(19) United States
(12) Patent Application Publication
(10) Pub. No.: US 2022/0127533 A1
(43) Pub. Date: Apr. 28, 2022

(54) PHOSPHORUS NITROGEN FLAME RETARDANT, METHOD THEREOF AND MATERIAL COMPRISING THE SAME

(71) Applicant: Chongfu ZHOU, Avon, OH (US)

(72) Inventor: Chongfu ZHOU, Avon, OH (US)

(21) Appl. No.: 17/454,822

(22) Filed: Nov. 15, 2021

Related U.S. Application Data
(63) Continuation-in-part of application No. PCT/CN2019/087271, filed on May 16, 2019.

(51) Int. Cl. C09K 21/12; C08K 5/53; C08K 5/00

(52) U.S. Cl. CPC C09K 21/12; C08K 5/0066; C08K 5/53

(57) ABSTRACT

Provided are phosphorus nitrogen flame retardants represented by Formula III, a method of preparing the flame retardants without using any solvent, and various materials comprising the flame retardants. Rb and Rc are independently of each other selected from hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical. The invention exhibits numerous technical merits such as excellent flame retardant efficacy, good compatibility with polymers, lower migration to material surface, excellent hydrolysis resistance, low smoke and low toxicity during burning, simpler preparation process, fewer by-products, shorter reaction time, higher yield, and no environmental impact, among others.

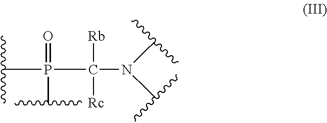

### CROSS-REFERENCE TO RELATED APPLICATIONS

This application is Continuation-in-Part of International Application Serial No. PCT/CN2019/087271 filed on May 16, 2019, the entire disclosures of which is incorporated herein by reference.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### FIELD OF THE INVENTION

The present invention generally relates to non-halogen flame retardants. Various embodiments of the invention provide a method of preparing a phosphorus nitrogen flame retardant such as flame retardant containing 9,10-dihydro-9-oxa-10-phosphaphenanthrene-10-oxide (DOPO), some novel phosphorus nitrogen flame retardants, and materials comprising the phosphorus nitrogen flame retardants.

### BACKGROUND OF THE INVENTION

Flame retardants are critically important in lessening the destructive impact of fires on people, property and the environment. They are used to modify potentially flammable materials, including textiles and plastics. A variety of different chemicals, with different properties and structures, act as flame retardants and these chemicals are often combined for effectiveness.

Flame retardants may be added to different materials or applied as a treatment to materials (e.g., textiles and plastics) to prevent fires from starting, limit the spread of fire, and minimize fire damages Some flame retardants work effectively on their own; others act as “synergists” to increase the fire protective benefits of other flame retardants.

In a typical fire cycle, the initial ignition source can be any energy source (e.g., heat, incandescent material or a small flame). The ignition source causes the material to burn and decompose (pyrolysis), releasing flammable gases. If solid materials do not break down into gases, they will remain in a condensed phase. During this phase, they will slowly smolder and, often, self-extinguish, especially when they “char,” meaning the material creates a carbonated barrier between the flame and the underlying material. In the gas phase, flammable gases released from the material are mixed with oxygen from the air. In the combustion zone or the burning phase, fuel, oxygen and free radicals combine to create chemical reactions that cause visible flames to appear. The fire then becomes self-sustaining because, as it continues to burn the material, more flammable gases are released, feeding the combustion process.

When flame retardants are present in the material, they can act in three mechanisms to stop the burning process. They may function to (1) disrupt the combustion stage of a fire cycle, including avoiding or delaying “flashover” or the burst of flames that engulfs a room and makes it much more difficult to escape; (2) limit the process of decomposition by physically insulating the available fuel sources from the material source with a fire-resisting “char” layer, and/or (3) dilute the flammable gases and oxygen concentrations in the flame formation zone by emitting water, nitrogen or other inert gases.

For example, polymer materials have the advantages of light weight, high specific strength, and good processing characteristics. Therefore, they are widely used in a variety of fields. Since most polymers are mainly composed of carbon and hydrogen elements, they are extremely flammable and can cause a huge fire safety hazard. DOPO-based flame retardants have the advantages of good flame retardancy, halogen-free, non-toxic, and environmentally friendly properties, so they have been widely used in epoxy resin, polyester, polypropylene and other polymer materials in recent years DOPO is an organophosphorus intermediate which has a very reactive PH bond and can undergo addition reactions with unsaturated bonds, and carbonyl groups etc. to form various DOPO-based flame retardants.

U.S. Pat. No. 4,742,088 discloses DOPO derivatives prepared by DOPO reacting with a nitrogen compound having reactive hydrogen group, and a third compound having a carbonyl functional group in a suitable solvent within a temperature range of 50-200 C. The resulting compound is a very good flame retardant for polyesters and polyurethanes.

U.S. Pat. No. 10,072,212 discloses DOPO derivatives by DOPO reacting with pentaerythritol phosphate alcohol in a solvent mixture of dichloromethan, N-methylimidazole, and carbon tetrachloride. This hybrid flame retardant combines gas phase and condense phase activities. The compound has high melting temperature point and 15% phosphorous content. It is a very good flame retardant for polyesters, especially fibers.

CN 108640949B discloses DOPO-phthalimide derivatives preparation method and its applications. The three-step reactions are carried out in multiple solvents.

U.S. Pat. Nos. 8,536,256 and 9,522,927 disclose DiDOPO with different bridge chains as a flame retardant for epoxy resin. The flame retardants in the patents do not include aryl substituted vinyl bridge chain. The derivative contains two phosphorus centers (DiDOPO) in one molecule. DiDOPO was prepared by DOPO reacting with potassium t-butoxide and two-bromine compounds in DMSO solvents. The above-mentioned DiDOPO flame retardants are all made by DOPO and dihalogenated alkanes under the action of strong alkali. The Michaelis-Becker reaction requires the use of expensive strong bases as raw materials, and it has the disadvantage of low reaction yields.

CN 1040865393A discloses that the bridge structure connecting two DOPO compounds is ethylene containing aryl groups, which need solvent during the reaction process. Since the bridge chain is short, the compound molecule has rigidity, which greatly avoids plasticization The aryl group on the vinyl adds steric hindrance which not only greatly increases its chemical stability of the compound, but also reduces its volatility, overcoming the disadvantages of current DiDOPO flame retardants.

CN 1563152 discloses a method for preparing phosphorus-containing polymeric flame retardant, which adopts DOPO modified terephthalic acid, phenol or hydroquinone, phenyl or naphthyl substituted dichloro (bromo) oxyphosphorus as the reaction matrix to obtain phosphorus-containing polymer flame retardant. However, a precipitation agent with 5-10 times the amount of solvent must be used in the separation process. It potentially causes heavy pollution to the environment.

CN 101643650A discloses the use of DOPO-containing hydroquinone or hydroquinone and olefins with reactive functional groups to form flame retardants, but they have poor compatibility with polymers and have leaching problems. The DOPO containing compounds were also prepared in a few solvents.

Generally speaking, DOPO-based flame retardants in the prior art have poor compatibility and poor hydrolysis resistance, so they are easy to leach out. The preparation methods have many problems such as high cost, low yield, and heavy environmental pollution.

Advantageously, the present invention discloses a phosphorus nitrogen flame retardant and its preparation method. The present invention generally exhibits numerous technical merits such as excellent flame retardant efficacy, good compatibility with polymers, lower migration to material surface, excellent hydrolysis resistance, low smoke and low toxicity during burning, simpler preparation process, fewer by-products, shorter reaction time, higher yield, and no environmental impact, among others. In some particular embodiments, the flame retardant of the present invention is an organic intumescent flame retardant prepared by bulk polymerization. The preparation method is a relatively simple process with high yield and without pollution to the environment.

### SUMMARY OF THE INVENTION

One aspect of the present invention provides method of preparing a phosphorus nitrogen flame retardant, comprising:

(1) providing a first compound containing m reactive group(s) each of which is represented by formula (I), wherein m is an integer and m≥1:

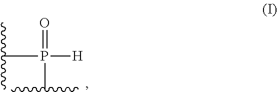 [SMILES: *[PH](*)=O]

wherein the waved lines represent any structural moiety or moieties;

(2) providing a second compound containing n reactive group(s) each of which is represented by formula (II), wherein n is an integer and n≥1:

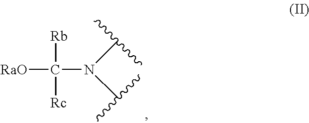

wherein Ra, Rb and Rc can be independently of each other any mono-valent group, for example, Ra is independently of each other selected from hydrogen, C1-C18 alkyl, heteroalkyl, cycloalkyl, heterocycloalkyl, substituted or unsubstituted aryl, substituted or unsubstituted C6-˜C18 aryl, substituted or unsubstituted C3˜C18 heteroaryl, substituted or unsubstituted heterocycles, alkyl such as methyl, ethyl and propyl, butyl, pentyl, hexyl, heptyl, octyl, nonyl, decyl, undecyl, dodecyl, isopropyl, isobutyl, isoheptyl, isohexyl, isooctyl, isononyl, isodecyl, isoundecyl, isododecyl, cyclic hexyl, cyclic butyl, cyclic propyl, cyclic heptyl, cyclic octyl, and acyl radical;

wherein Rb is independently of each other hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical;

wherein Rc is independently of each other hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical; and

wherein the waved lines represent any structural moiety or moieties;

(3) mixing the first and second compounds in the absence of any solvent to react each other according to reaction scheme ZCF below, so as to prepare a phosphorus nitrogen flame retardant containing p group(s) each of which is represented by formula (III), wherein p is an integer, and

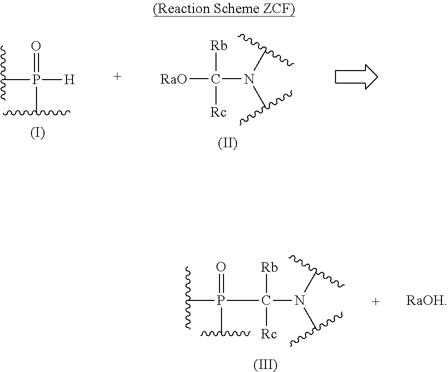

Another aspect of the invention provides a phosphorus nitrogen flame retardant represented by Formula III:

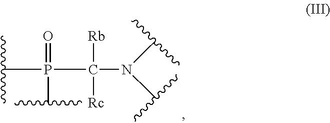

wherein Rb is independently of each other hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical;

wherein Rc is independently of each other hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical; and

wherein the waved lines represent any structural moiety or moieties.

Still another aspect of the invention provides a material comprising a base polymer and the phosphorus nitrogen flame retardant as described above, optionally in a weight ratio of 25:75 to 99:1.

In some embodiments, the present invention provides a DOPO-containing phosphorus-nitrogen flame retardant and its preparation method thereof. The DOPO-containing phosphorus nitrogen flame retardant has excellent flame retardant efficacy, good compatibility with the plastics. It does not ooze out of the substrate. Moreover, it has excellent hydrolysis resistance, low-smoke and low-toxicity. The preparation method is a relatively simple process with high yield. The process does not give off pollution to the environment.

The above features and advantages and other features and advantages of the present invention are readily apparent from the following detailed description of the best modes for carrying out the invention when taken in connection with the accompanying drawings (if any).

### BRIEF DESCRIPTION OF THE SEVERAL VIEWS OF THE DRAWINGS

Not applicable.

### DETAILED DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement.

Where a numerical range is disclosed herein, unless otherwise specified, such range is continuous, inclusive of both the minimum and maximum values of the range as well as every value between such minimum and maximum values. Still further, where a range refers to integers, only the integers from the minimum value to and including the maximum value of such range are included. In addition, where multiple ranges are provided to describe a feature or characteristic, such ranges can be combined.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

As described in the section of SUMMARY OF THE INVENTION, step (2) is providing a second compound containing n reactive group(s) each of which is represented by formula (II). In some embodiments, a reactive group represented by formula (IIa) as shown below may be contained in the second compound. It should be appreciated that formula (IIa) group will be counted as two reactive groups of formula (II).

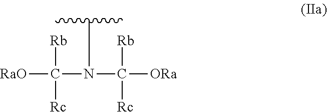

In some embodiments, a group represented by formula (IIIa) as shown below may be contained in the product, i.e. the phosphorus nitrogen flame retardant from step (3). It should be appreciated that formula (IIIa) group will be counted as two groups of formula (III).

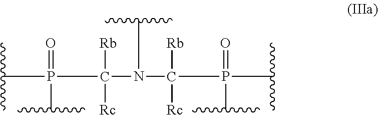

As described in the section of SUMMARY OF THE INVENTION, step (3) of the method is mixing the first and second compounds in the absence of any solvent to react each other according to reaction scheme ZCF, so as to prepare a phosphorus nitrogen flame retardant containing p group(s) each of which is represented by formula (III). In various embodiments, the reaction scheme ZCF may be carried out in the absence of a nonpolar solvent, a polar solvent, an aprotic solvent, a protic solvent; a nonpolar hydrocarbon solvent such as heptane, pentane, hexane, benzene, xylene, and toluene; a nonpolar ether solvent such as 1, 4-dioxane, diethyl ether, and tetrahydrofuran (THF); a nonpolar chlorocarbon solvent such as chloroform; a polar aprotic solvent such as dichloromethane (DCM), ethyl acetate, acetone, dimethyl formamide (DMF), acetonitrile (MeCN), dimethyl sulfoxide (DMSO), nitromethane, chlorobenzene, chlorobromomethane, and propylene carbonate; a polar protic solvent such as ammonia, formic acid, n-butanol, isopropyl alcohol (IPA), n-propanol, ethanol, methanol, acetic acid, and water; pyridine, benzoyl, cyclohexane, dichlorobenzene, diethylene glycol, furfural, isopropyl ether, lactic acid, nitrobenzene, polydimethylsiloxane, glycerin, cresols, citric acid, carbon disulfide, butylacetate, acrylonitrile, butyl phthalate, dichloroethane, phthalates, or any mixture thereof.

In a variety of exemplary embodiments, the first compound has a melting temperature point T1, the second compound has a melting temperature point T2, the first compound has a boiling temperature point or decomposition temperature point T3, and the second compound has a boiling temperature point or decomposition temperature point T4. The method may further include heating the mixture of the first and second compounds in step (3) to a reaction temperature Tr. Tr may be any temperature that can conveniently facilitate the reaction. For example, Tr may be between T1 and T2, higher than both T1 and T2, between T3 and T4, or higher than both T3 and T4.

In some preferred embodiments, the reaction temperature Tr during step (3) may be increased from a temperature between T1 and T2 (inclusive) to a temperature between T3 and T4 (inclusive) or even a temperature higher than both T3 and T4. For instance, when the first compound is DOPO, T1=119° C., and T3=230° C.

In certain embodiments, the m value in the first compound may be m=1 (such as DOPO), the n value in the second compound may be n≥2, 3, 4, 5, 6, 7 or 8; and the p value in the phosphorus nitrogen flame retardant product may be p=n.

In some embodiments, the entire reaction mixture in step (3) of the method consists of (or consists essentially of) the first compound and the second compound. In preferred embodiments, the entire reaction mixture in step (3) of the method consists of (or consists essentially of) the first compound, the second compound, and a catalyst such as an acid catalyst. The reaction in step (3) may be catalyzed by such a catalyst. For example, the catalyst may be selected from benzenesulfonic acid, p-toluenesulfonic acid, p-toluenesulfonic acid hydrate or its alcohol solution, phosphoric acid, hydrochloric acid, sulfuric acid, boric acid, nitric acid, hydrofluoric acid (HF), hydrobromic acid (HBr), hydroiodic acid (HI), trifluoromethanesulfonic acid, ethanesulfonic acid, methanesulfonic acid, acetic acid, formic acid, hexafluorophosphoric acid, fluoroboric acid, fluorosulfuric acid, fluoroantimonic acid, chromic acid, fluoroacetic acid, trifluoroacetic acid, chloroacetic acid, dichloroacetic acid, trichloroacetic acid, or any mixture thereof.

In some exemplary embodiments of the invention, the first compound in the method may be selected from:

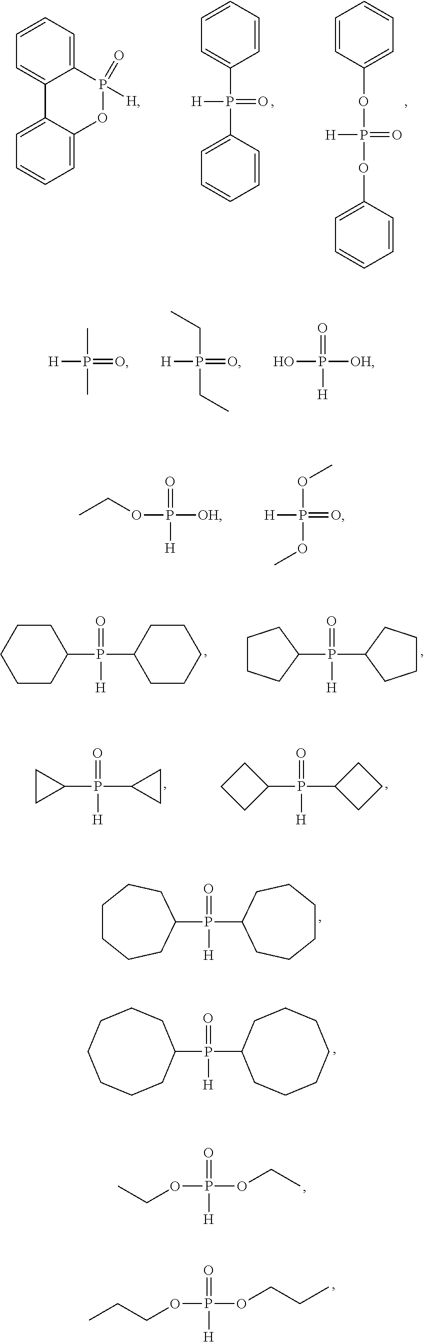

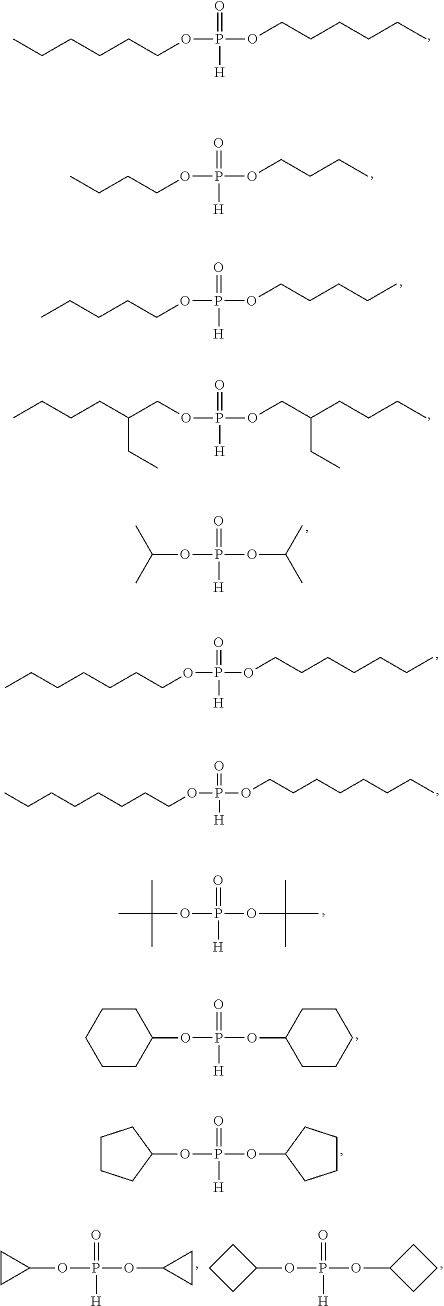

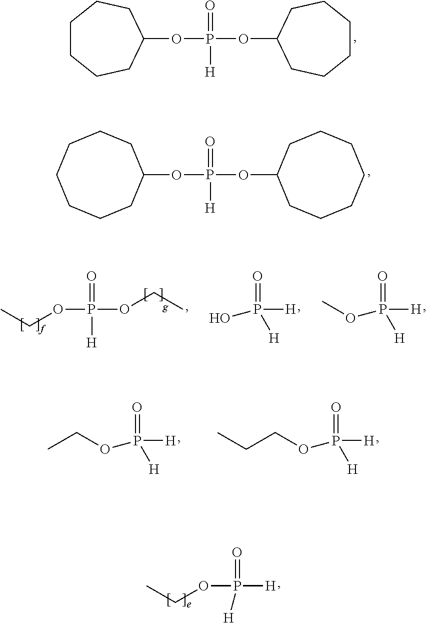

(wherein f and e are integers of 0˜18

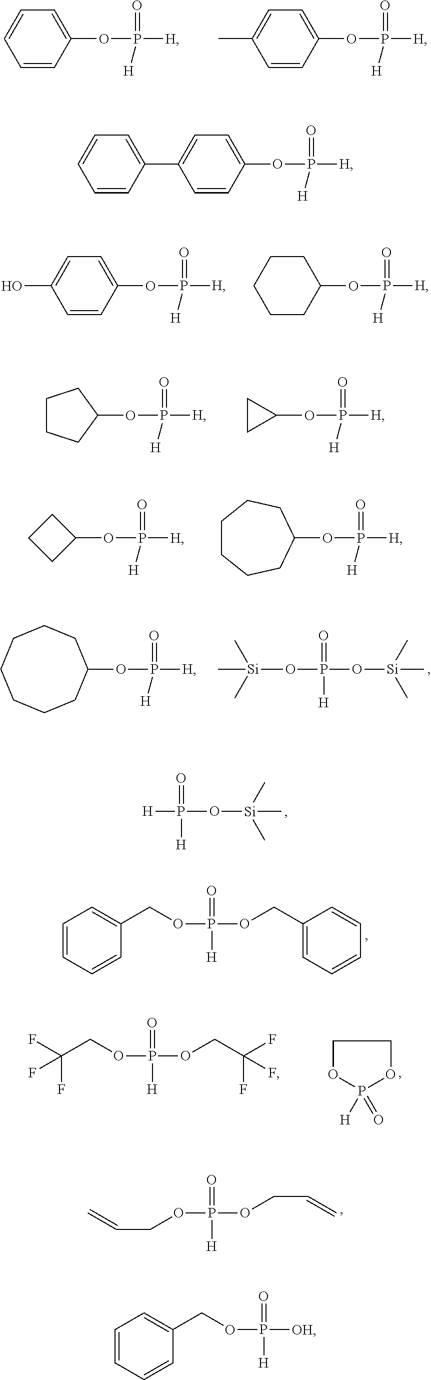

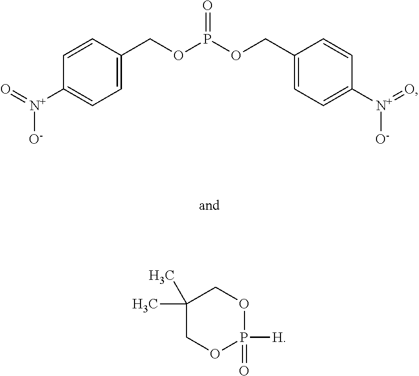

In some exemplary embodiments of the invention, the second compound used in the method may be represented by Formula (II-A):

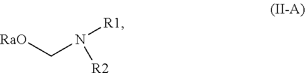

wherein R1 and R2 are independently of each other selected from H, C1-C24 alkyl, cylic alkyl, heteroalkyl, heterocylcoalkyl, C6-C24 aryl, C3-C24 heteroaryl, fused cycloalkyl aryl, fused cycloalkane heteroaryl group, fused heterocyclyl aryl, fused heterocyclyl heteroaryl, and nitrogen, silicon, boron, oxygen, sulfur, and carbonyl or sulfonyl substituted C1-C24 alkyl groups; or wherein R1 and R2 are connected through a saturated/unsaturated alkyl group, or bridging a heteroaryl group, a fused cycloalkyl aryl group, a fused ring with the N atom, cycloalkylheteroaryl, fused heterocyclylaryl, or fused heterocyclylheteroaryl. Further, the heteroaryl group is a monocyclic or polycyclic aromatic group, and the N atom is connected to the aromatic ring. The group contains one, two or three heterocyclic atoms being selected from N, O and S. The remaining ring atoms are C. Further, one or more carbon atoms of the heteroaryl group is substituted by a carbonyl group. Further, the heterocyclic group is a non-aromatic mono- or polycyclic group, wherein one or more ring atoms are selected from N, O, or S(O) x heteroatoms, where x is an integer from 0 to 2, and the remaining ring atoms are C. Further, the alkyl group includes linear, branched or aromatic ring-containing alkyl groups.

In some specific but still exemplary embodiments of the invention, the second compound may be selected from:

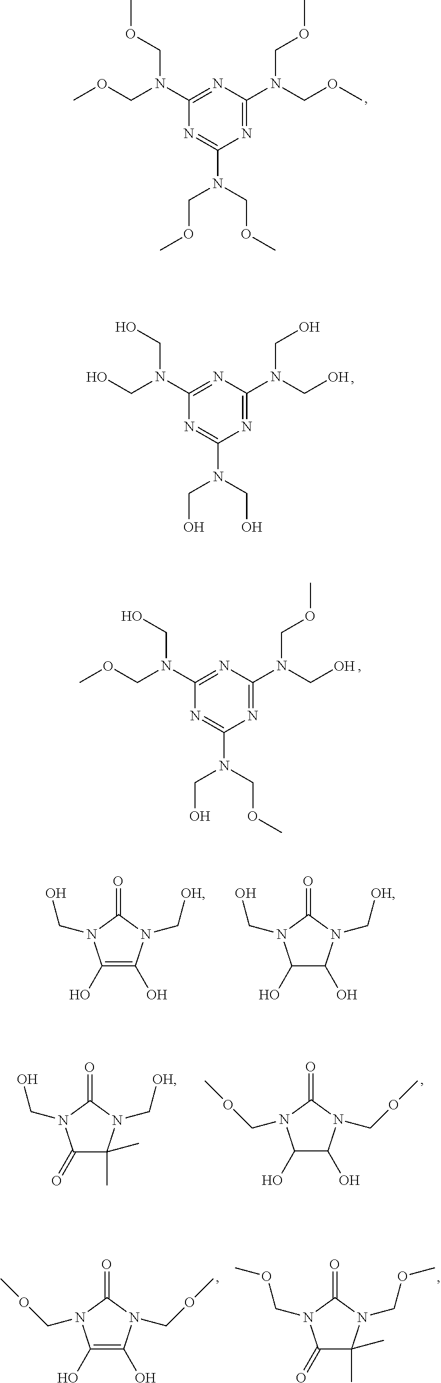

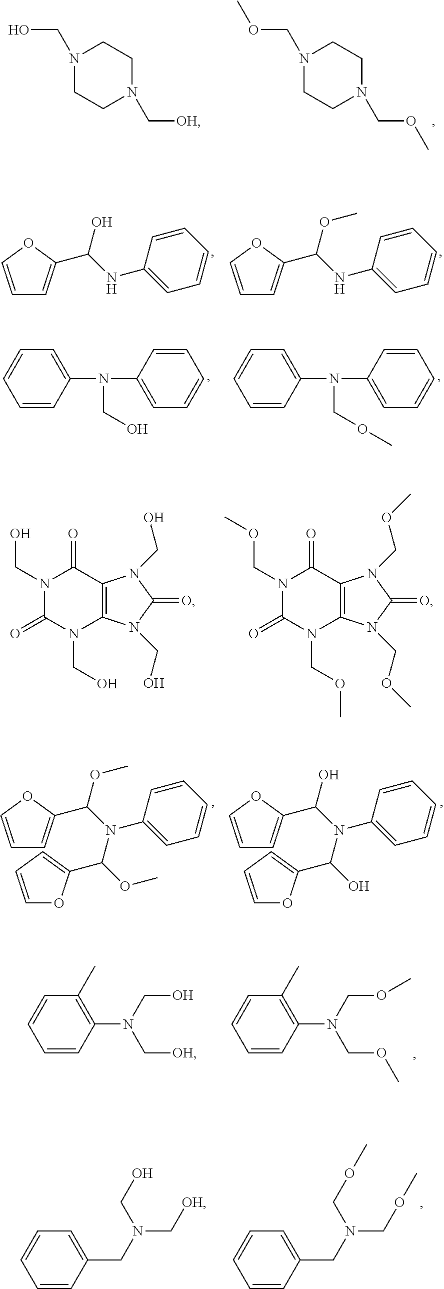

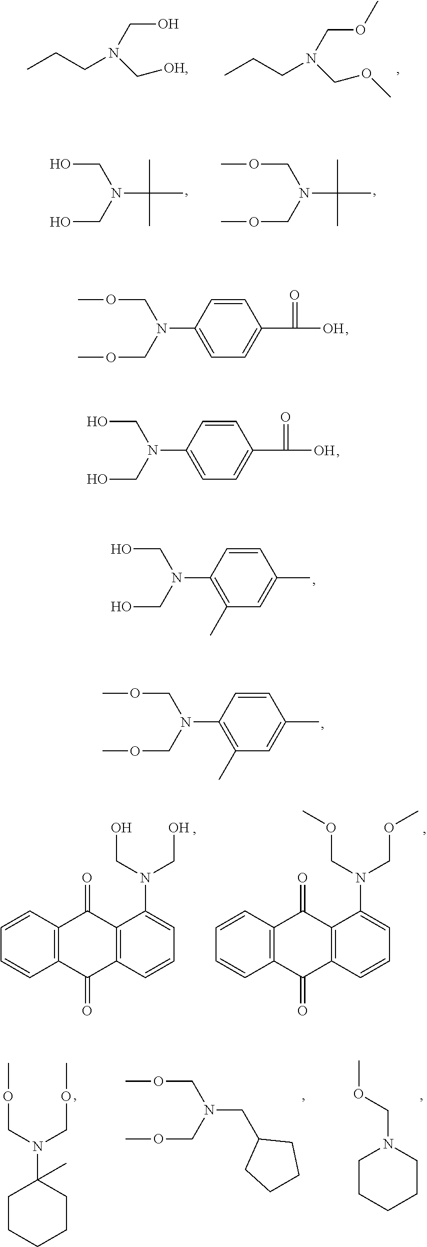

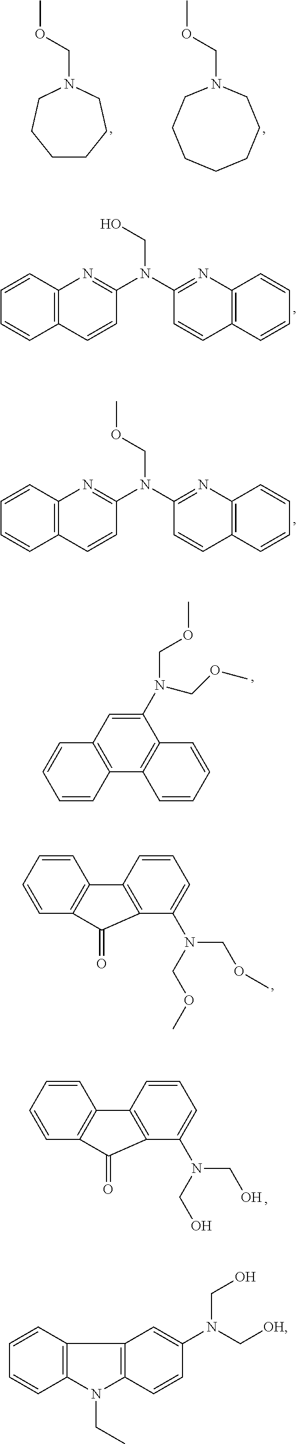

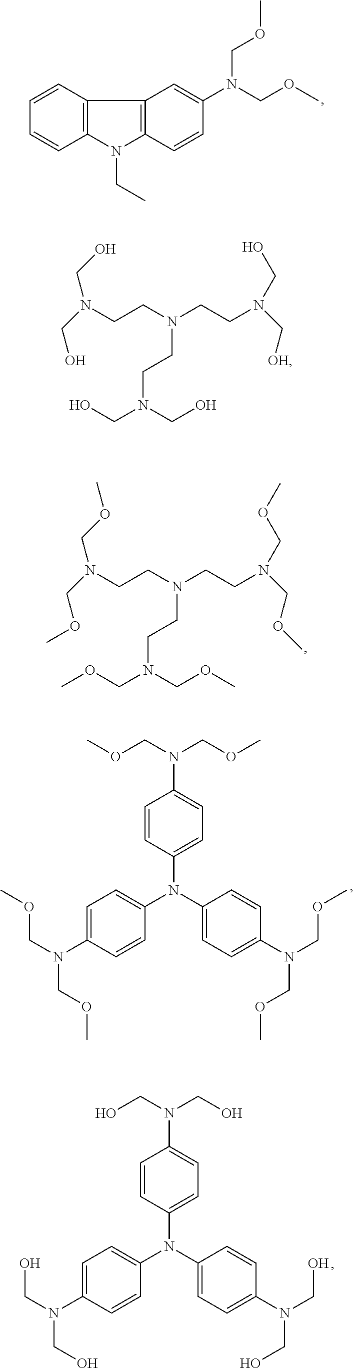

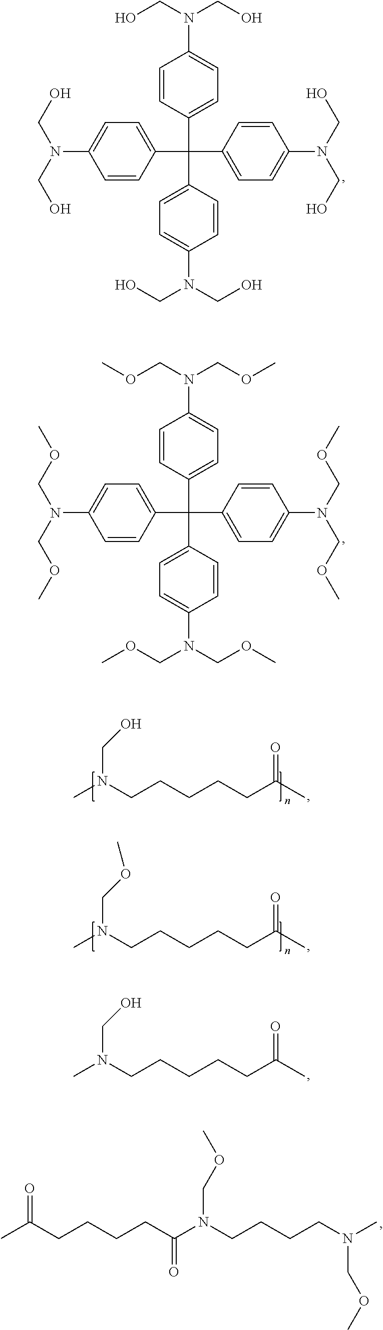

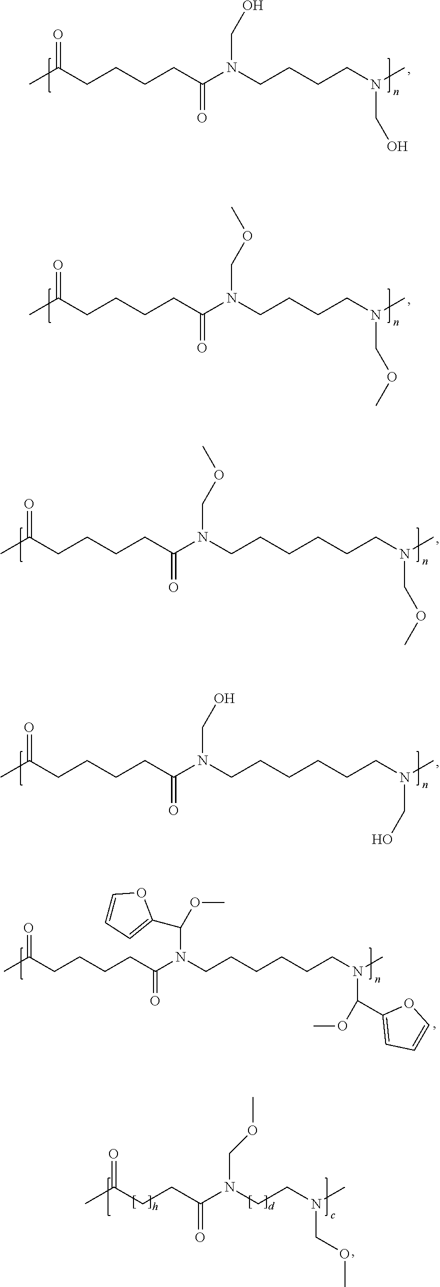

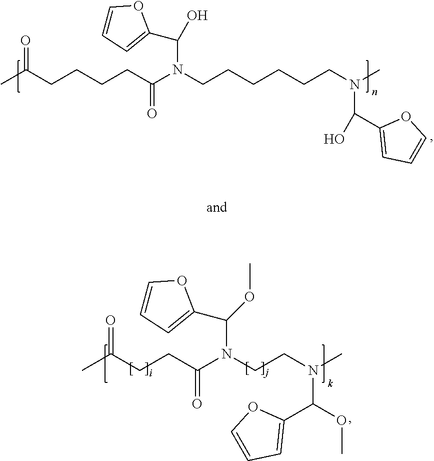

wherein n, c and k are integers of 1 or greater than 1; and h, d, i and j are integers in the range of from 1 to 20.

In a number of exemplary embodiments of the invention, the product of the method—phosphorus nitrogen flame retardant—may be represented by Formula (III-X) or Formula (III-Y):

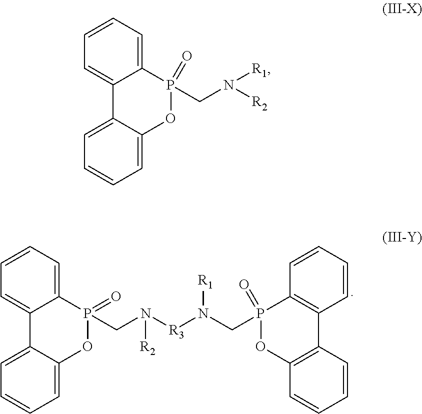

R1 and R2 are independently of each other selected from H, C1-C24 alkyl, cycloalkyl, heteroalkyl, heterocylcoalkyl, C6-C24 aryl, C3-C24 heteroaryl, fused cycloalkyl aryl, fused cycloalkane heteroaryl group, fused heterocyclyl aryl, fused heterocyclyl heteroaryl, and nitrogen, silicon, boron, oxygen, sulfur, and carbonyl or sulfonyl substituted C1-C24 alkyl groups; or wherein R1 and R2 are connected through a saturated/unsaturated alkyl group, or bridging a heteroaryl group, a fused cycloalkyl aryl group, a fused ring with the N atom, cycloalkylheteroaryl, fused heterocyclylaryl, or fused heterocyclylheteroaryl. Further, the heteroaryl group is a monocyclic or polycyclic aromatic group, and the N atom is connected to the aromatic ring. The group contains one, two or three heterocyclic atoms being selected from N, O and S. The remaining ring atoms are C. Further, one or more carbon atoms of the heteroaryl group is substituted by a carbonyl group. Further, the heterocyclic group is a non-aromatic mono- or polycyclic group, wherein one or more ring atoms are selected from N, O, or S(O) x heteroatoms, where x is an integer from 0 to 2, and the remaining ring atoms are C. Further, the alkyl group includes linear, branched or aromatic ring-containing alkyl groups.

R3 may be selected from C1-C24 alkyl, cyloalkyl, heteroalkyl, heterocylcoalkyl, C6-C24 aryl, C3-C24 heteroaryl, fused cycloalkyl aryl, fused cycloalkane heteroaryl group, fused heterocyclyl aryl, fused heterocyclyl heteroaryl, and silicon, oxygen, boron, nitrogen, sulfur, and carbonyl or sulfonyl substituted C1-C24 alkyl groups; and unsaturated alkyl.

In some preferred embodiments of the invention, the product of the method (phosphorus nitrogen flame retardant) may be selected from:

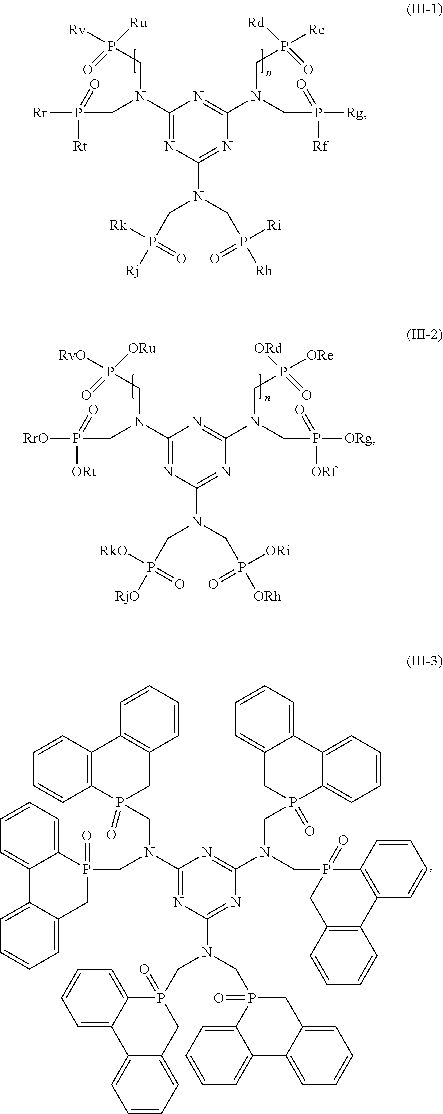

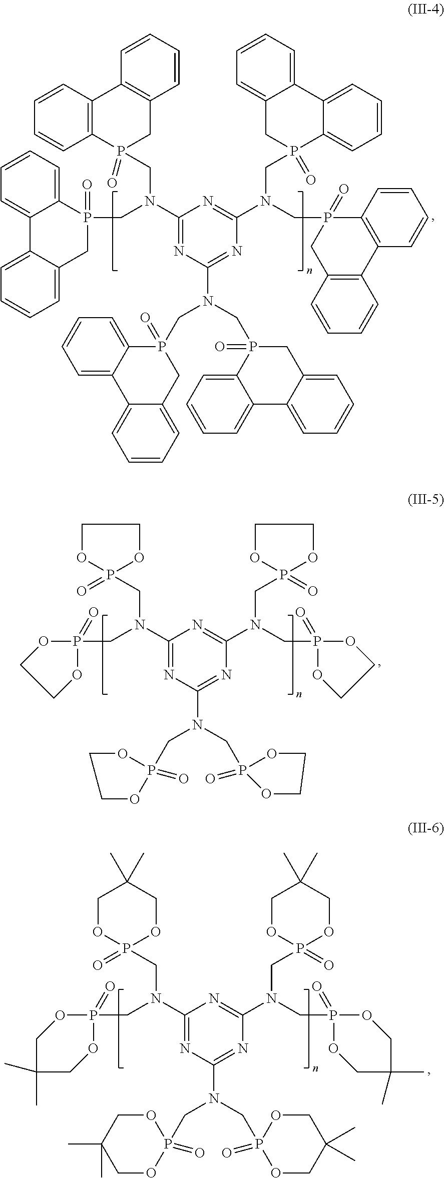

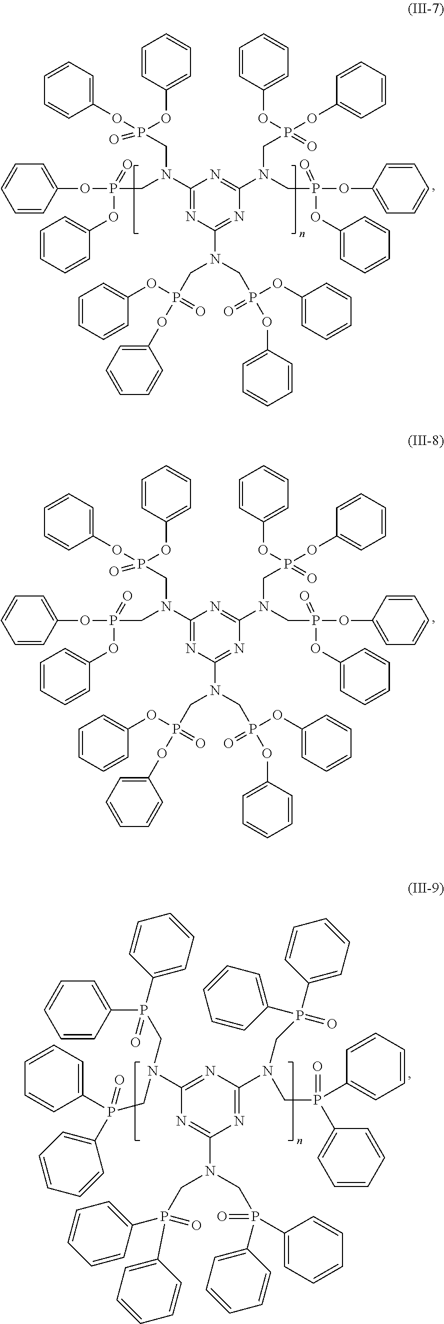

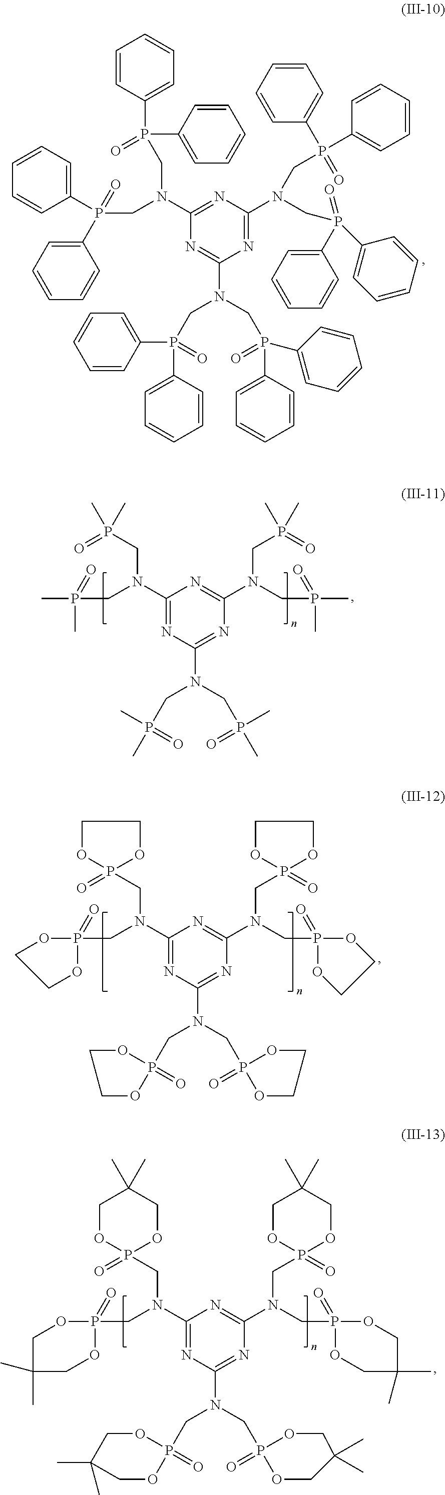

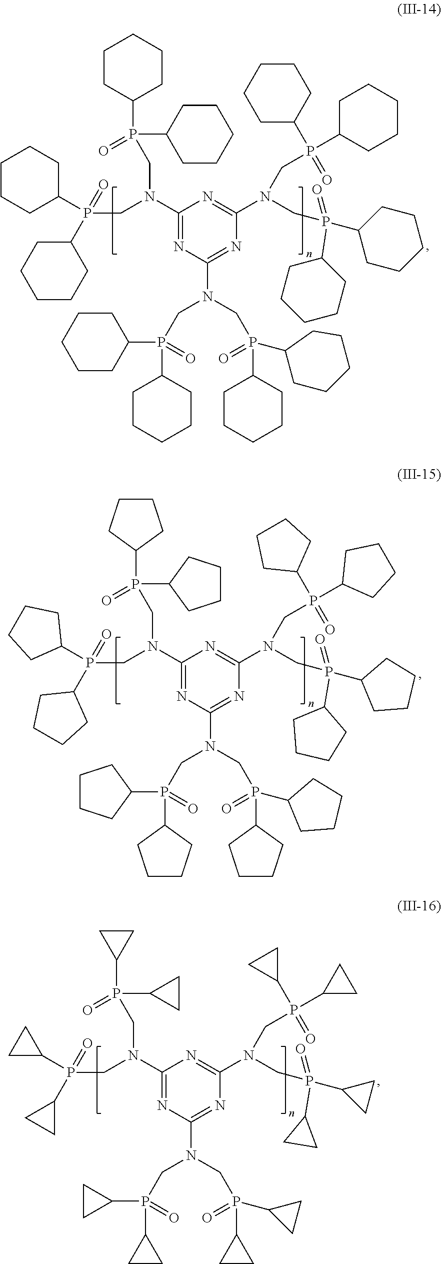

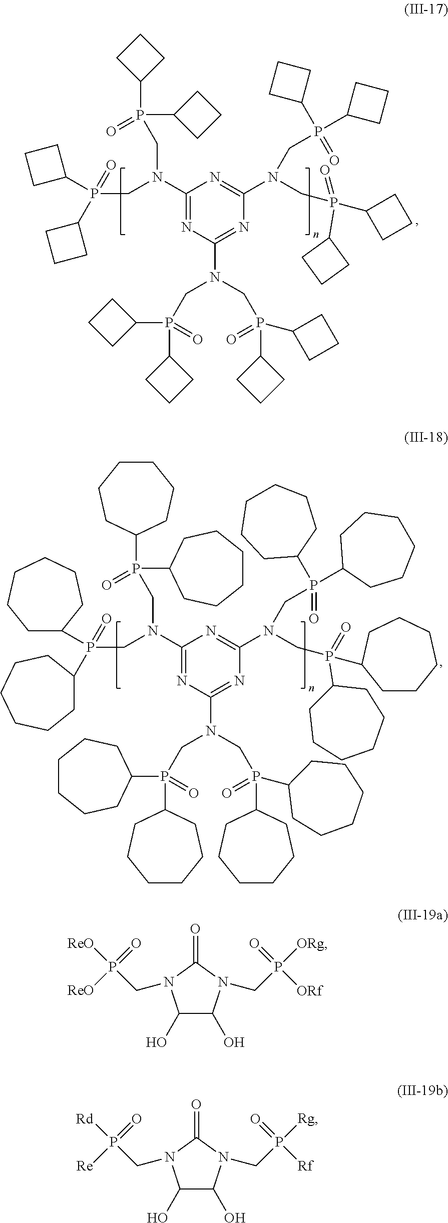

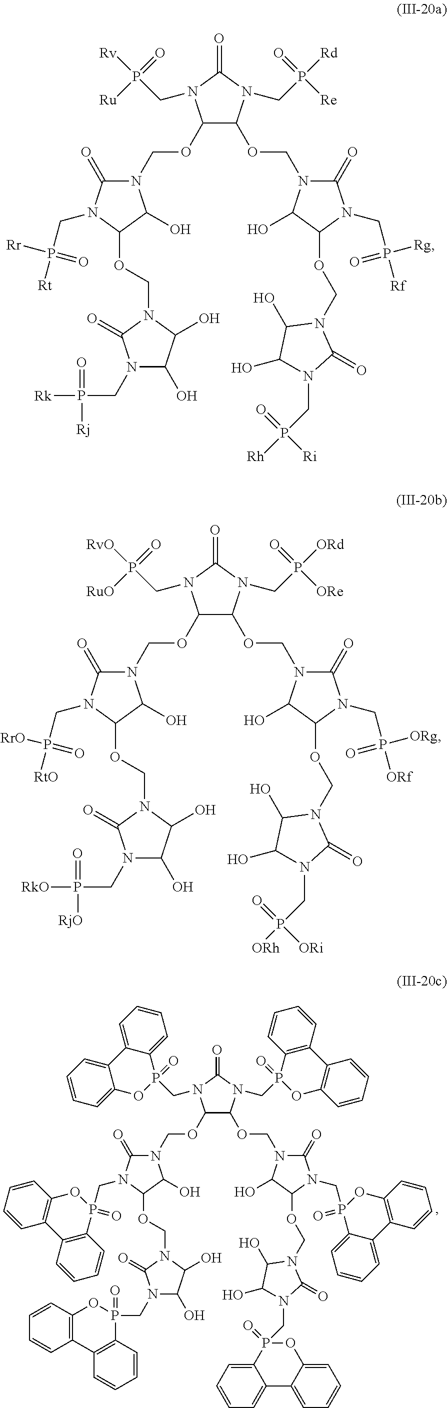

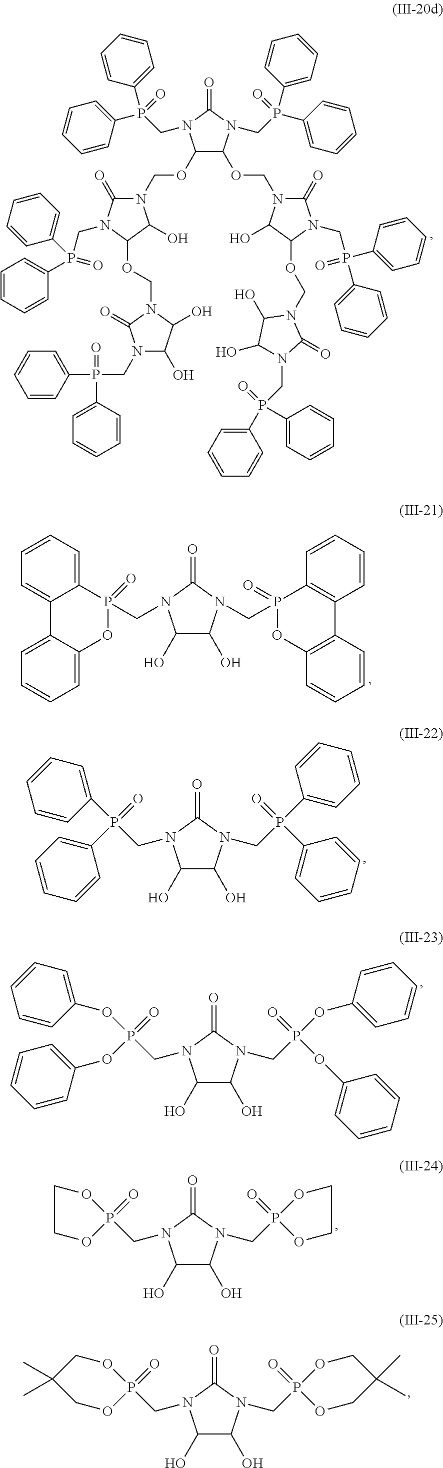

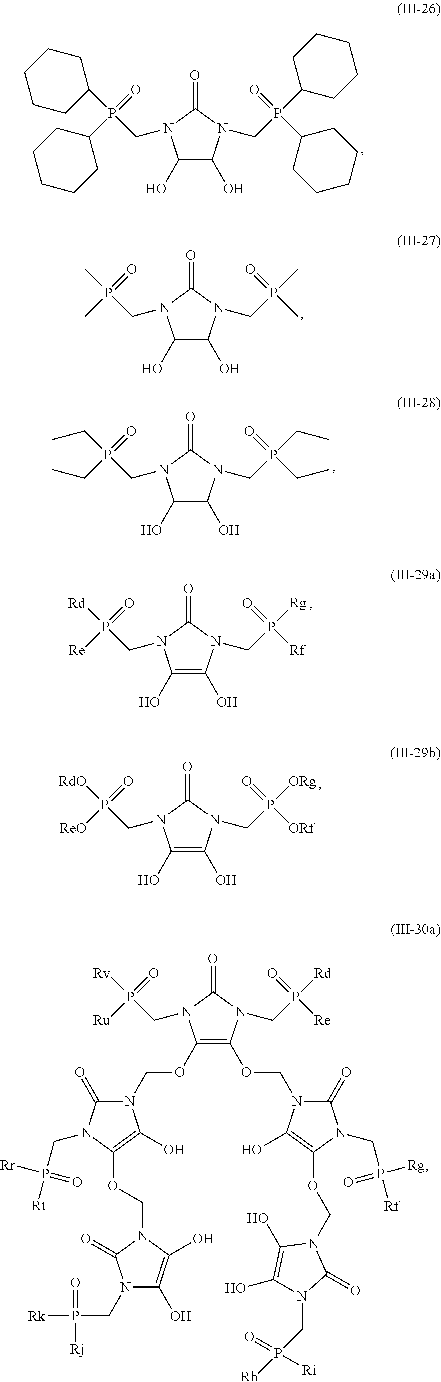

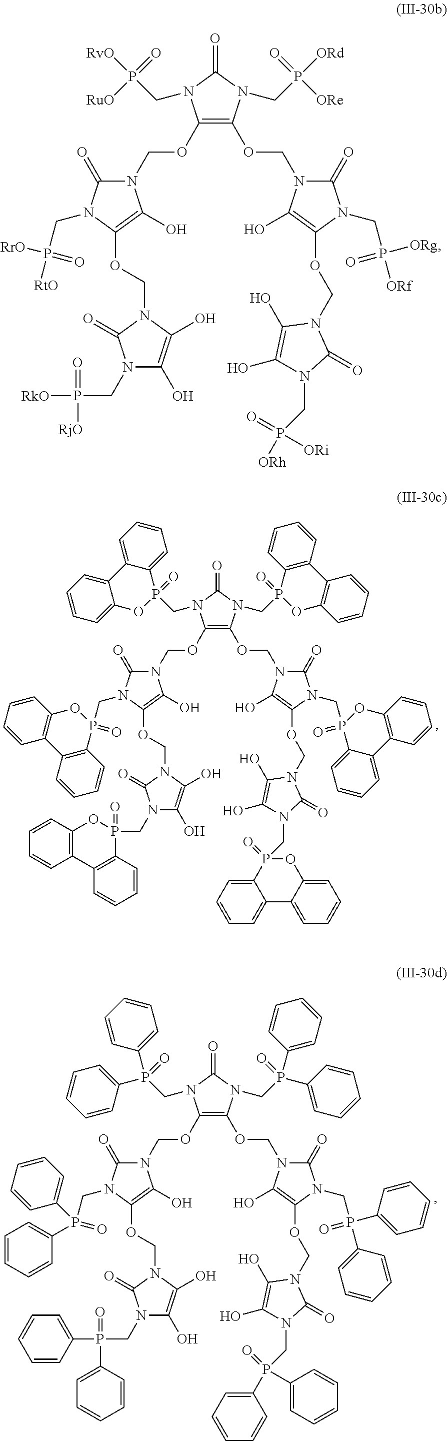

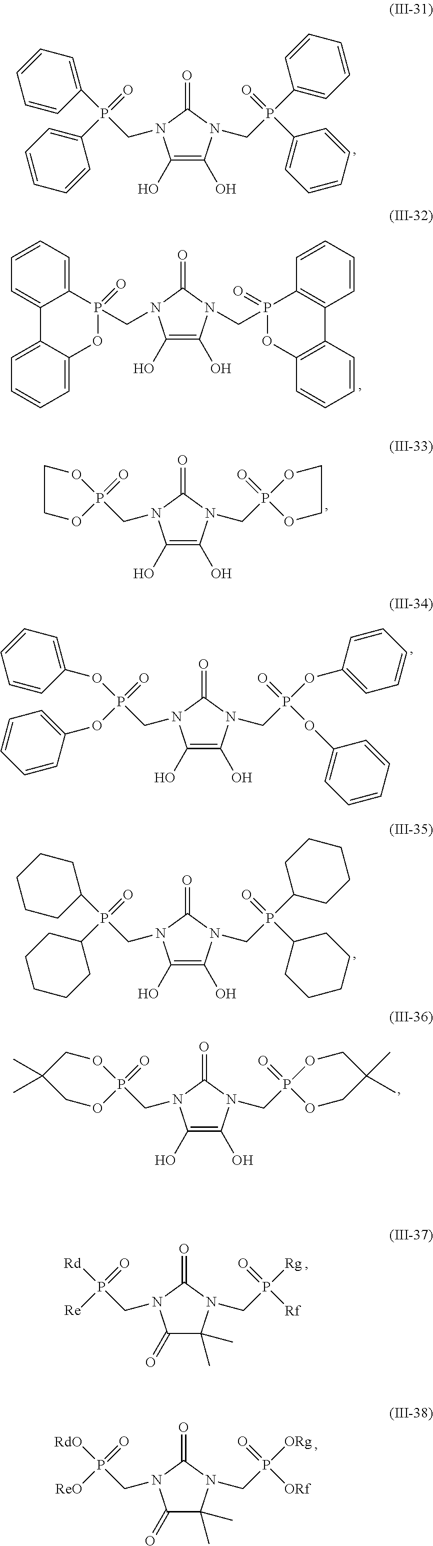

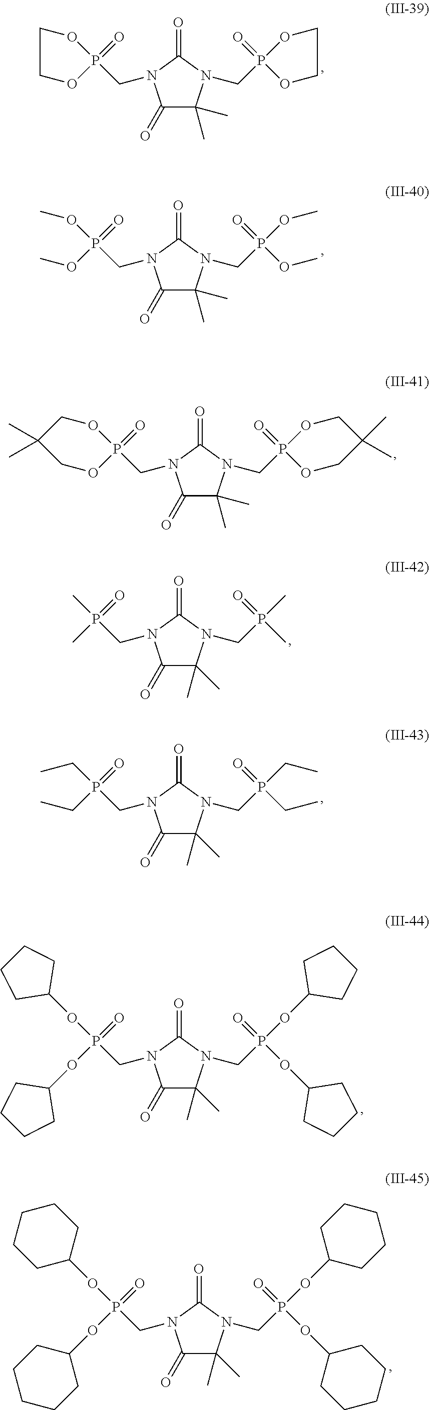

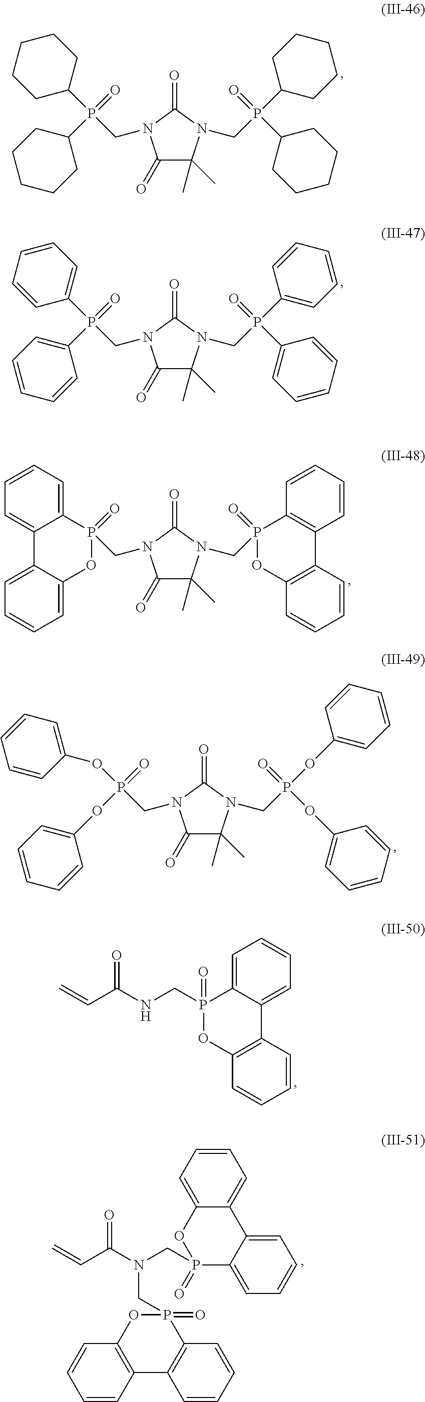

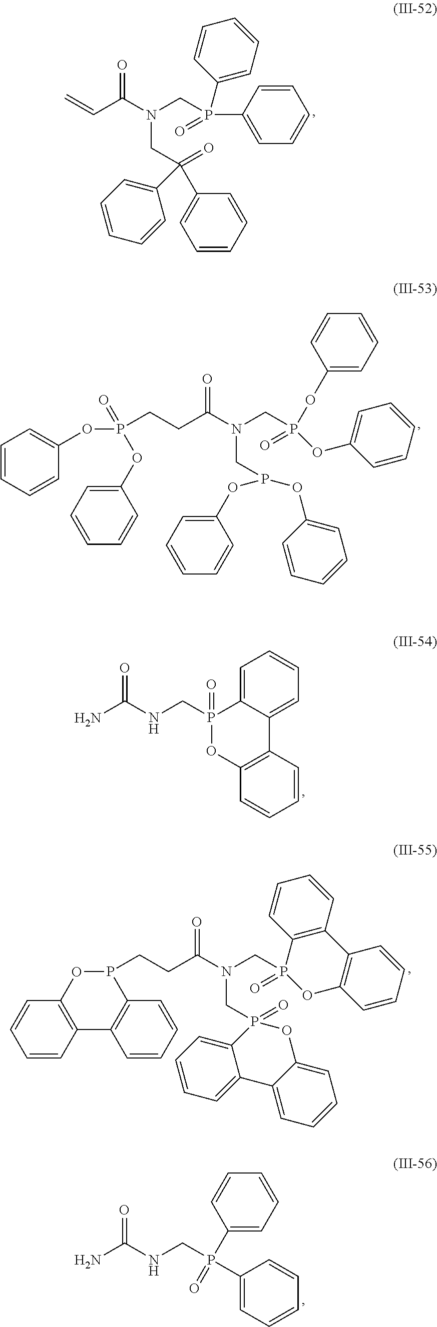

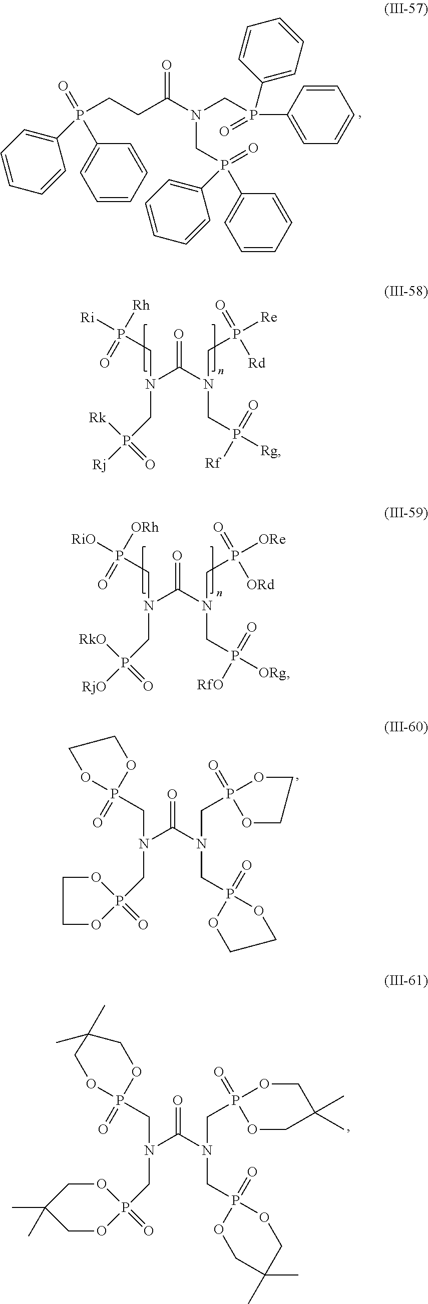

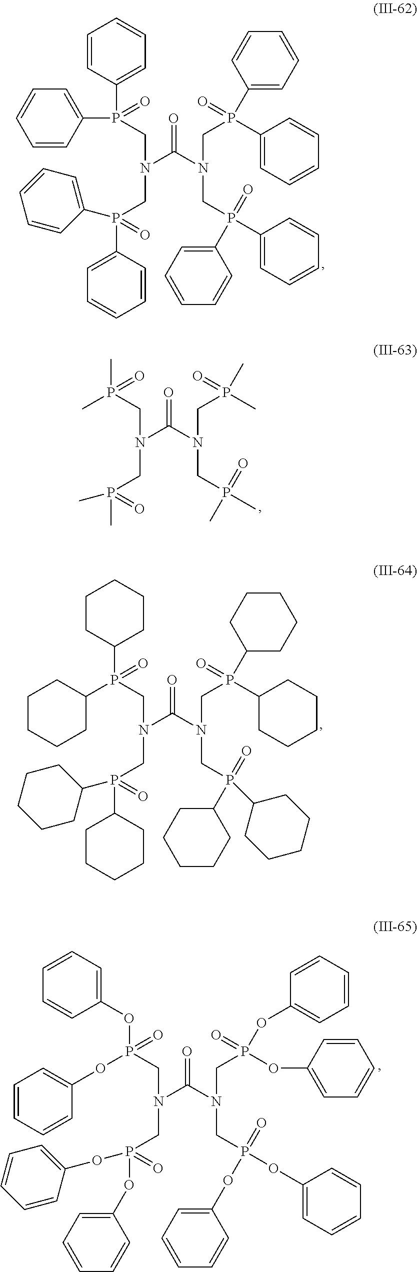

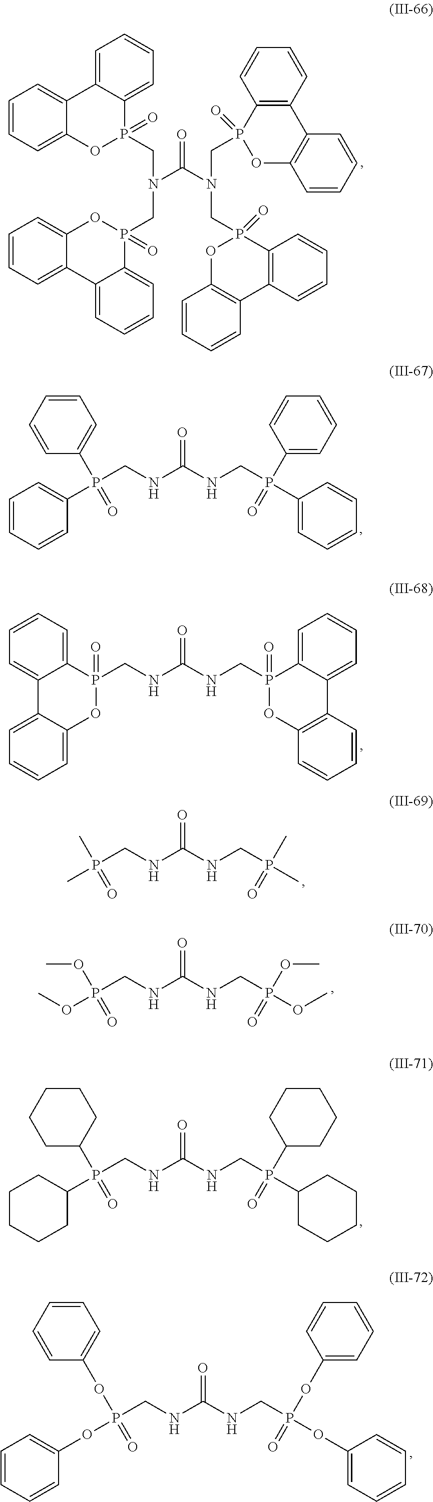

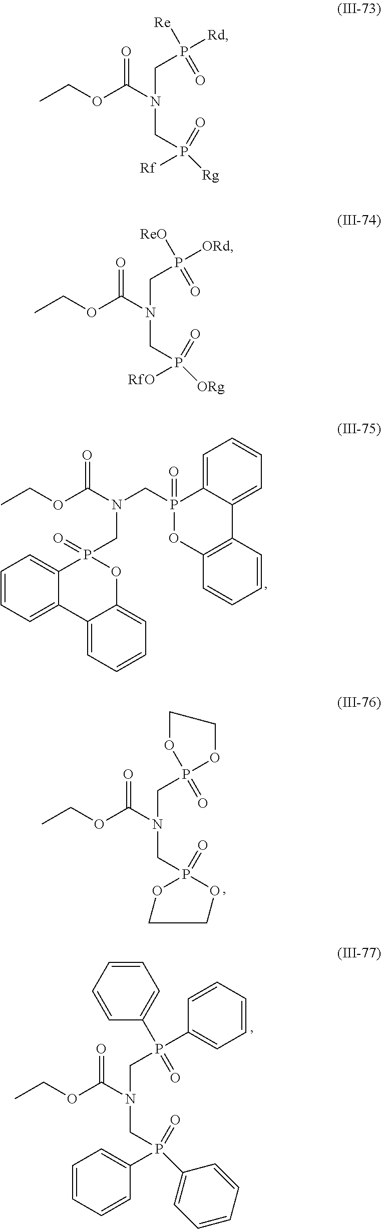

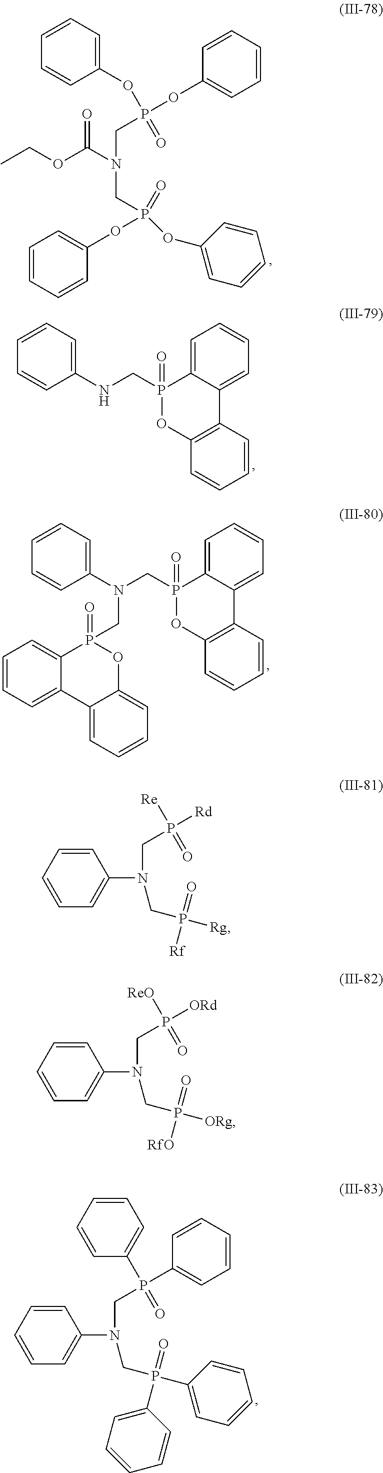

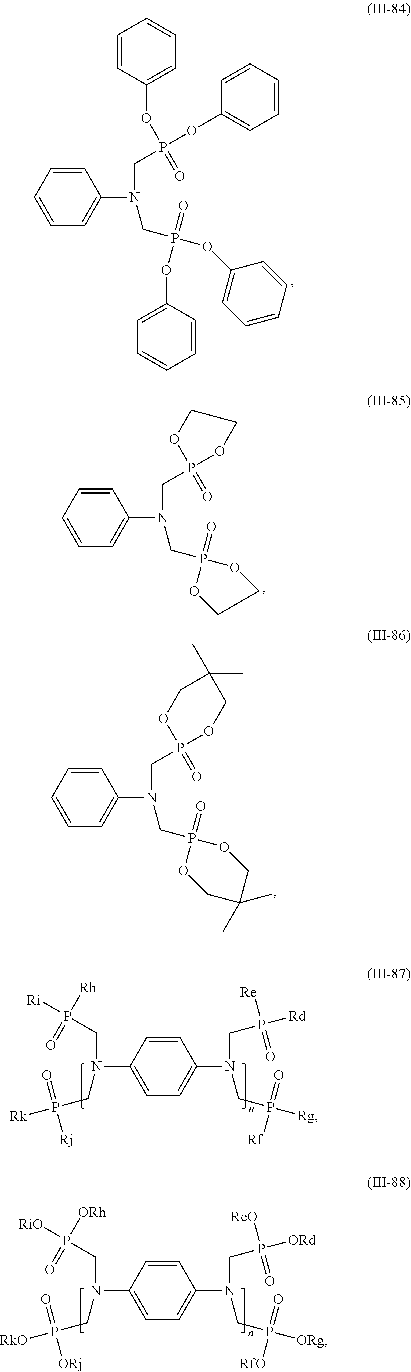

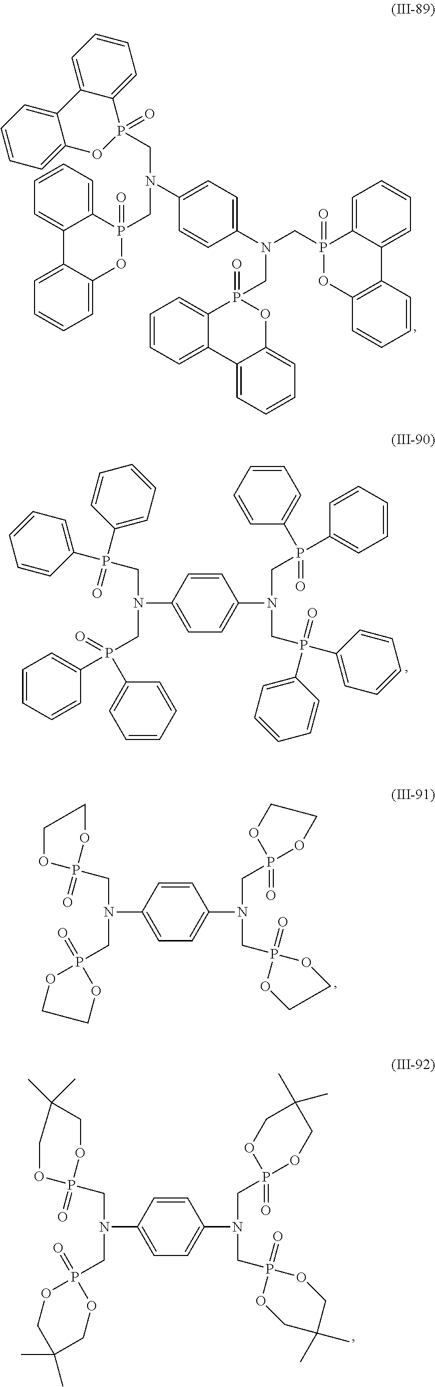

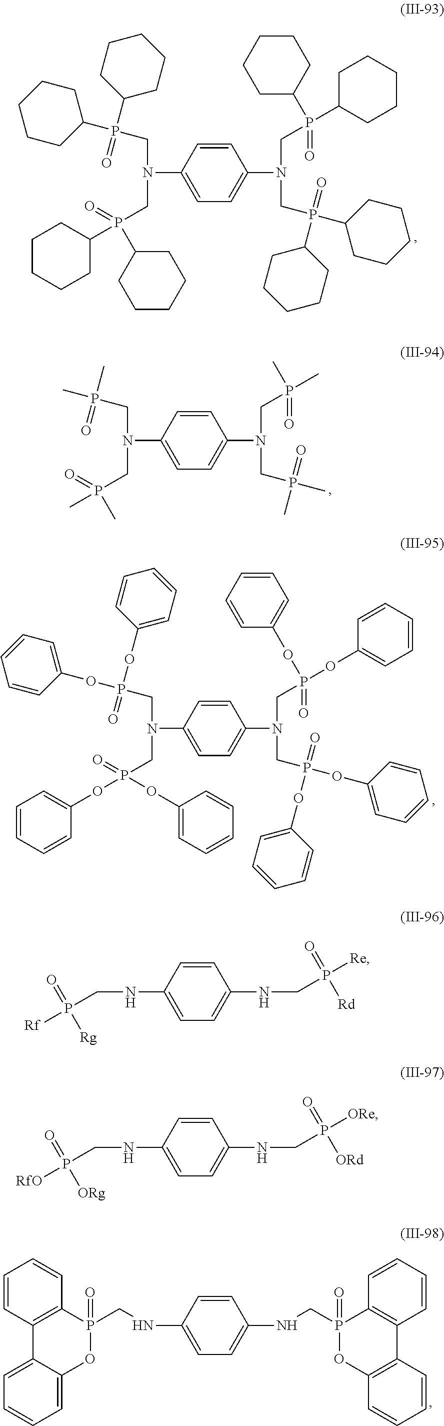

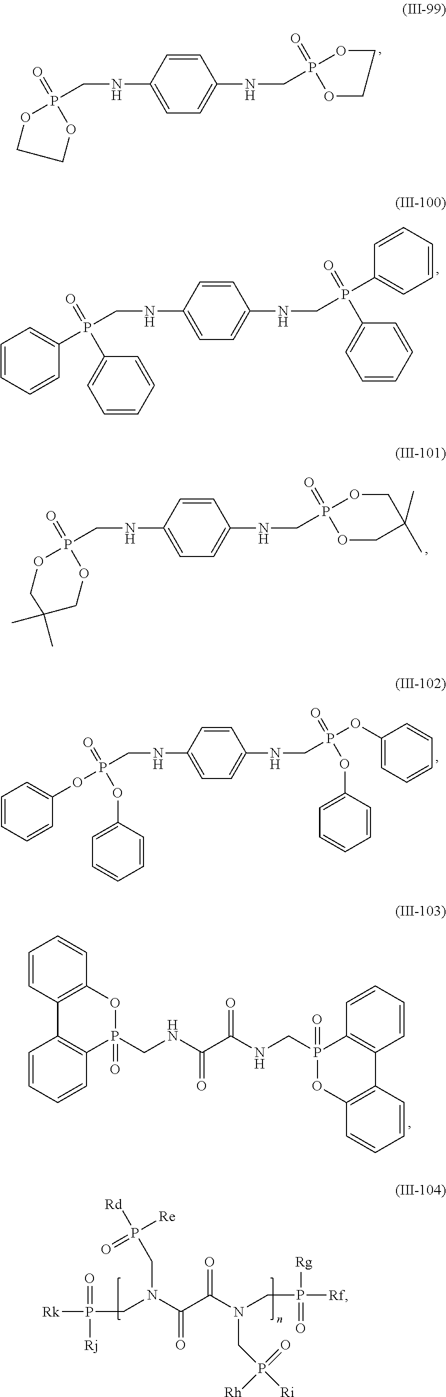

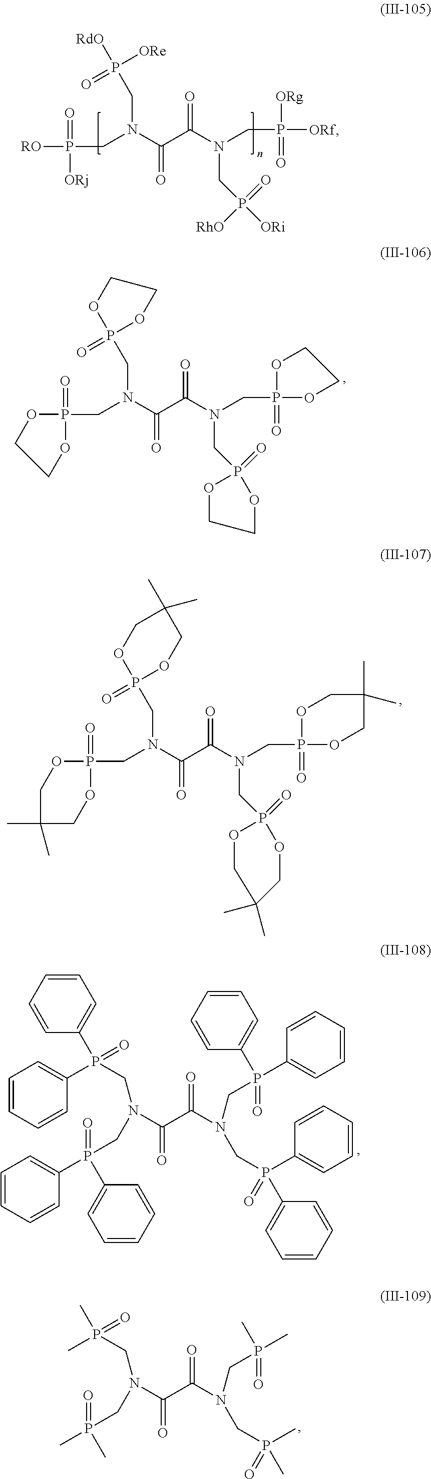

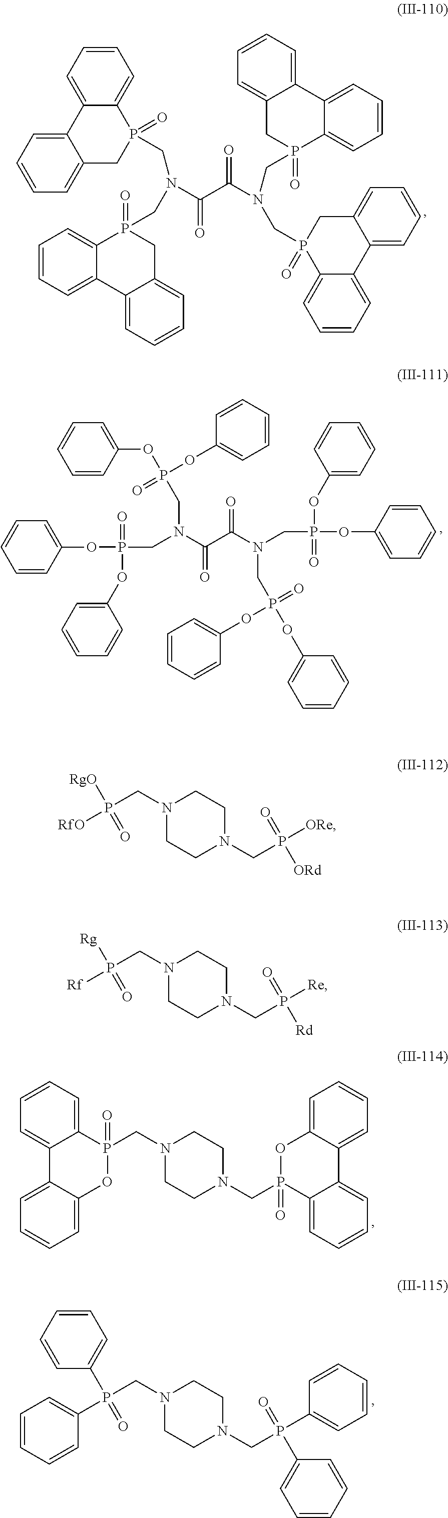

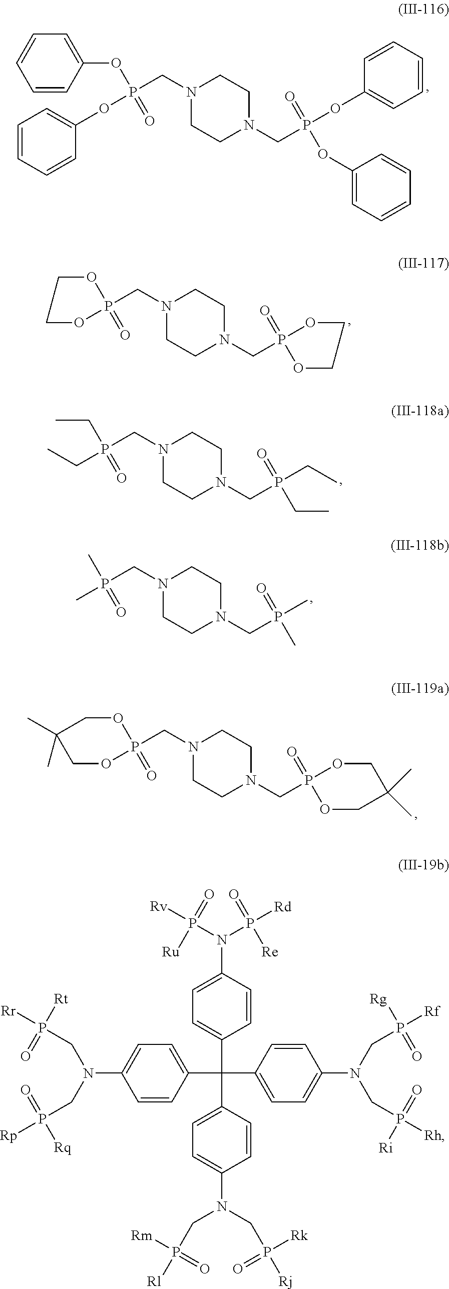

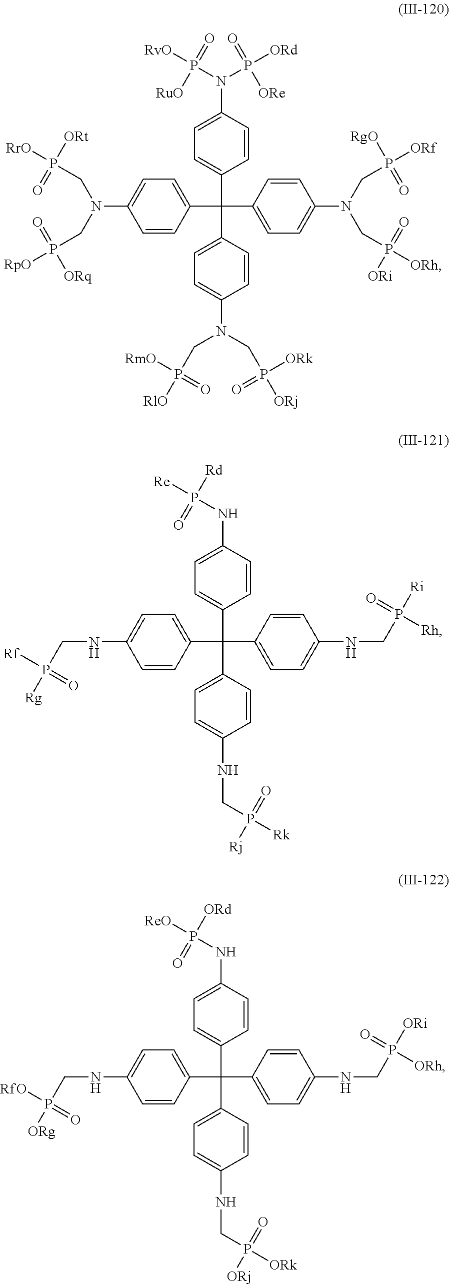

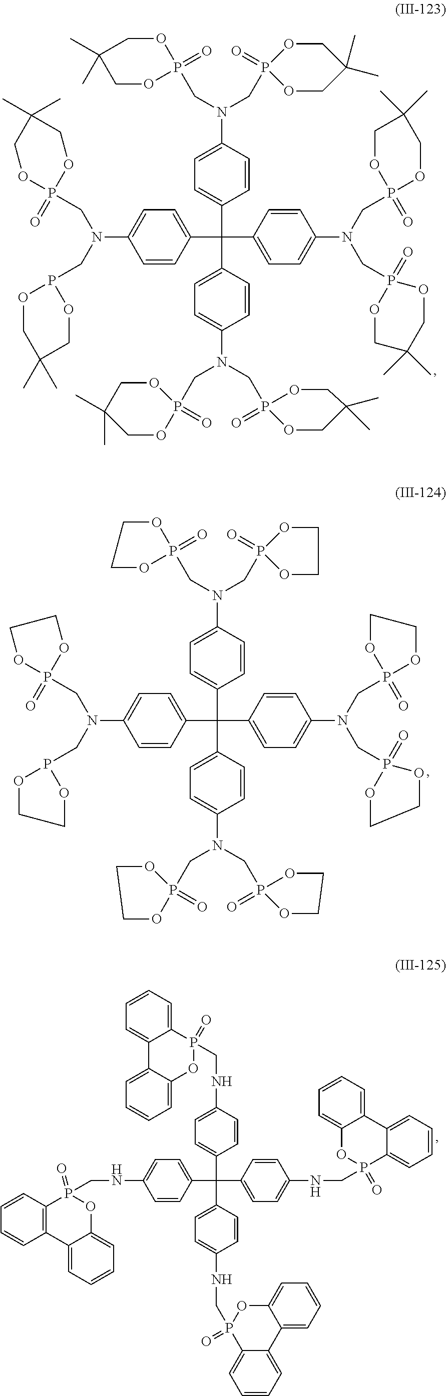

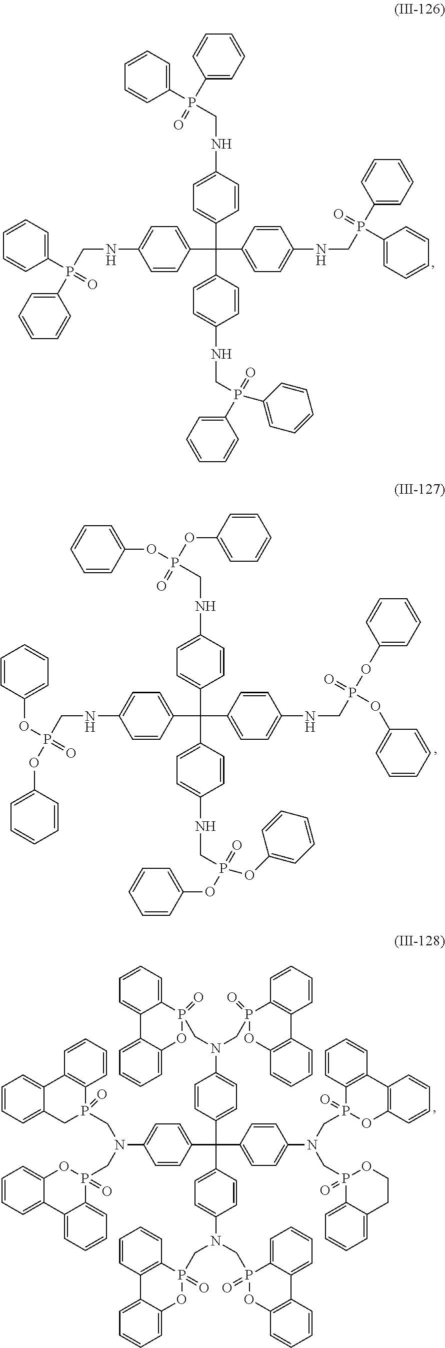

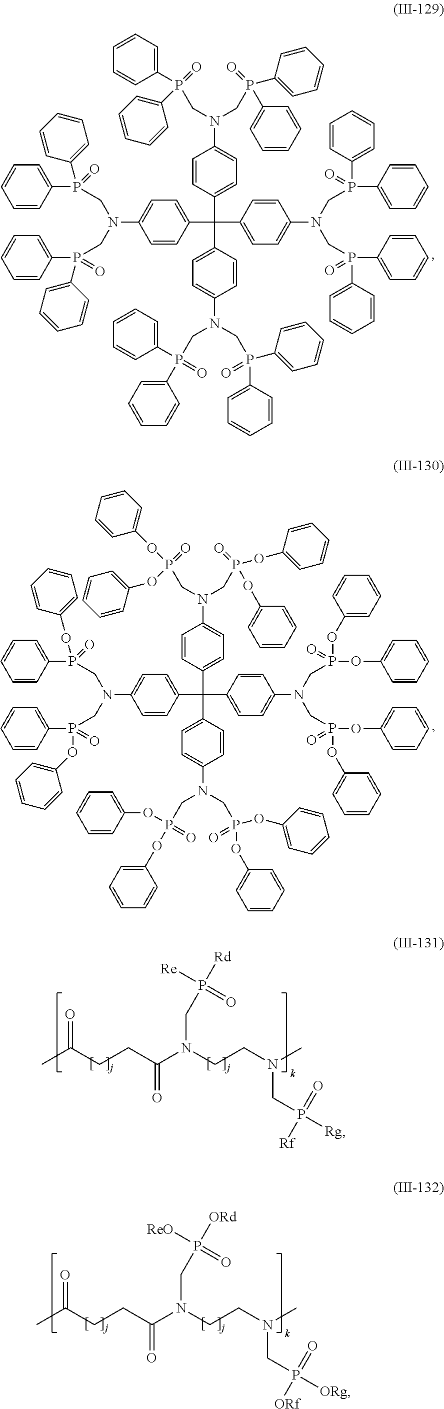

wherein i and j are integers equal to 0 or greater than 0; and k is an integer, equal to 1 or greater than 1;

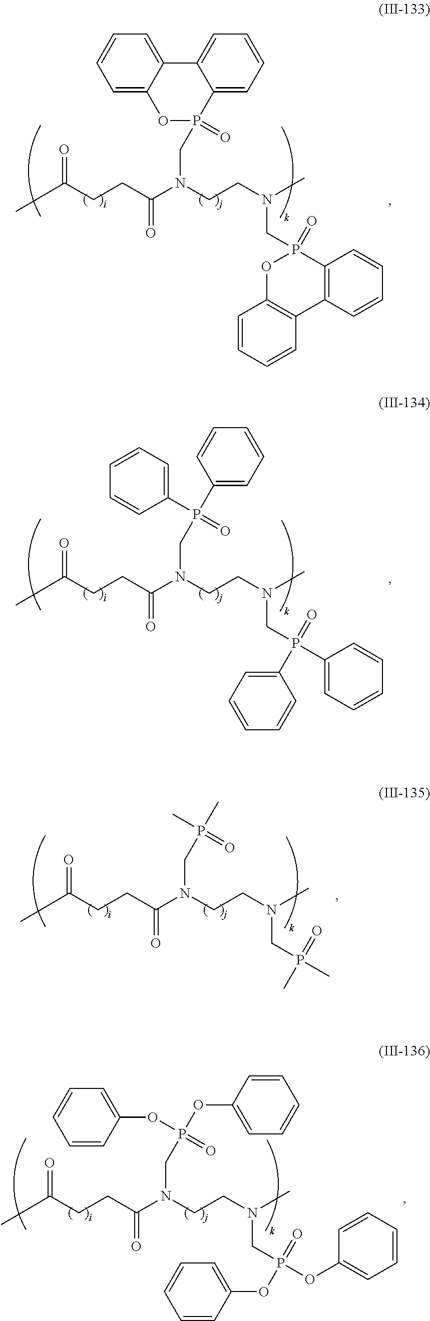

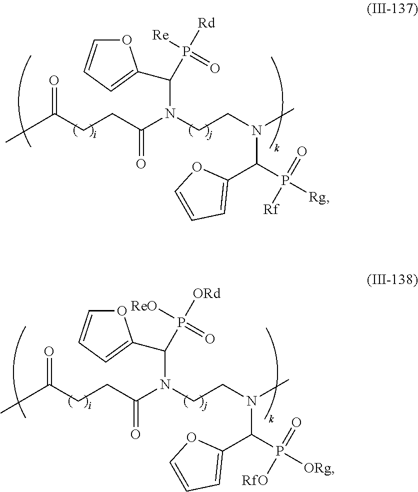

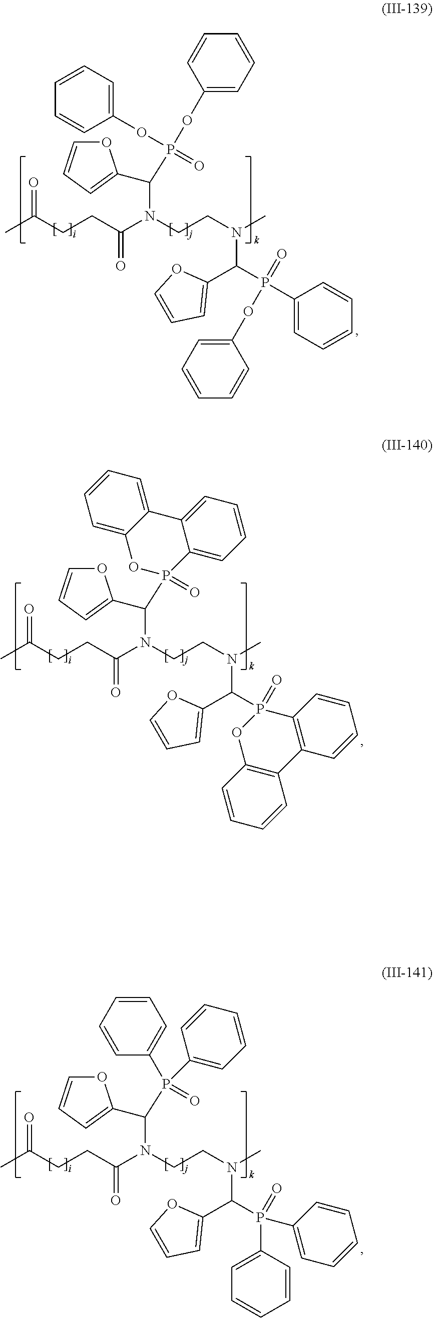

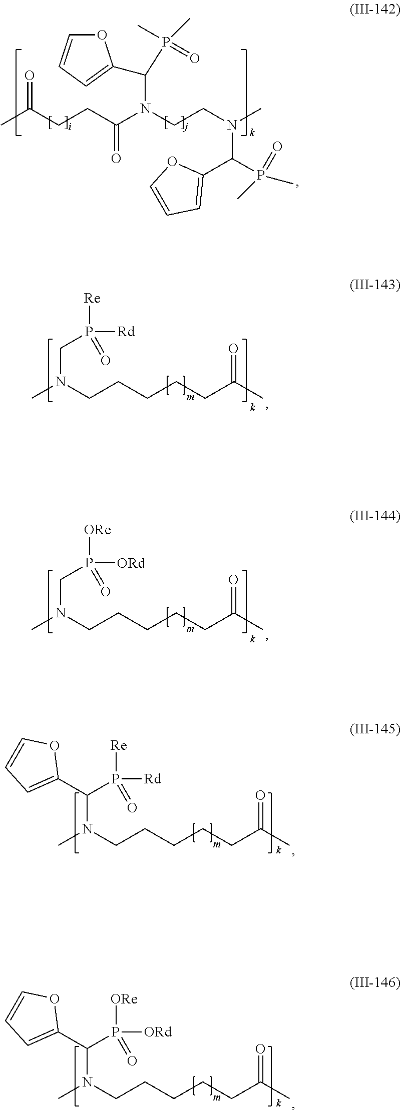

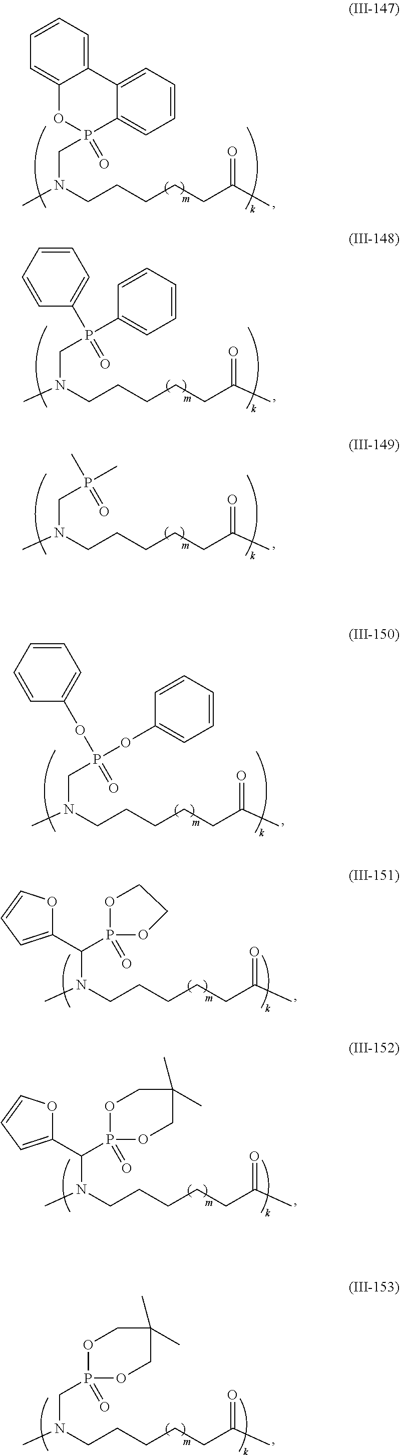

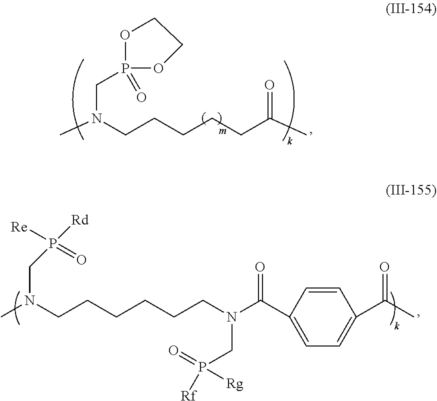

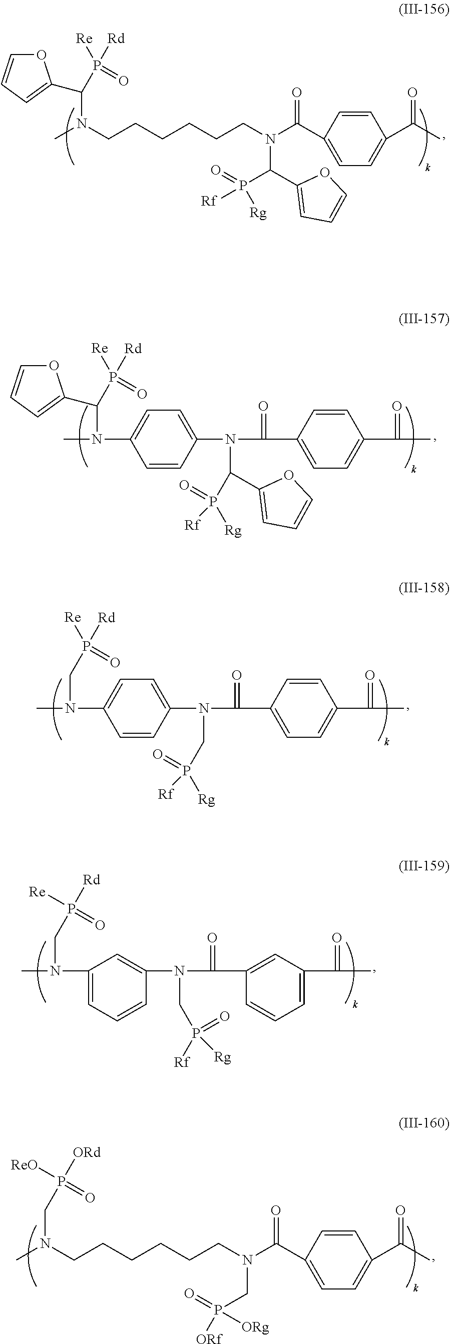

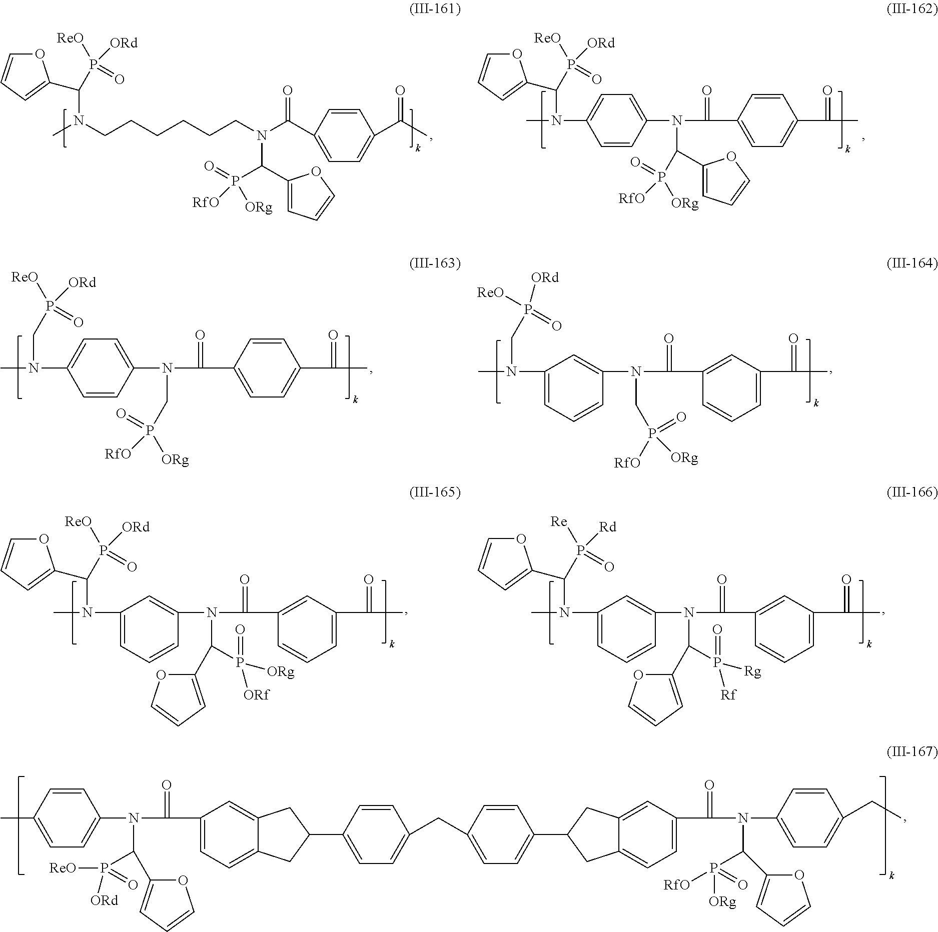

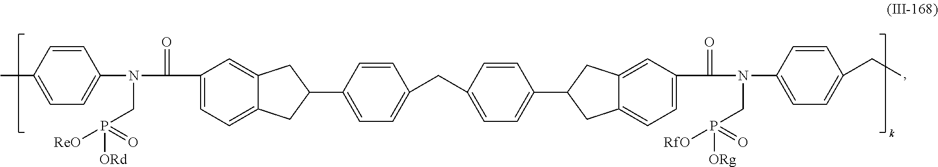

wherein i, j and m are integers ≤0; k is an integer ≥1;

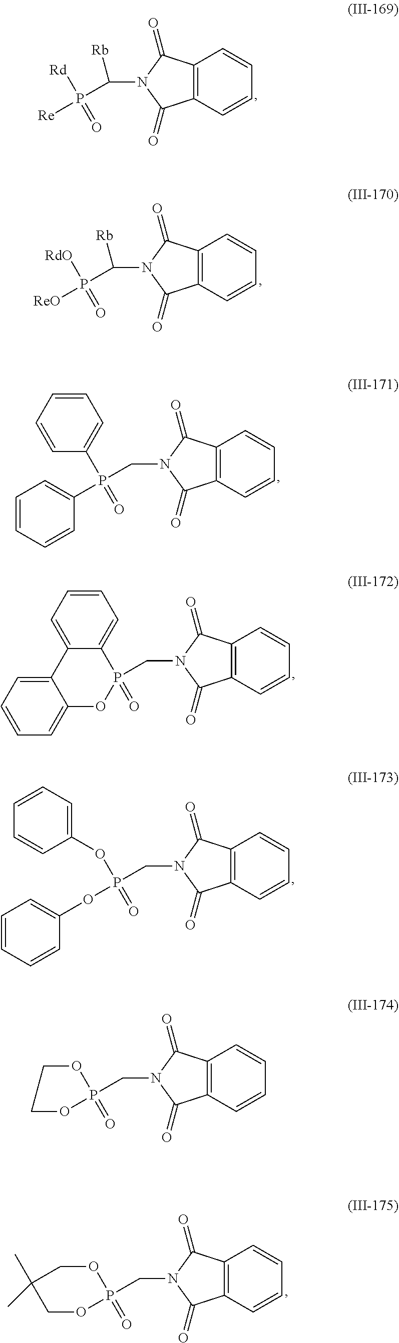

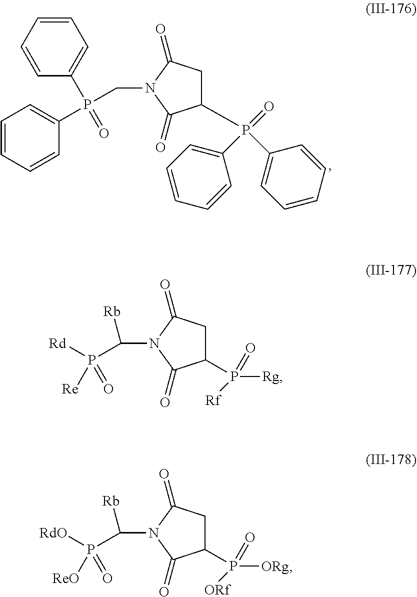

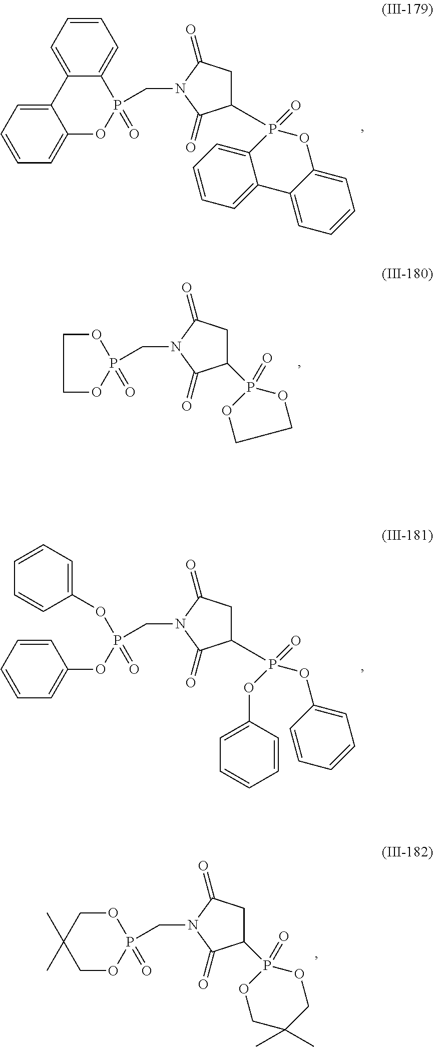

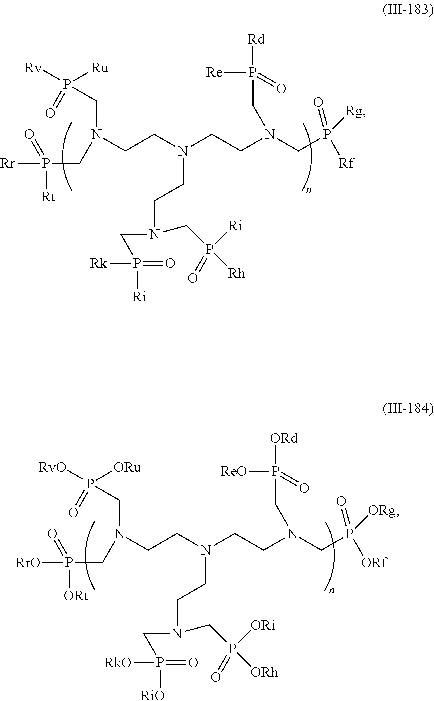

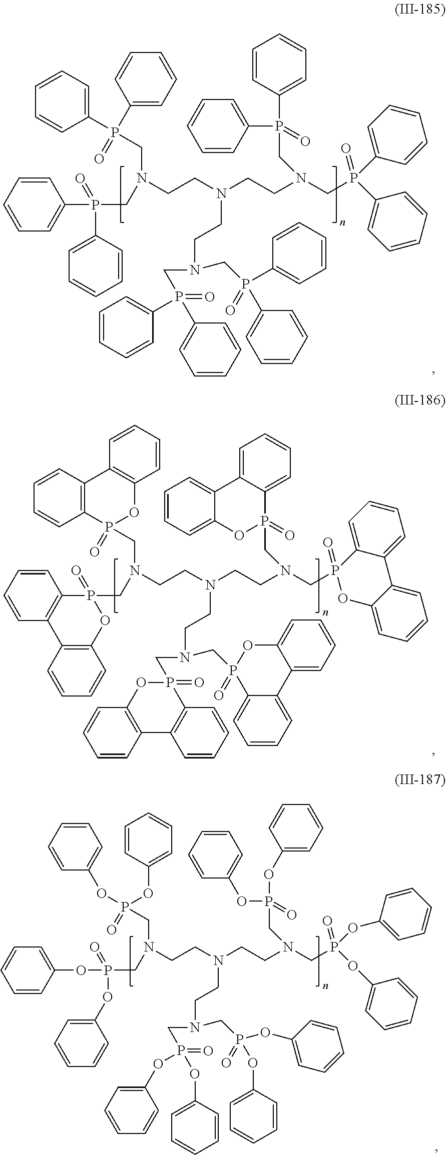

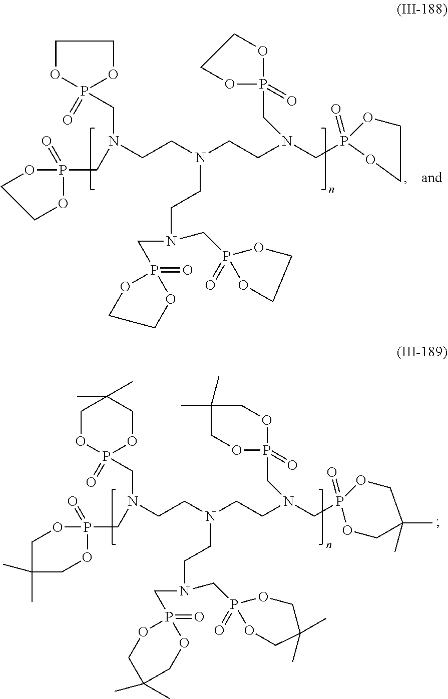

wherein n (if present) is an integer, n≥1, preferably n=1˜100; and

wherein, in all compounds (III-1) to (III-189), Re, Rd, Rf, Rg, Rh, Ri, Rk, Rj, Rm, Rl, Rp, Rq, Rr, Rt, Ru and Rv (if present) are independently of each other selected from C1-C24 alkyl, cycloalkyl, heteroalkyl, heterocycloalkyl, C6-C24 aryl, substituted aryl, C3-C24 heteroaryl, substituted heteroaryl, fused cycloalkyl aryl, fused cycloalkane heteroaryl group, fused heterocyclyl aryl, fused heterocyclyl heteroaryl, and nitrogen, silicon, oxygen, boron, sulfur, and carbonyl or sulfonyl substituted C1-C24 alkyl, cycloalkyl, heterocycloalkyl groups; and acyl radical; Rb is selected from hydrogen, C1-C18 alkyl, heteroalkyl, cycloalkyl, C6˜C18 aryl, substituted aryl, acyl radical, substituted or unsubstituted heterocyclic alkyl, substituted or unsubstituted heterocycles, and substituted or unsubstituted heteroaryl such as C3-C18 heteroaryl.

As previously described in the section of SUMMARY OF THE INVENTION, the present invention provides phosphorus nitrogen flame retardants represented by Formula (III), which may be prepared by the method of the present invention, or by any other suitable method(s):

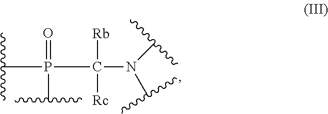

wherein Rb is independently of each other hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical;

wherein Rc is independently of each other hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical; and

wherein the waved lines represent any structural moiety or moieties.

For example, the phosphorus nitrogen flame retardant of the invention may be represented by anyone of Formulas (III-X), (III-Y), (III-1)˜(III-171) and (III-173)˜(III-189), as defined above.

As previously described in the section of SUMMARY OF THE INVENTION, the present invention provides a material comprising a base polymer and the phosphorus nitrogen flame retardant as described above. In many exemplary embodiments of the invention, the base polymer may be selected from resins which includes thermoplastic resins and thermseting resins. Examples of thermoplastic resin include, but are not limited to, polyphosphonate, polyethylene, polypropylene, polyisoprene, cyclic olefin copolymer, polyesters (e.g. polyethylene terephthalate, polybutylene terephthalate, polytrimethylene terephthalate, and polyethylene naphthalate), poly(2-ethyl-2-oxazoline), polycaprolactone, poly(lactic acid), poly(butylene adipate-co-terephthalate), polyhydroxyalkanoates, polypropylene carbonate, poly(farnenesene)diols, thermoplastic polyester elastomer (TPEE), TPE, thermoplastic polyolefin (TPO), thermoplastic vulcanizates (TPV), styrene-ethylene-butylene-styrene polybutadiene, polystyrene resin, impact-resistant polystyrene, acrylonitrile-styrene resin (SAN), acrylonitrile-butadiene-styrene resin (ABS resin), methyl methacrylate-butadiene-styrene resin (MBS resin), methyl methacrylate-acrylonitrile-butadiene-styrene resin (MABS resin), acrylonitrile-acrylic rubber-styrene resin (AAS resin), polymethyl (meth)acrylate, polycarbonate, polyphenylene ether, modified polyphenylene ether (mPPE), polyamide, polyphenylene sulfide, polyimide, polyether ether ketone, polysulfone, polyphenylsulfone, polyarylate, polyether ketone, polyether nitrile, polyvinyl chloride (PVC), chlorinated PVC, polyacrylonitrile, polyurethane, polythioether sulfone, polyether sulfone, polybenzimidazol, polycarbodiimide, polyamideimide, polyetherimide, polyacetal, liquid crystalline polymer, composite plastics and the like, any blend or mixture thereof. Examples of thermosetting resins include, but are not limited to, polyurethane, phenol resin, melamine resin, urea resin, unsaturated polyester resin, diallyl phthalate resin, silicon resin and epoxy resin; epoxy resins, bisphenol-A type epoxy resin, bisphenol-F type epoxy resin, bisphenol-AD type epoxy resin, phenol novolac type epoxy resin, cresol novolac type epoxy resin, cycloaliphatic epoxy resin, glycidyl ester-based resin, glycidyl amine-based epoxy resin, heterocyclic epoxy resin, urethane modified epoxy resin and brominated bisphenol-A type epoxy resin, and the like, and any blend or mixture thereof.

In some exemplary embodiments of the invention, the material may further include one or more components selected from antioxidants, UV stabilizers, pigments, anti-dripping agents, releasing agents, fillers, minerals, carbon fibers, glass fibers, impact modifiers, lubricants, smoke suppressants, other phosphorous flame retardants, nitrogen flame retardants, fluorine containing resins, and any mixture thereof.

In some specific embodiments, DOPO-containing phosphorus-nitrogen flame retardant has a structure as shown below:

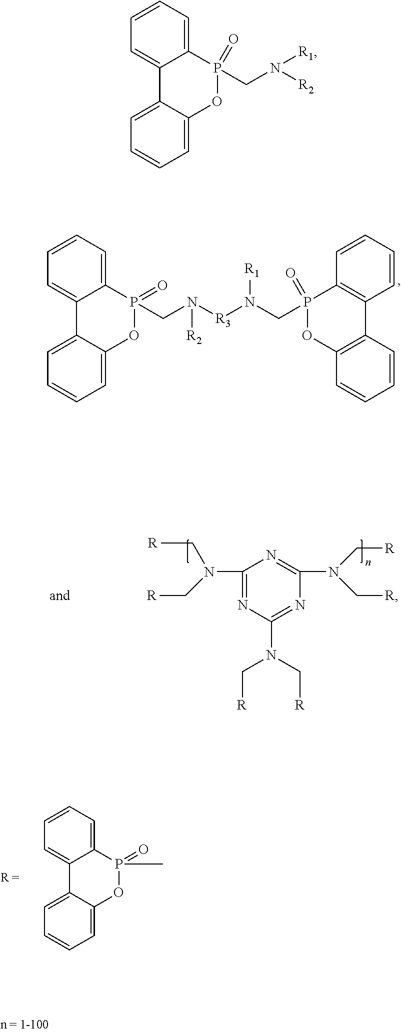

wherein R1 and R2 are selected from H, C1-C24 alkyl, cycloalkyl, heteroalkyl, heterocylcoalkyl, C6-C24 aryl, C3-C24 heteroaryl, fused cycloalkyl aryl, fused cycloalkane heteroaryl group, fused heterocyclyl aryl, fused heterocyclyl heteroaryl, and nitrogen, silicon, oxygen, boron, sulfur, and carbonyl or sulfonyl substituted C1-C24 alkyl groups; or, wherein R1 and R2 are connected through a saturated/unsaturated alkyl group, or bridging a heteroaryl group, a fused cycloalkyl aryl group, a fused ring with the N atom, cycloalkylheteroaryl, fused heterocyclylaryl, or fused heterocyclylheteroaryl. Further, the heteroaryl group is a monocyclic or polycyclic aromatic group, and the N atom is connected to the aromatic ring. The group contains one, two or three heterocyclic atoms being selected from N, O and S. The remaining ring atoms are C. Further, one or more carbon atoms of the heteroaryl group is substituted by a carbonyl group. Further, the heterocyclic group is a non-aromatic mono- or polycyclic group, wherein one or more ring atoms are selected from N, O, or S(O) x heteroatoms, where x is an integer from 0 to 2, and the remaining ring atoms are C. Further, the alkyl group includes linear, branched or aromatic ring-containing alkyl groups.

R3 is selected from C1-C24 alkyl, cycloalkyl, heteroalkyl, heterocycloalkyl, C6-C24 aryl, C3-C24 heteroaryl, fused cycloalkyl aryl, fused cycloalkane heteroaryl group, fused heterocyclyl aryl, fused heterocyclyl heteroaryl, and silicon, oxygen, boron, nitrogen, sulfur, and carbonyl or sulfonyl substituted C1-C24 alkyl groups; and unsaturated alkyl.

For example, the DOPO-containing flame retardant may have the following structures:

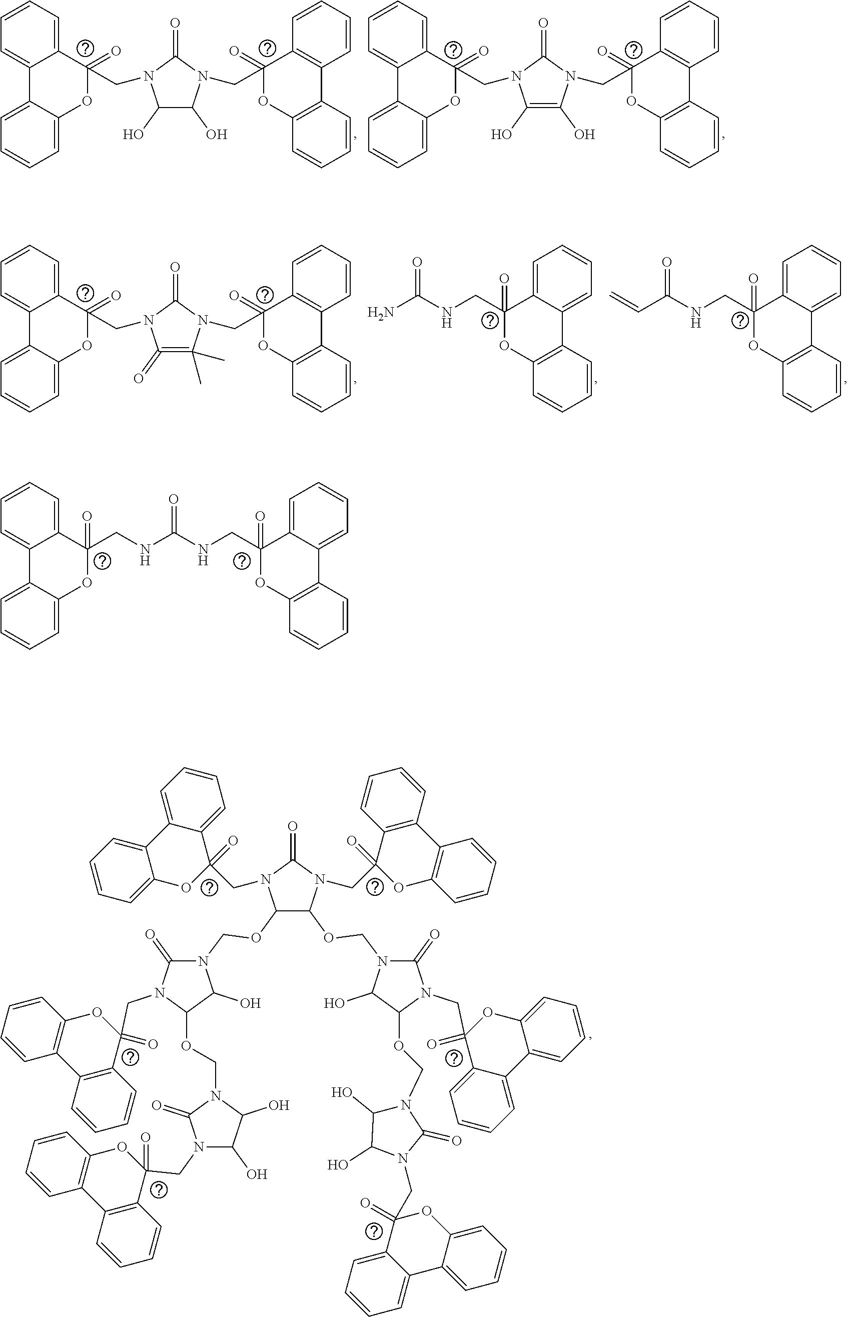

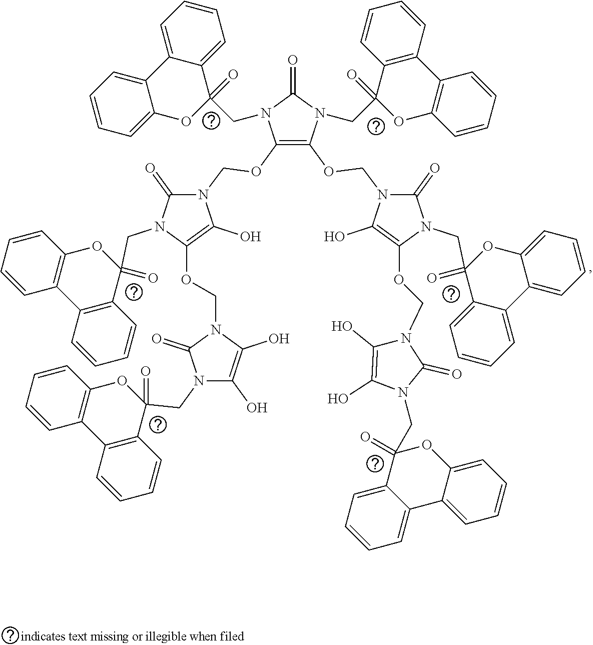

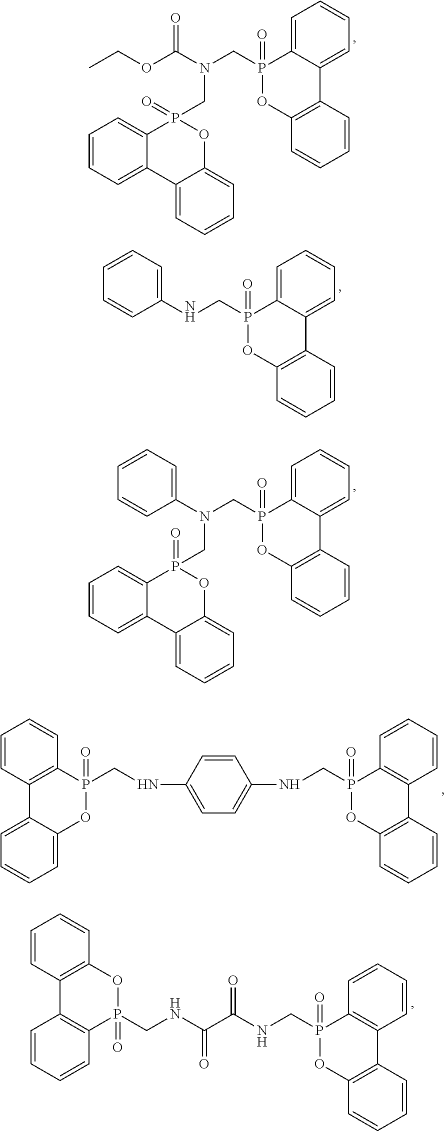

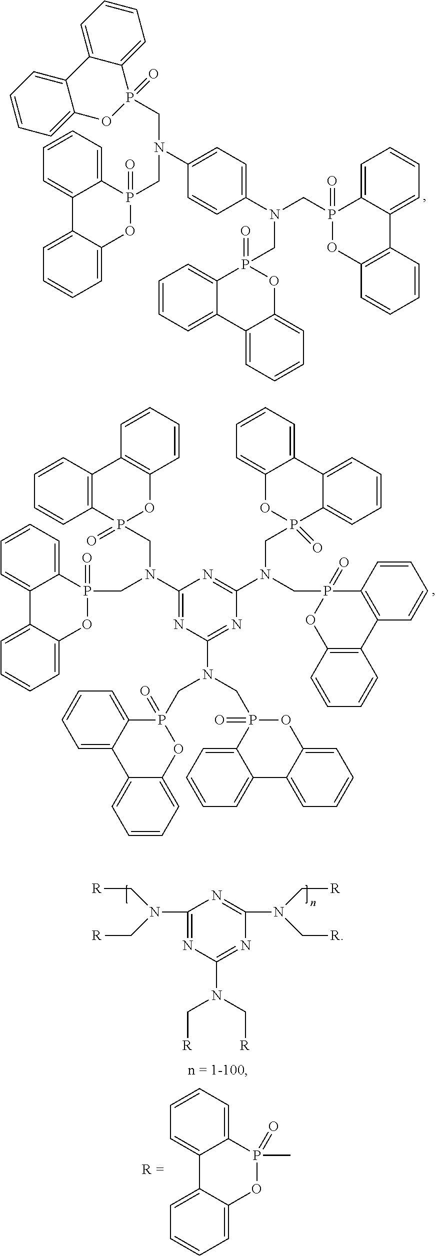

One embodiment of the present invention provides a preparation method of the DOPO-containing phosphorus-nitrogen flame retardant, which includes the following steps:

(i) heating to melt 9,10-dihydro-9-oxa-10-phosphaphenanthrene-10-oxide (DOPO);

(ii) adding the following structure compound or its ether derivatives to the molten 9,10-dihydro-9-oxa-10-phosphaphenanthrene-10-oxide, wherein R1 and R2 are defined as above:

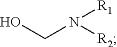

and

(iii) stirring the mixture for a period of time, then increasing the temperature and continue to stir until the reaction is over, cool down to obtain DOPO-containing phosphorus nitrogen type flame retardant.

Further, in the above preparation method, a strong acid catalyst is further added in the step (ii). Strong acid catalyst can accelerate the reaction and improve production efficiency. Preferably, the strong acid catalyst is selected from p-benzenesulfonic acid, p-benzenesulfonic acid hydrate or its alcohol solution, phosphoric acid, hydrochloric acid or one or more mixtures of sulfuric acid. Further, the amount of the strong acid catalyst is 0.01 to 5% of the mass of the raw material. Further, in the above preparation method, the heating temperature in step (i) is 215-221° C. The temperature should be high enough to melt it. However, too high temperature will increase energy consumption and increase the process cost. Further, in the above preparation method step (ii), after stirring and reacting for 30-40 minutes, the reaction temperature is increased to 225-230° C. The viscosity of the system in the late stage of the reaction of the above preparation method increases significantly, and the stirring can be effectively carried out by increasing the reaction temperature.

The present invention can exhibit numerous technical merits. For example, the DOPO-containing phosphorus-nitrogen flame retardant of the present invention has shown excellent flame retardant efficacy in a wide range of polymers, e.g. epoxy resin, ABS, PMMA, TPV, nylon, polyester, polyolefin, polyurethane, polycarbonate and other polymers. The flame retardant of the present invention belongs to organic macromolecules, so it shows good compatibility with polymers. It is also very difficult to migrate to the surface. The flame retardant in the present invention also shows excellent hydrolysis resistance. Additionally, the flame retardant of the present invention belongs to an intumescent-type flame retardant and exhibits low smoke and low toxicity during burning. The preparation method of the present invention has simpler process, fewer by-products, shorter reaction time, higher yield, and no environmental impact.

### EXAMPLES

### Example 1: Preparation of Flame Retardant

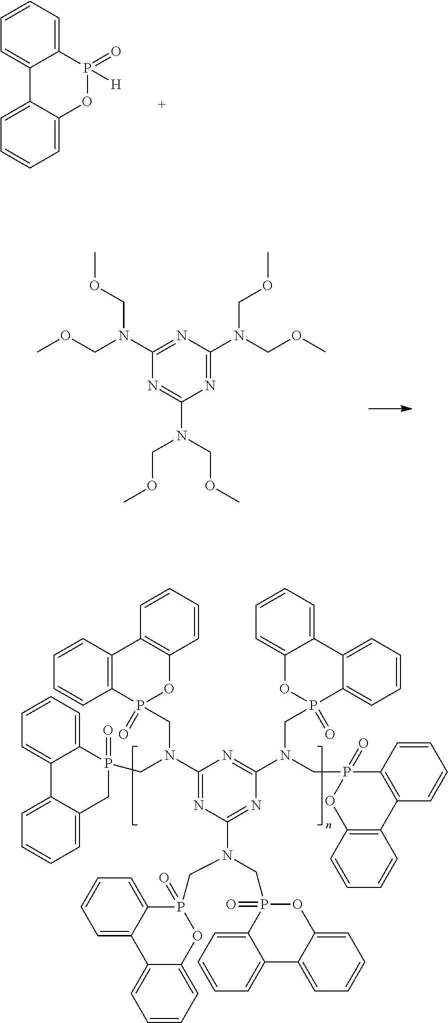

wherein n is integers, n≥1.

490 g of 9,10-dihydro-9-oxa-10-phosphaphenanthrene-10-Oxide (DOPO) was added into a 1000-ml three-neck flask equipped with a stirrer and then is melt at 170° C. Next, 210 g of hexamethylol melamine hexamethyl ether was added into the mixture. In order to accelerate reaction, 0.1% benzenesulfonic acid was added into the mixture as a strong acid catalyst. The reaction mixture was agitated strongly. The melt viscosity rises significantly while producing by-product methanol. After 30 minutes, the reaction mixture was heated up to 230° C. and was continuously stirred for a few hours until almost no methanol was produced. After cooling, the product was a pale-yellow solid with a yield of 84%. The glass transition temperature of the product as measured by DSC is 140° C.

### Example 2: Preparation of Flame Retardant

525 g of 9,10-dihydro-9-oxa-10-phosphaphenanthrene-10-Oxide (DOPO) was added into a 1000-ml three-neck flask equipped with a stirrer and then is melt at 170° C. Next, 175 g of hexamethylol melamine hexamethyl ether was added into the flask. In order to accelerate reaction, 0.1% benzenesulfonic acid was added into the mixture as a strong acid catalyst. The reaction mixture was agitated strongly. The melt viscosity rises significantly while producing by-product methanol. After 35 minutes, the reaction mixture was heated up to 235° C. and is continuously stirred for a few hours until almost no methanol is produced. After cooling, the product is a transparent solid with a yield of 89%. The glass transition temperature of the product as measured by DSC is 121° C.

### Example 3: Preparation of Flame Retardant

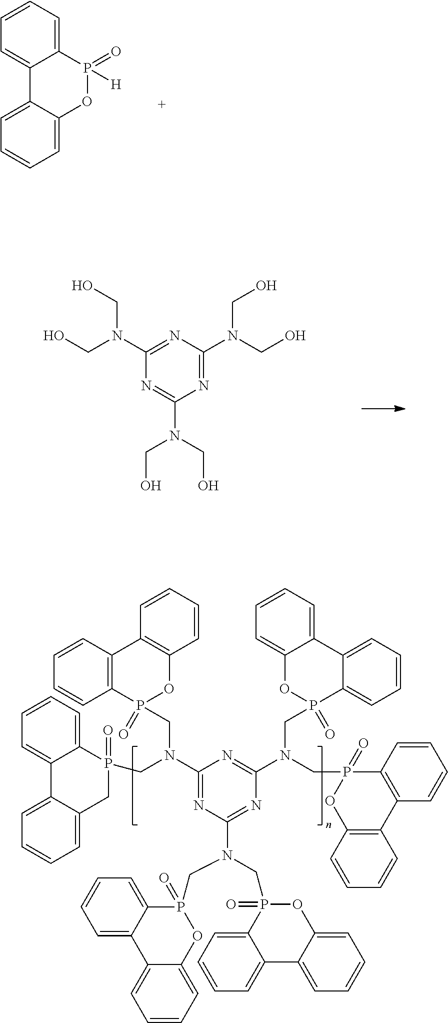

wherein n is integers, n≥1.

520 g of 9,10-dihydro-9-oxa-10-phosphaphenanthrene-10-Oxide (DOPO) was added into a 1000-ml three-neck flask equipped with a stirrer and was then melt at 165° C. Next, 140 g of hexamethylol melamine was added into the flask. In order to accelerate the reaction, 0.1% benzenesulfonic acid was added into the mixture as a strong acid catalyst. The reaction mixture was agitated strongly. The melt viscosity rises significantly while producing by-product water. After 40 minutes, the reaction mixture was heated up to 240° C. and continuously is stirred for a few hours until almost no water is produced. After cooling, the product is a pale-yellow solid with a yield of 89%. The glass transition temperature of the product as detected by DSC is 147° C.

### Example 4: Preparation of Flame Retardant

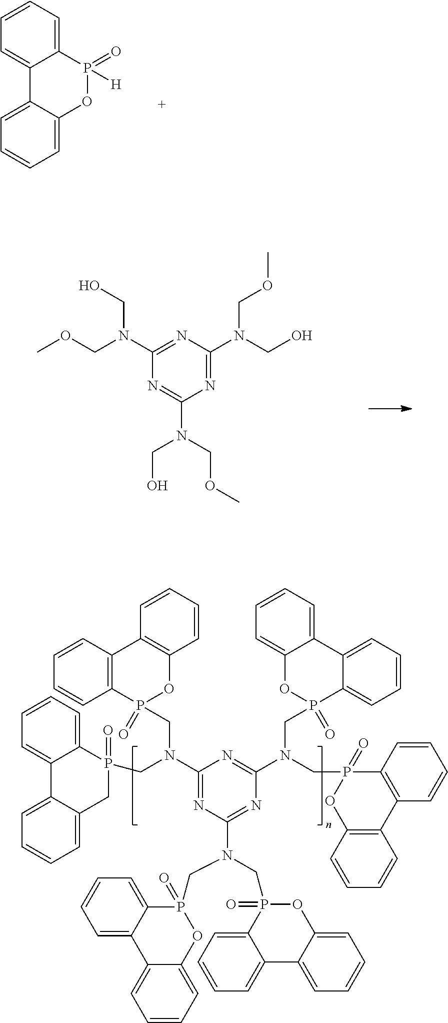

wherein n is integers, n≥1.

520 g of 9,10-dihydro-9-oxa-10-phosphaphenanthrene-10-Oxide (dopo) was added into a 1000-ml three-neck flask equipped with a stirrer and was then melt at 170° C. Next, 160 g of trimethylol melamine trimethyl ether was added into the flask. In order to accelerate the reaction, 0.1% benzenesulfonic acid was added into the mixture as a strong acid catalyst. The reaction mixture was agitated strongly. The melt viscosity rises significantly while producing by-product methanol and water. After 30 minutes, the reaction mixture was heated up to 230° C. and was continuously stirred for a few hours until almost no water and methanol is produced. After cooling, the product is a pale-yellow solid with a yield of 86%. The glass transition temperature of the product as detected by DSC is 145° C.

### Example 5. Preparation of Flame Retardant

448 g of 9,10-dihydro-9-oxa-10-phosphaphenanthrene-10-Oxide (dopo) was added into a 1000-ml three-neck flask equipped with a stirrer and was then melt at 165° C. Next, 252 g of dimethylol ethylene urea was added into the flask. In order to accelerate the reaction, 0.1% benzenesulfonic acid was added into the mixture as a strong acid catalyst. The reaction mixture was agitated strongly. The melt viscosity rises significantly while producing by-product water. After 40 minutes, the reaction mixture was heated up to 220° C. and was continuously stirred for a few hours until almost no water was produced. After cooling, the product is a pale-yellow solid with a yield of 83%. The glass transition temperature of the product as detected by DSC is 105° C.

### Example 6: Preparation of Flame Retardant

580.3 g of 9,10-dihydro-9-oxa-10-phosphaphenanthrene-10-Oxide (dopo) was added into a 1000-ml three-neck flask equipped with a stirrer and was then melt at 165° C. Next, 119.7 g of dimethylol ethylene urea was added into the flask. In order to accelerate the reaction, 0.1% benzenesulfonic acid was added into the mixture as a strong acid catalyst. The reaction mixture was agitated strongly. The melt viscosity rises significantly while producing by-product water. After 40 minutes, the reaction mixture was heated up to 200° C. and was continuously stirred for a few hours until almost no water is produced. After cooling, the product is a dark red solid with a yield of 80%. The glass transition temperature of the product as detected by DSC is 60° C.

### Example 7: Preparation of Flame Retardant

495.6 g of 9,10-dihydro-9-oxa-10-phosphaphenanthrene-10-Oxide (dopo) was added into a 1000-ml three-neck flask equipped with a stirrer and was then melt at 165° C. Next, 204.4 g of dimethylol ethylene urea was added into the flask. In order to accelerate the reaction, 0.1% benzenesulfonic acid was added into the mixture as a strong acid catalyst. The reaction mixture was agitated strongly. The melt viscosity rises significantly while producing by-product water. After 40 minutes, the reaction mixture was heated up to 230° C. and was continuously stirred for a few hours until almost no water was produced. After cooling, the product is a dark red solid with a yield of 80%. The glass transition temperature of the product as detected by DSC is 85° C.

### Example 8: Preparation of Flame Retardant

420.0 g of 9,10-dihydro-9-oxa-10-phosphaphenanthrene-10-Oxide (dopo) was added into a 1000-ml three-neck flask equipped with a stirrer and was then melt at 200° C. Next, 280 g of methylolated dimethylol dihydroxyethylene urea was added into the flask. In order to accelerate reaction, 0.1% benzenesulfonic acid was added into the mixture as a strong acid catalyst. The reaction mixture was agitated strongly. The melt viscosity rises significantly while producing by-product methanol and water. After 40 minutes, the reaction mixture was heated up to 240° C. and was continuously stirred for a few hours until almost no methanol and water was produced. After cooling, the product is a dark red solid with a yield of 80%. The glass transition temperature of the product as detected by DSC is 100° C.

### Example 9: Preparation of Flame Retardant

473.9 g of 9,10-dihydro-9-oxa-10-phosphaphenanthrene-10-Oxide (dopo) was added into a 1000-ml three-neck flask equipped with a stirrer and was then melt at 180° C. Next, 226.1 g of methylolated dimethylol dihydroxyethylene urea was added into the flask. In order to accelerate the reaction, 0.1% benzenesulfonic acid was added into the mixture as a strong acid catalyst. The reaction mixture was agitated strongly. The melt viscosity rises significantly while producing by-product methanol and water. After 40 minutes, the reaction mixture was heated up to 220° C. and was continuously stirred for a few hours until almost no methanol and water was produced. After cooling, the product is a dark red solid with a yield of 80%. The glass transition temperature of the product as detected by DSC is 85° C.

### Example 10: Performance of Flame Retardant

Nylon 6 YH800 (Yueyang Baling Petrochemical) and the product obtained in Example 1 were mixed at a weight ratio of 85:15 and extruded in a twin-screw extruder (Nanjing Mianya Machinery Manufacturing Co., Ltd.) with a diameter of 40 mm. The extrusion temperature was 220° C., and the screw speed is 300 rpm. After drying, the extruded material was put in a 1.7 mm thick compression mold, preheated for 5 minutes in a flat vulcanizer at 230° C., pressed at 5 MPa for 3 minutes, and then cut into the testing specimens with dimensions of 125×12.5×1.7 mm. The flame retardancy rating of the product is UL-94 V0 @1.7 mm.

### Example 11: Performance of Flame Retardant

The ether-based polyurethane TPU 5182 (Shanghai Yitan New Material Co., Ltd.) and the product obtained in Example 2 were mixed at a weight ratio of 85:15 and extruded in a twin-screw extruder (Nanjing Mianya Machinery Manufacturing Co., Ltd.) with a diameter of 40 mm. The extrusion temperature was 180° C., and the screw speed was 300 rpm. After drying, the extruded material was placed in a 1.7 mm thick compression mold, preheated for 5 minutes in a flat vulcanizer at 180° C., then pressed at 5 MPa for 3 minutes, and then cut into the testing specimens with dimensions of 125×12.5×1.7 mm. The flame retardancy rating of the product was UL-94 V0 @1.7 mm.

### Example 12: Performance of Flame Retardant

Nylon 6,6 101F (DuPont) and the product obtained in Example 1 were mixed at a weight ratio of 90:10 and extruded in a twin-screw extruder (Nanjing Mianya Machinery Manufacturing Co., Ltd.) with a diameter of 40 mm. The extrusion temperature was 255° C., and the screw speed was 300 rpm. After drying, the extruded material was put in a 1.7 mm thick compression mold, preheated for 5 minutes in a flat vulcanizer at 260° C., then pressed at 5 MPa for 3 minutes, and then cut into the testing specimens with dimensions: 125×12.5×1.7 mm. The flame retardancy rating of the product is UL-94 V0 @1.7 mm.

### Example 13: Performance of Flame Retardant

The polyester PET FG600 (intrinsic viscosity: 0.675) (Sinopec Yizheng Chemical Fiber Co., Ltd.) and the product obtained in Example 1 were mixed at a weight ratio of 90:10 and extruded in a twin-screw extruder (Nanjing Mianya Machinery Manufacturing Co., Ltd.) with a diameter of 40 mm. The extrusion temperature was 255° C., and the screw speed was 300 rpm. After drying, the extruded material was put in a 3 mm thick compression mold, preheated for 5 minutes in a flat vulcanizer at 260° C., then pressed at 5 MPa for 3 minutes, and then cut into the testing specimens with dimensions: 125×12.5×3 mm. The flame retardancy rating of the product is UL-94 V0 @3 mm.

### Example 14: Performance of Flame Retardant

Polypropylene PP MR700 (Shanghai Jinshan Petrochemical Company) and the product obtained in Example 1 were mixed at a weight ratio of 75:25 and extruded in a twin-screw extruder (Nanjing Mianya Machinery Manufacturing Co., Ltd.) with a diameter of 40 mm. The extrusion temperature was 220° C., and the screw speed was 300 rpm. After drying, the extruded material was put in a 3 mm thick compression mold, preheated for 5 minutes in a flat vulcanizer at 220° C., then pressed at 5 MPa for 3 minutes, and then cut into the testing specimens with dimensions: 125×12.5×3 mm. The flame retardancy rating of the product is UL-94 V0 (@3 mm.

### Example 15: Performance of Flame Retardant

The ether based polyurethane TPU 5182 (Shanghai Yitan New Material Co., Ltd.) and the product obtained in Example 5 were mixed at a ratio of 90:10 and extruded in a twin-screw extruder (Nanjing Mianya Machinery Manufacturing Co., Ltd.) with a diameter of 40 mm. The extrusion temperature was 180° C., and the screw speed was 300 rpm. After drying, the extruded material was put in a 0.8 mm thick compression mold, preheated for 5 minutes in a flat vulcanizer at 220° C., then pressed at 5 MPa for 3 minutes, and then cut into the testing specimens with dimensions: 125×12.5×0.8 mm. The flame retardancy rating of the product is UL-94 V0 @0.8 mm.

### Example 16: Performance of Flame Retardant

Nylon 6 YH800 (Yueyang Baling Petrochemical) and the product obtained in Example 5 were mixed at a weight ratio of 85:15 and extruded in a twin-screw extruder (Nanjing Mianya Machinery Manufacturing Co., Ltd.) with a diameter of 40 mm. The extrusion temperature was 200° C., and the screw speed was 300 rpm. After drying, the extruded material was put in a 1.7 mm thick compression mold, preheated for 5 minutes in a flat vulcanizer at 220° C., then pressed at 5 MPa for 3 minutes, and then cut into the testing specimens with dimensions: 125×12.5×1.7 mm. The flame retardancy rating of the product is UL-94 V0 @1.7 mm.

### Example 17: Performance of Flame Retardant

Nylon 6 YH800 (Yueyang Baling Petrochemical) and the product obtained in Example 8 were mixed at a weight ratio of 85:15 and extruded in a twin-screw extruder (Nanjing Mianya Machinery Manufacturing Co., Ltd.) with a diameter of 40 mm. The extrusion temperature was 200° C., and the screw speed was 300 rpm. After drying, the extruded material was put in a 1.7 mm thick compression mold, preheated for 5 minutes in a flat vulcanizer at 230° C., then pressed at 5 MPa for 3 minutes, and then cut into the testing specimens with dimensions: 125×12.5×1.7 mm. The flame retardancy rating of the product is UL-94 V0 @1.7 mm.

### Example 18: Performance of Flame Retardant

Nylon 6 YH800 (Yueyang Baling Petrochemical) and the product obtained in Example 8 were mixed at a weight ratio of 90:10 and extruded in a twin-screw extruder (Nanjing Mianya Machinery Manufacturing Co., Ltd.) with a diameter of 40 mm. The extrusion temperature was 200° C., and the screw speed was 300 rpm. After drying, the extruded material was put in a 1.7 mm thick compression mold, preheated for 5 minutes in a flat vulcanizer at 230° C., then pressed at 5 MPa for 3 minutes, and then cut into the testing specimens with dimensions: 125×12.5×1.7 mm. The flame retardancy rating of the product is UL-94 V2 @1.7 mm.

In the foregoing specification, embodiments of the present invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicant to be the scope of the invention, is the literal and equivalent scope of the set of claims that issue from this application, in the specific form in which such claims issue, including any subsequent correction.

1. A method of preparing a phosphorus nitrogen flame retardant, comprising:
(1) providing a first compound containing m reactive group(s) each of which is represented by formula (I), wherein m is an integer and m≥1: 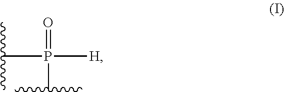
wherein the waved lines represent any structural moiety or moieties;
(2) providing a second compound containing n reactive group(s) each of which is represented by formula (II), wherein n is an integer and n≥1: 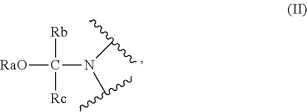
wherein Ra is independently of each other selected from hydrogen, C1-C18 alkyl, heteroalkyl, cycloalkyl, heterocycloalkyl, substituted or unsubstituted aryl, substituted or unsubstituted C6˜C18 aryl, substituted or unsubstituted C3˜C18 heteroaryl, substituted or unsubstituted heterocycles, alkyl such as methyl, ethyl and propyl, butyl, pentyl, hexyl, heptyl, octyl, nonyl, decyl, undecyl, dodecyl, isopropyl, isobutyl, isoheptyl, isohexyl, isooctyl, isononyl, isodecyl, isoundecyl, isododecyl, cyclic hexyl, cyclicbutyl, cyclic propyl, cyclic heptyl, cyclic octyl; and acyl radical;
wherein Rb is independently of each other selected from hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical;
wherein Rc is independently of each other selected from hydrogen, substituted or unsubstituted alkyl such as C1-C18 alkyl, substituted or unsubstituted heteroalkyl, substituted or unsubstituted heterocyclic alkyl, substituted or unsubstituted cycloalkyl, substituted or unsubstituted heterocycles, substituted or unsubstituted aryl such as C6˜C18 aryl, substituted or unsubstituted heteroaryl such as C3˜C18 heteroaryl, and acyl radical; and
wherein the waved lines represent any structural moiety or moieties;
(3) mixing the first and second compounds in the absence of any solvent to react each other according to reaction scheme ZCF below, so as to prepare a phosphorus nitrogen flame retardant containing p group(s) each of which is represented by formula (III), wherein p is an integer, and p≥1:

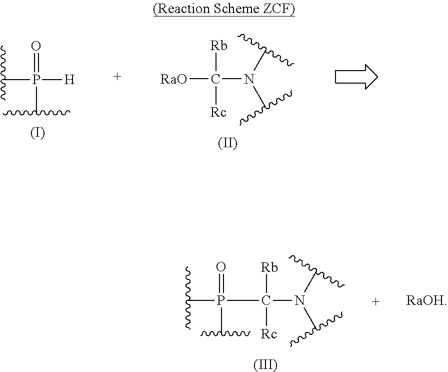

2. The method according to claim 1, wherein a reactive group represented by formula (IIa) if contained in the second compound is counted as two reactive groups of formula (II): 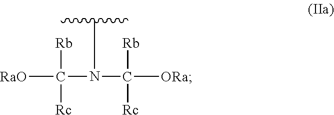
and
wherein a group represented by formula (IIIa) if contained in said phosphorus nitrogen flame retardant is counted as two groups of formula (III):

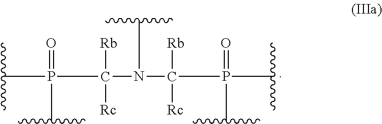

3. The method according to claim 1, wherein said solvent is a nonpolar solvent; a polar solvent; an aprotic solvent; a protic solvent; a nonpolar hydrocarbon solvent such as heptane, pentane, hexane, benzene, xylene, and toluene; a nonpolar ether solvent such as 1, 4-dioxane, diethyl ether, and tetrahydrofuran (THF); a nonpolar chlorocarbon solvent such as chloroform; a polar aprotic solvent such as dichloromethane (DCM), ethyl acetate, acetone, dimethyl formamide (DMF), acetonitrile (MeCN), dimethyl sulfoxide (DMSO), nitromethane, chlorobenzene, chlorobromomethane, and propylene carbonate; a polar protic solvent such as ammonia, formic acid, n-butanol, isopropyl alcohol (IPA), n-propanol, ethanol, methanol, acetic acid, and water; pyridine, benzoyl, cyclohexane, dichlorobenzene, diethylene glycol, furfural, isopropyl ether, lactic acid, nitrobenzene, polydimethylsiloxane, glycerin, cresols, citric acid, carbon disulfide, butylacetate, acrylonitrile, butyl phthalate, dichloroethane, phthalates, or any mixture thereof.

4. The method according to claim 1, wherein the first compound has a melting temperature point T1, the second compound has a melting temperature point T2, the first compound has a boiling temperature point or decomposition temperature point T3, and the second compound has a boiling temperature point or decomposition temperature point T4,
wherein the method further comprises heating the mixture of the first and second compounds in step (3) to a reaction temperature Tr, and
wherein Tr is between T1 and T2, Tr is higher than both T1 and T2, Tr is between T3 and T4, or Tr is higher than both T3 and T4.

5. The method according to claim 4, wherein the reaction temperature Tr during step (3) is increased from a temperature between T1 and T2 (inclusive) to a temperature between T3 and T4 (inclusive) or a temperature higher than both T3 and T4.

6. The method according to claim 5, wherein the first compound is DOPO, T1=119° C., and T3=230° C.

7. The method according to claim 1, wherein m=1 (such as DOPO); n≥2, 3, 4, 5, 6, 7 or 8; and p=n.

8. The method according to claim 1, wherein the entire reaction mixture in step (3) consists of the first compound and the second compound.

9. The method according to claim 1, wherein the entre reaction mixture in step (3) consists of the first compound, the second compound, and a catalyst such as an acid catalyst, and wherein the reaction in step (3) is catalyzed by said catalyst.

10. The method according to claim 9, wherein the catalyst is selected from benzenesulfonic acid, p-toluenesulfonic acid, p-toluenesulfonic acid hydrate or its alcohol solution, phosphoric acid, hydrochloric acid, sulfuric acid, boric acid, nitric acid, hydrofluoric acid (HF), hydrobromic acid (HBr), hydroiodic acid (HI), trifluoromethanesulfonic acid, ethanesulfonic acid, methanesulfonic acid, acetic acid, formic acid, hexafluorophosphoric acid, fluoroboric acid, fluorosulfuric acid, fluoroantimonic acid, chromic acid, fluoroacetic acid, trifluoroacetic acid, chloroacetic acid, dichloroacetic acid, trichloroacetic acid, or any mixture thereof.

11. The method according to claim 1, wherein said first compound is selected from: 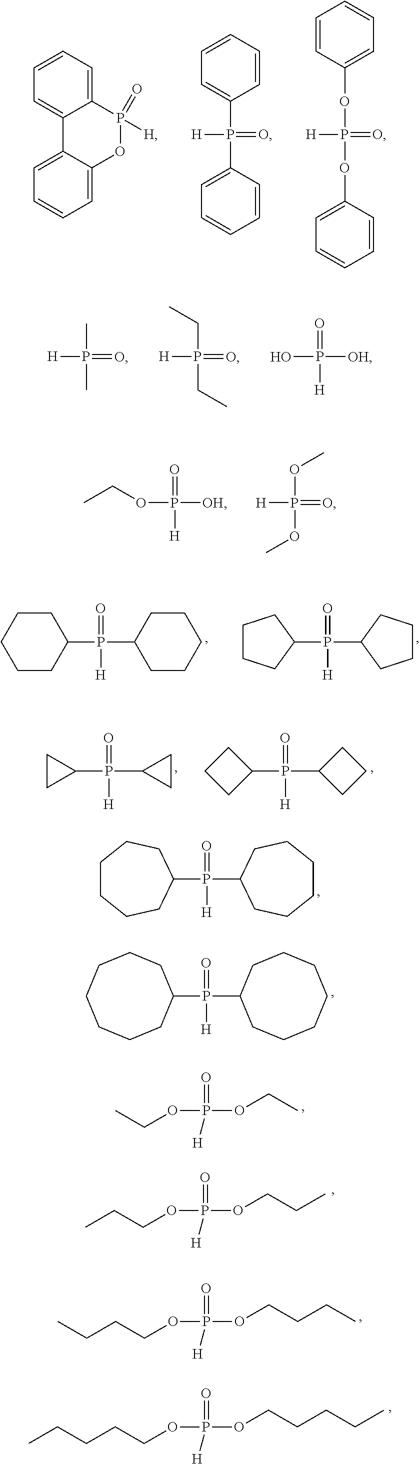 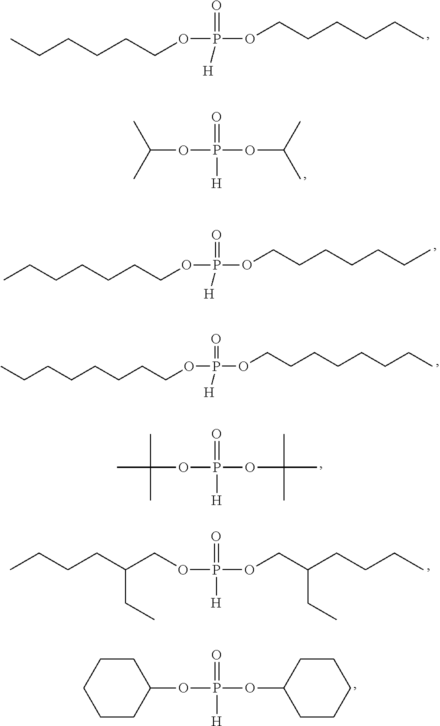 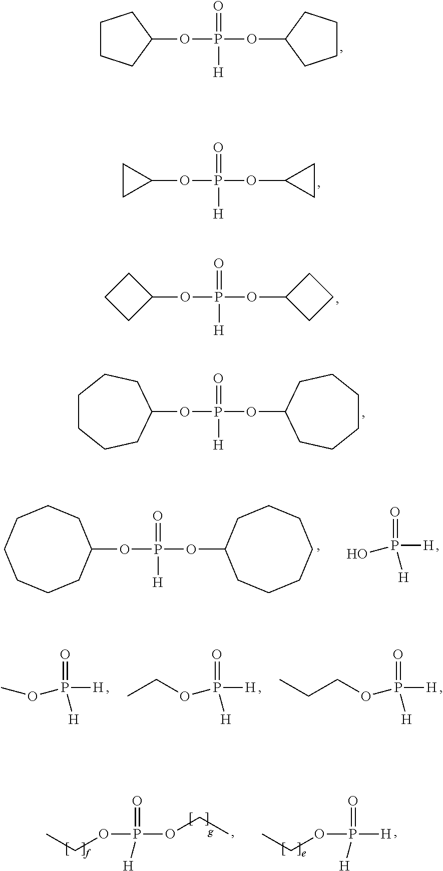
(wherein f, g and e are integer 0˜18);

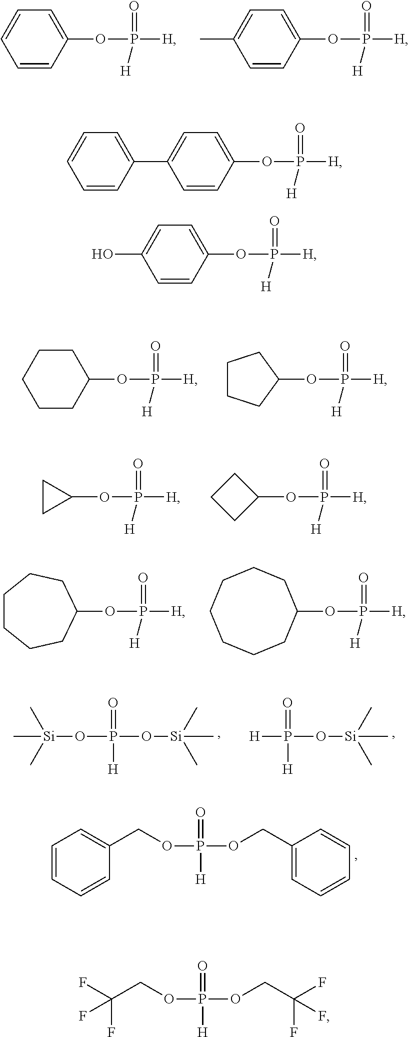

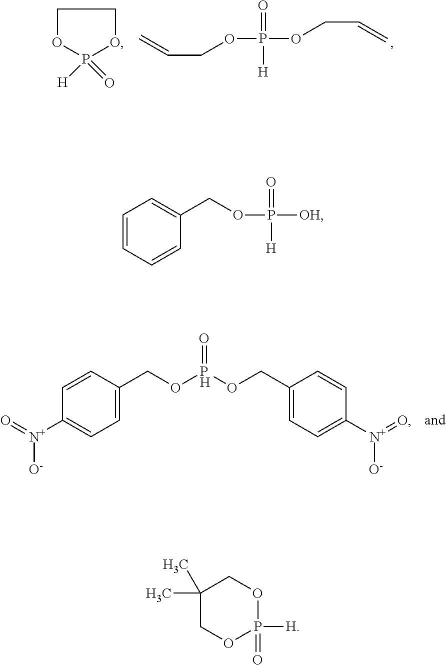

12. The method according to claim 1, wherein said second compound is represented by Formula (II-A): 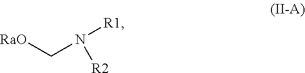
wherein R1 and R2 are independently of each other selected from H, C1-C24 alkyl, heteroalkyl, cycloalkyl, heterocycloalkyl, C6-C24 aryl, C3-C24 heteroaryl, fused cycloalkyl aryl, fused cycloalkane heteroaryl group, fused heterocyclyl aryl, fused heterocyclyl heteroaryl, and nitrogen, silicon, boron, oxygen, sulfur, and carbonyl or sulfonyl substituted C1-C24 alkyl groups; or wherein R1 and R2 are connected through a saturated/unsaturated alkyl group, or bridging a heteroaryl group, a fused cycloalkyl aryl group, a fused ring with the N atom, cycloalkylheteroaryl, fused heterocyclylaryl, or fused heterocyclylheteroaryl; and optionally wherein the heteroaryl group is a monocyclic or polycyclic aromatic group, and the N atom is connected to the aromatic ring; or wherein the group contains one, two or three heterocyclic atoms being selected from N, O and S, and the remaining ring atoms are C; optionally wherein one or more carbon atoms of the heteroaryl group is substituted by a carbonyl group; optionally wherein the heterocyclic group is a non-aromatic mono- or polycyclic group, wherein one or more ring atoms are selected from N, O, or S(O) x heteroatoms, where x is an integer from 0 to 2, and the remaining ring atoms are C; and optionally wherein the alkyl group includes linear, branched or aromatic ring-containing alkyl groups.

13. The method according to claim 1, wherein said second compound is selected from: 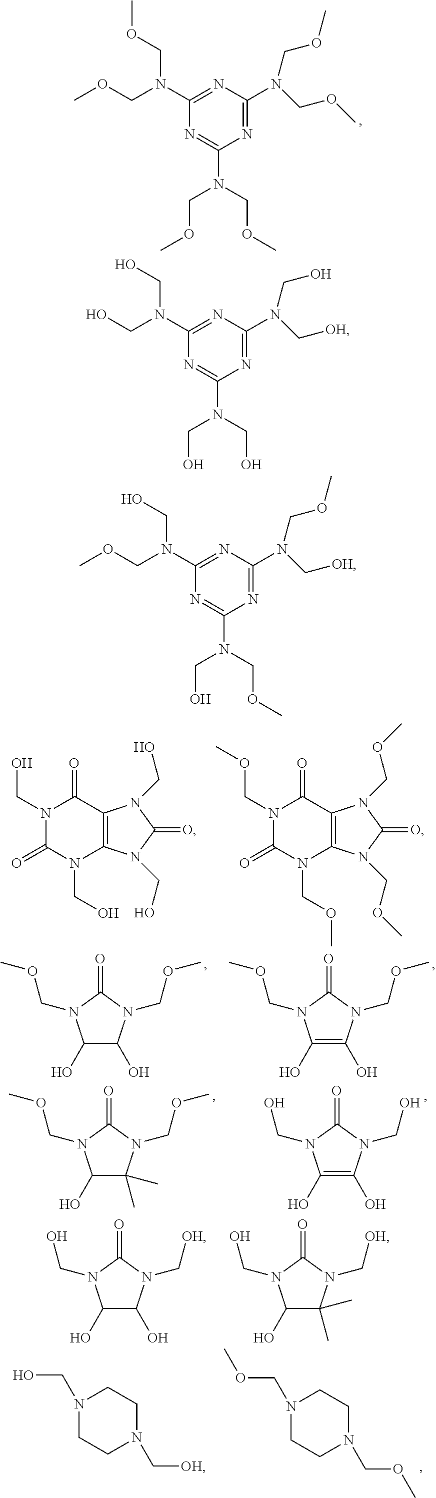 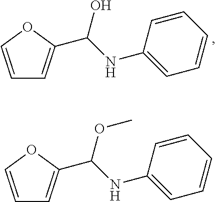 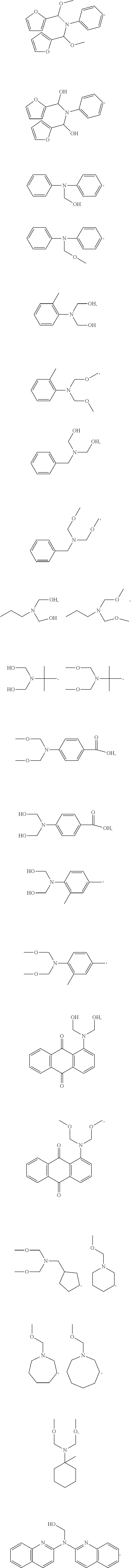 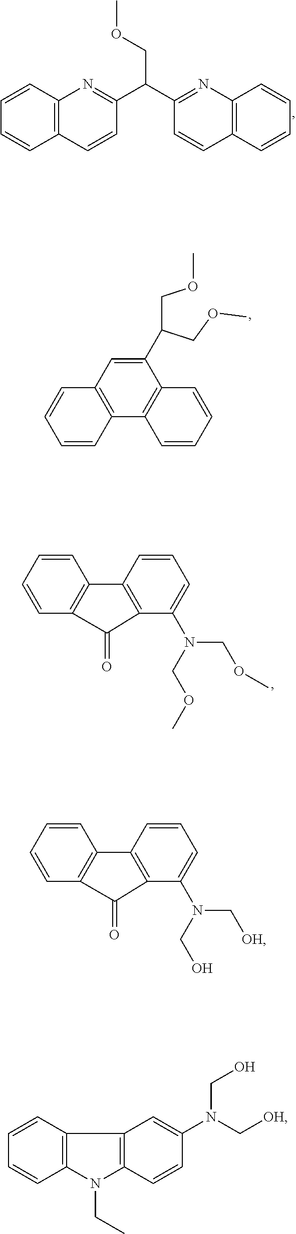 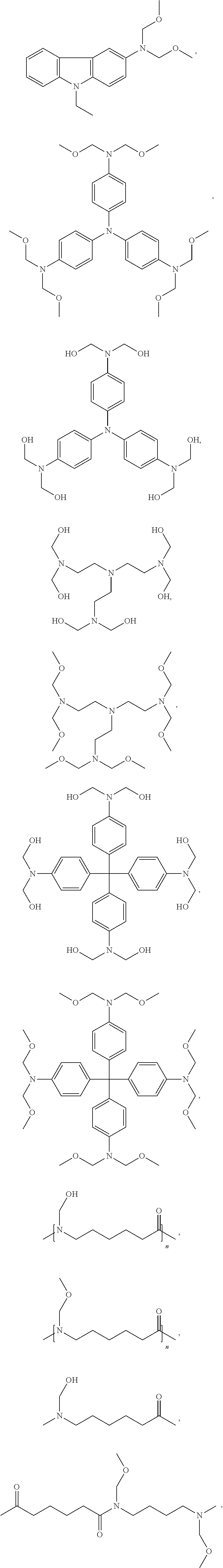 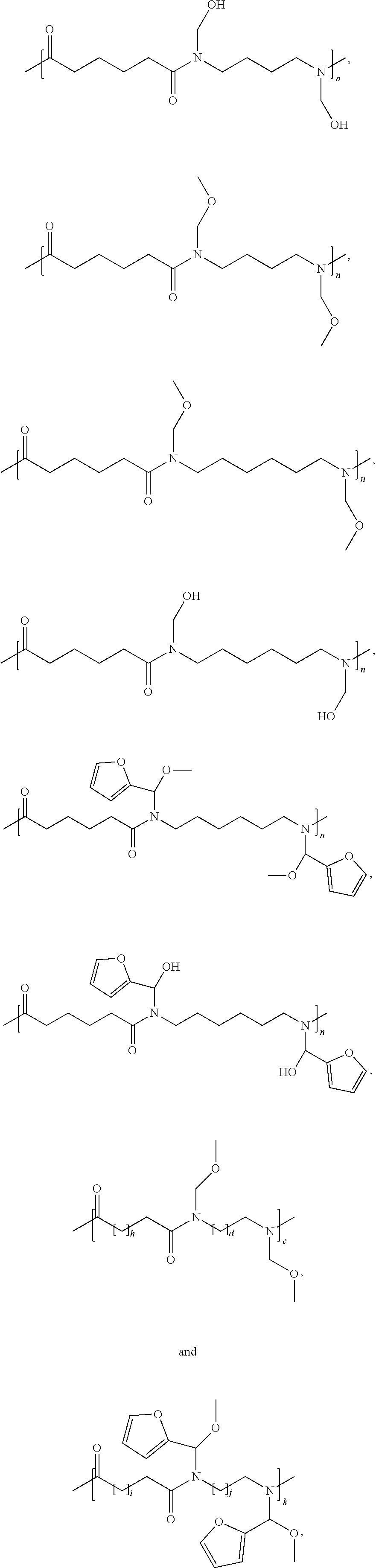
wherein n, c and k are integers of 1 or greater than 1; and h, d, i and j are integers in the range of from 1 to 20.

14. The method according to claim 1, wherein said phosphorus nitrogen flame retardant is represented by Formula (III-X) or Formula (III-Y): 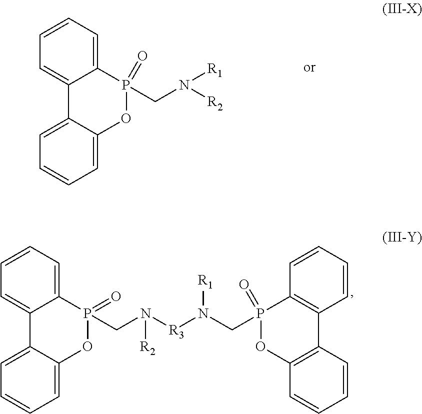
wherein R1 and R2 are independently of each other selected from H, C1-C24 alkyl, heteroalkyl, cycloalkyl, heterocycloalkyl, C6-C24 aryl, C3-C24 heteroaryl, fused cycloalkyl aryl, fused cycloalkane heteroaryl group, fused heterocyclyl aryl, fused heterocyclyl heteroaryl, and nitrogen, silicon, boron, oxygen, sulfur, and carbonyl or sulfonyl substituted C1-C24 alkyl groups; or wherein R1 and R2 are connected through a saturated/unsaturated alkyl group, or bridging a heteroaryl group, a fused cycloalkyl aryl group, a fused ring with the N atom, cycloalkylheteroaryl, fused heterocyclylaryl, or fused heterocyclylheteroaryl; optionally wherein the heteroaryl group is a monocyclic or polycyclic aromatic group, and the N atom is connected to the aromatic ring; optionally wherein the group contains one, two or three heterocyclic atoms being selected from N, O and S, and the remaining ring atoms are C; optionally wherein one or more carbon atoms of the heteroaryl group is substituted by a carbonyl group; optionally wherein the heterocyclic group is a non-aromatic mono- or polycyclic group, wherein one or more ring atoms are selected from N, O, or S(O) x heteroatoms, where x is an integer from 0 to 2, and the remaining ring atoms are C; optionally wherein the alkyl group includes linear, branched or aromatic ring-containing alkyl groups; and
wherein R3 is selected from C1-C24 alkyl, heteroalkyl, cycloalkyl, heterocycloalkyl, C6-C24 aryl, C3-C24 heteroaryl, fused cycloalkyl aryl, fused cycloalkane heteroaryl group, fused heterocyclyl aryl, fused heterocyclyl heteroaryl, and silicon, oxygen, boron, nitrogen, sulfur, and carbonyl or sulfonyl substituted C1-C24 alkyl groups; and unsaturated alkyl.

15. The method according to claim 1, wherein said phosphorus nitrogen flame retardant is selected from: 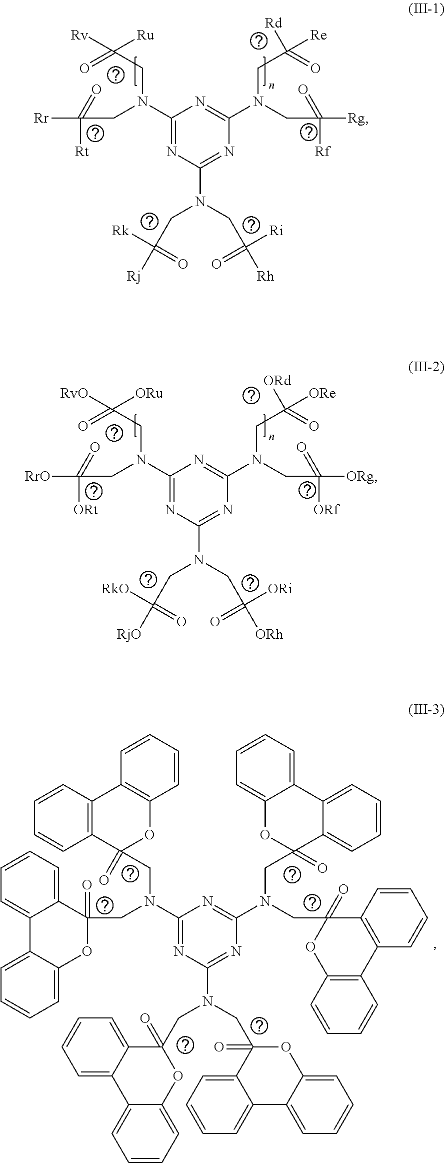 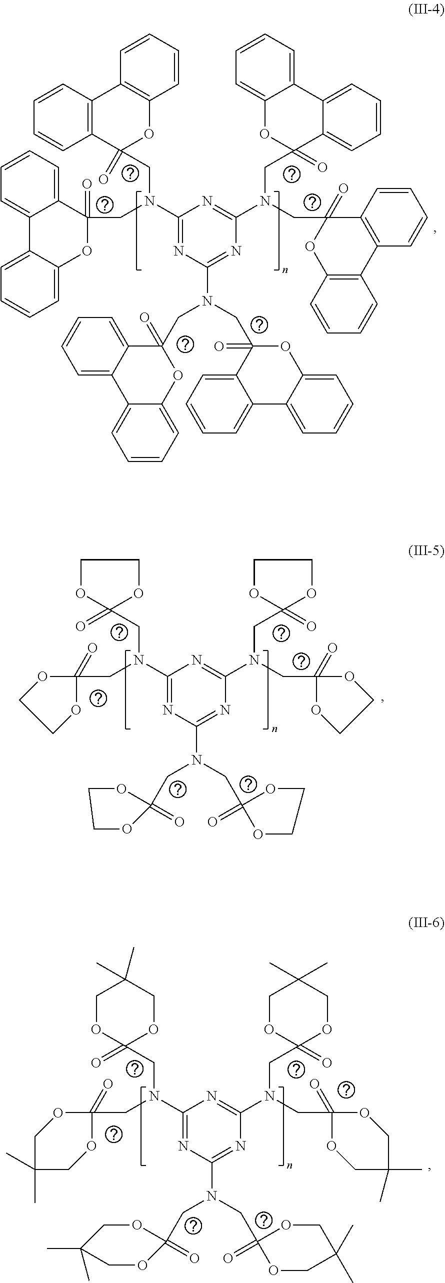 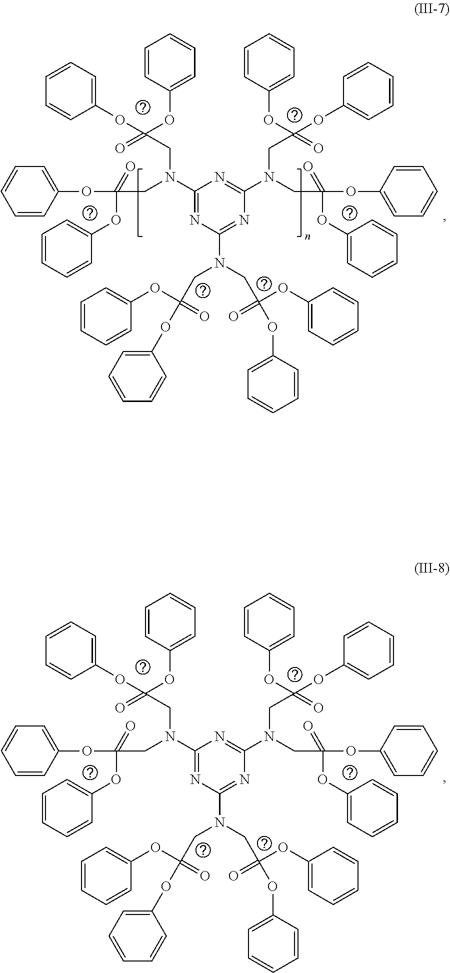 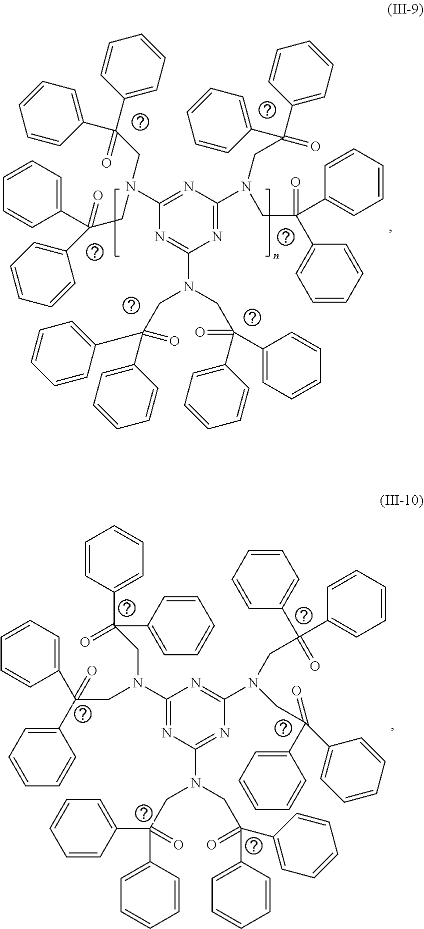 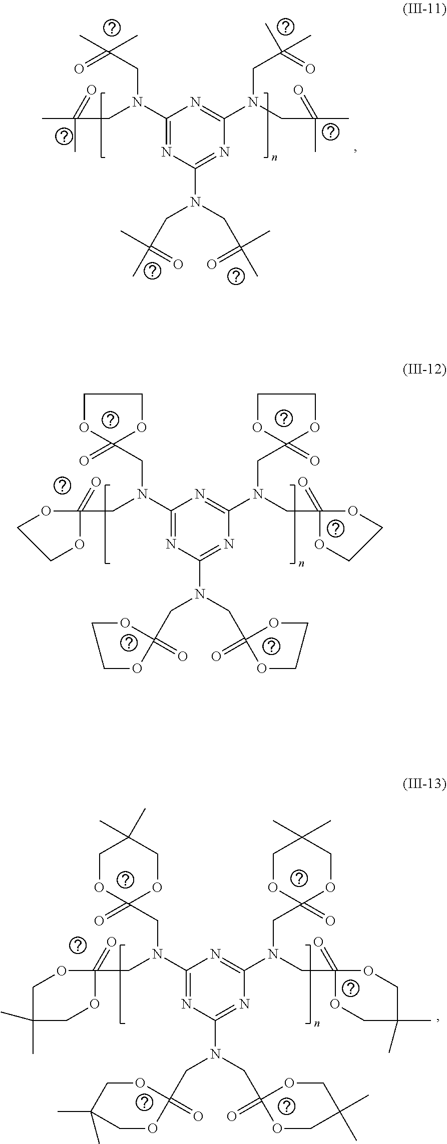 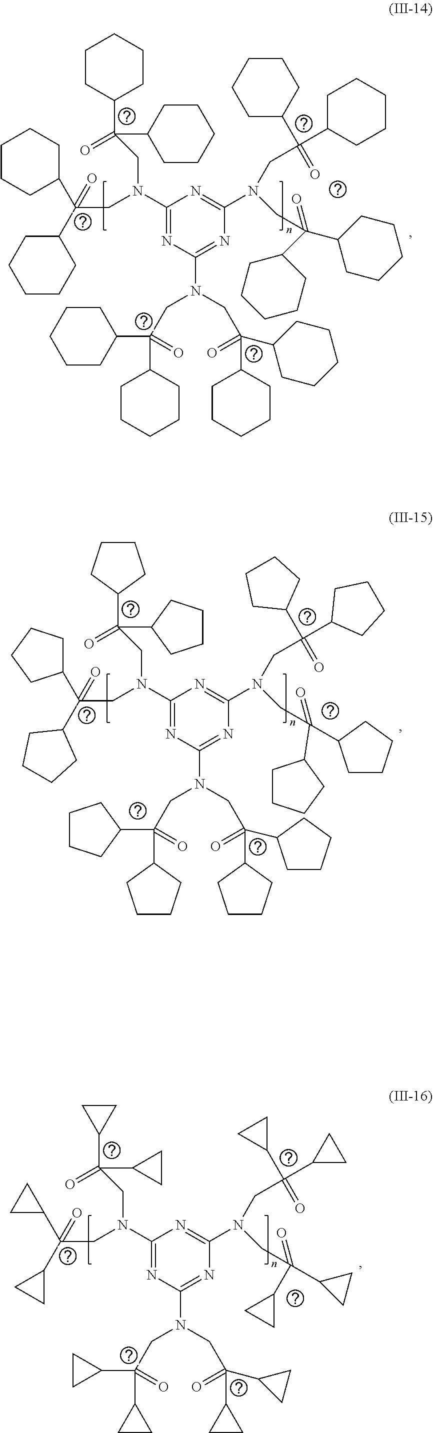 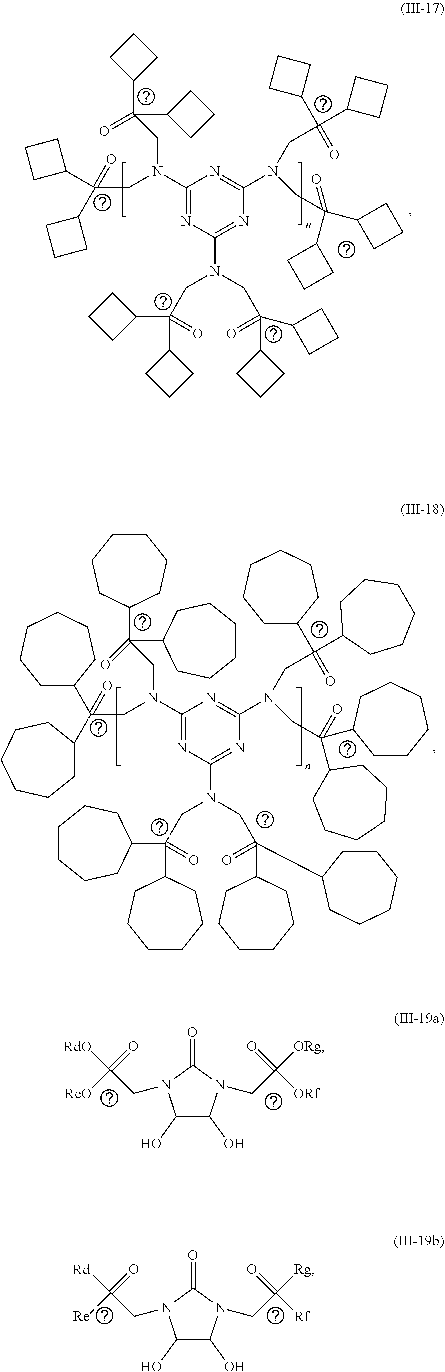 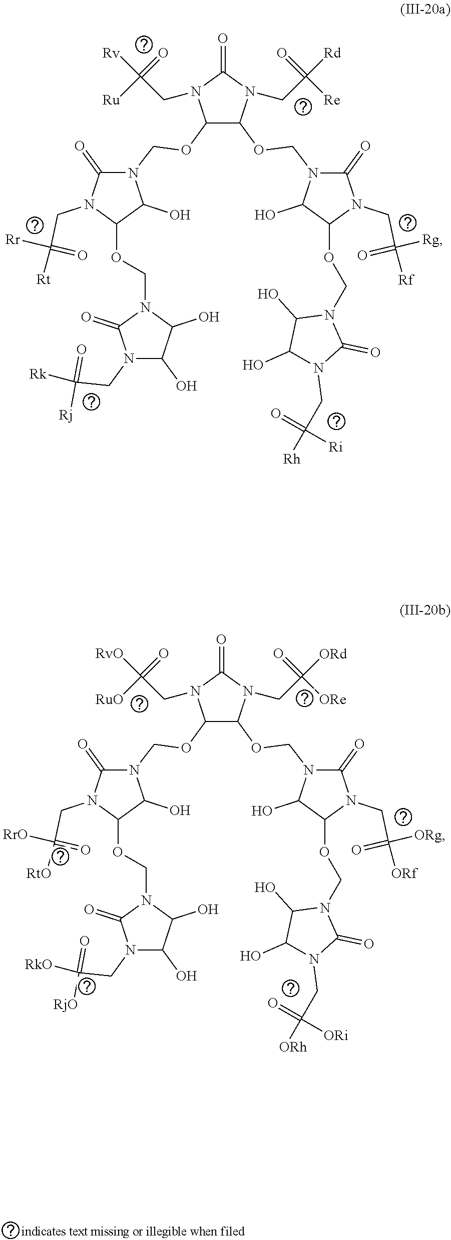 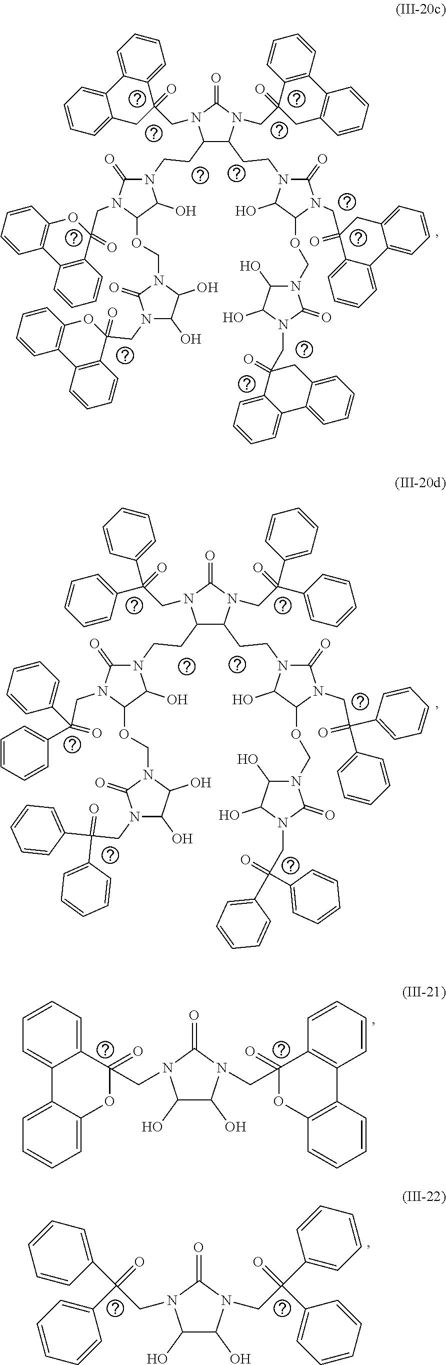 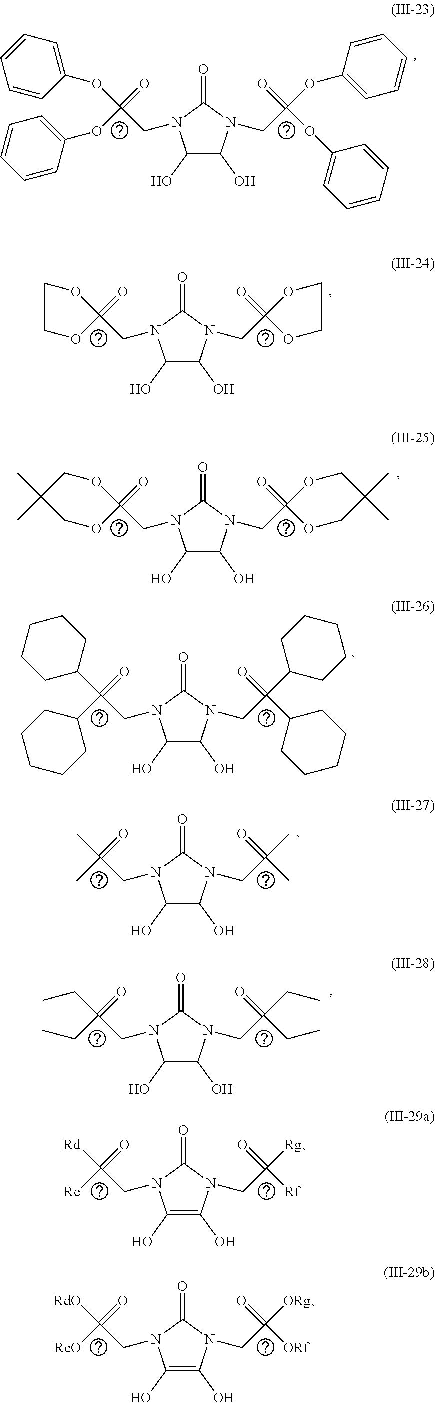 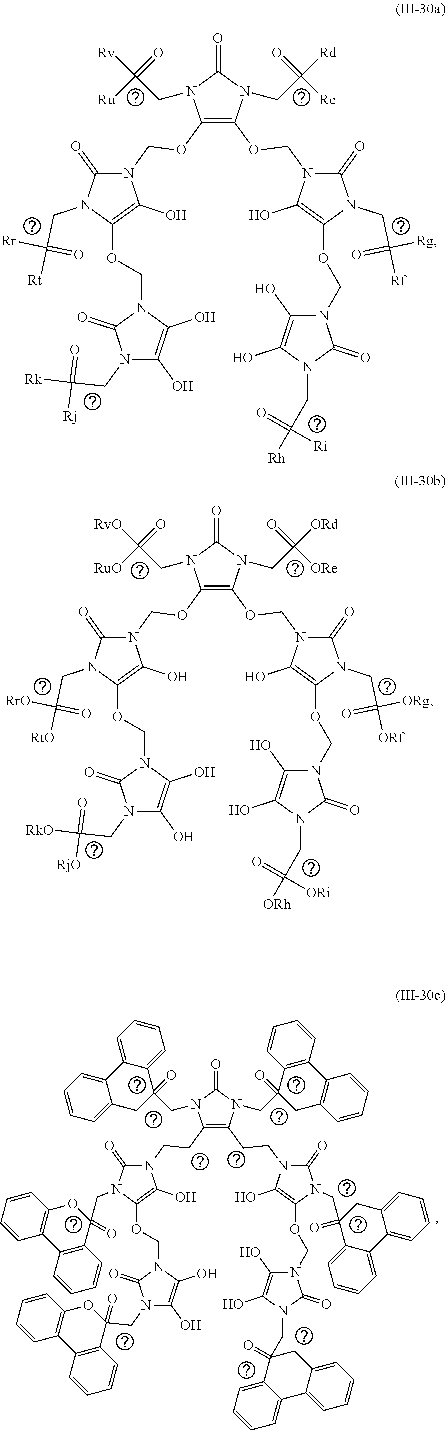 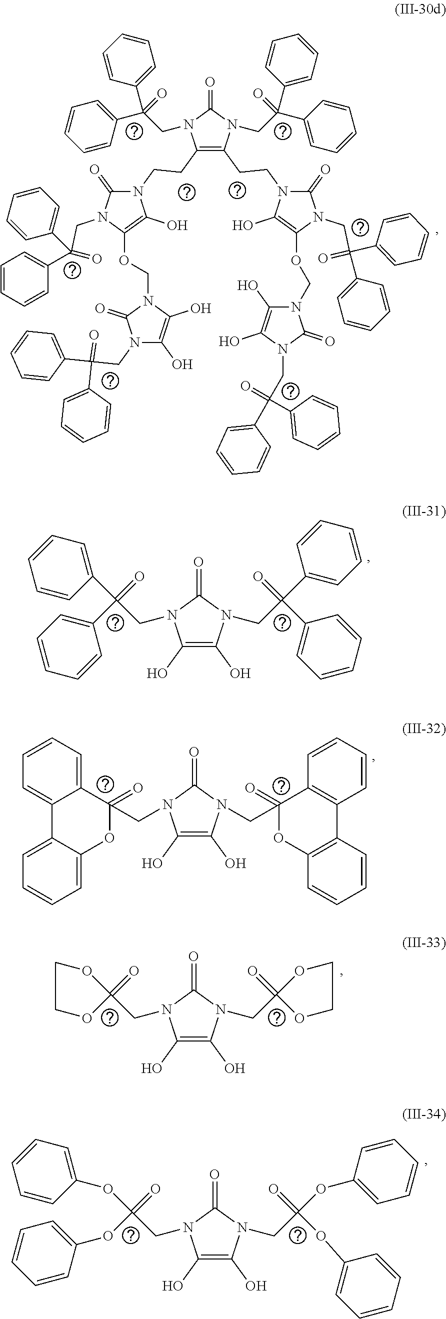 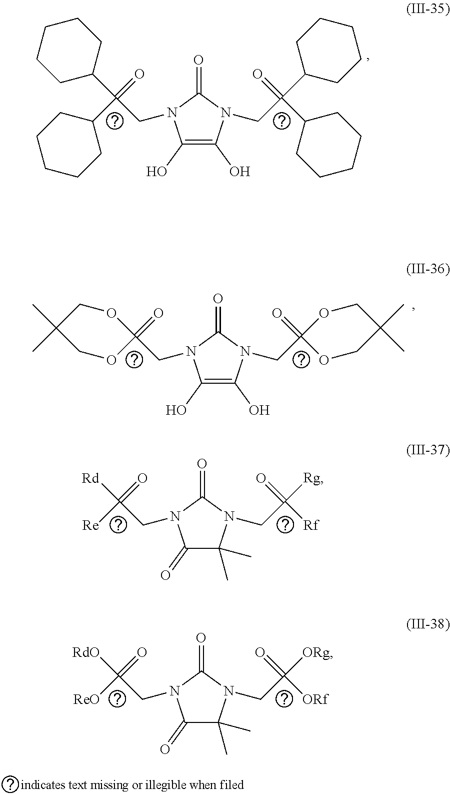 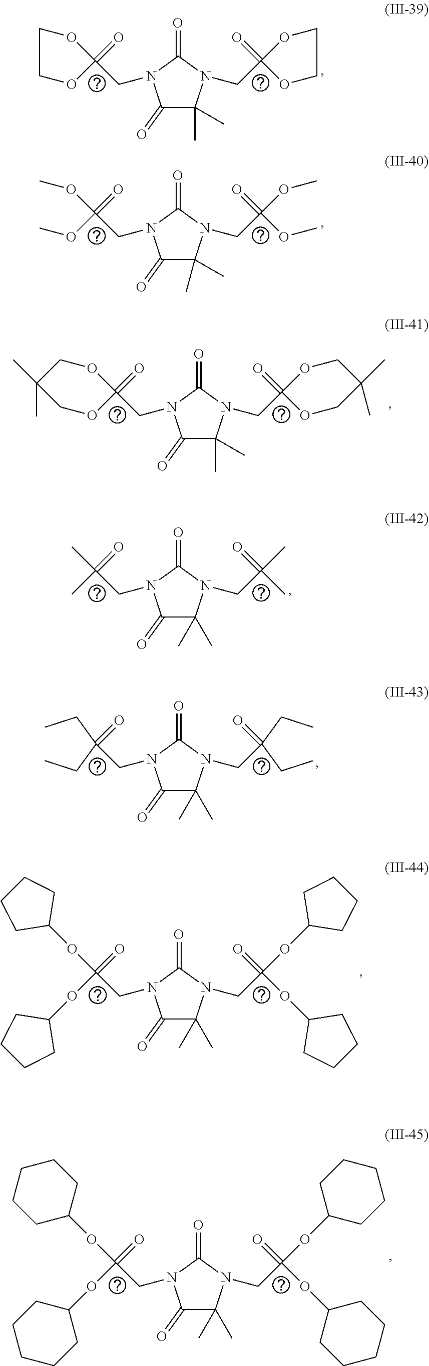 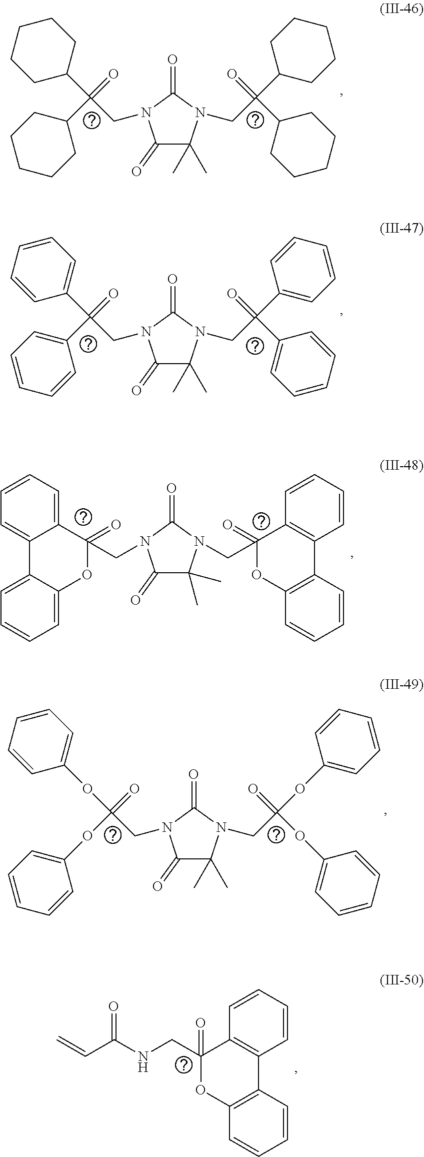 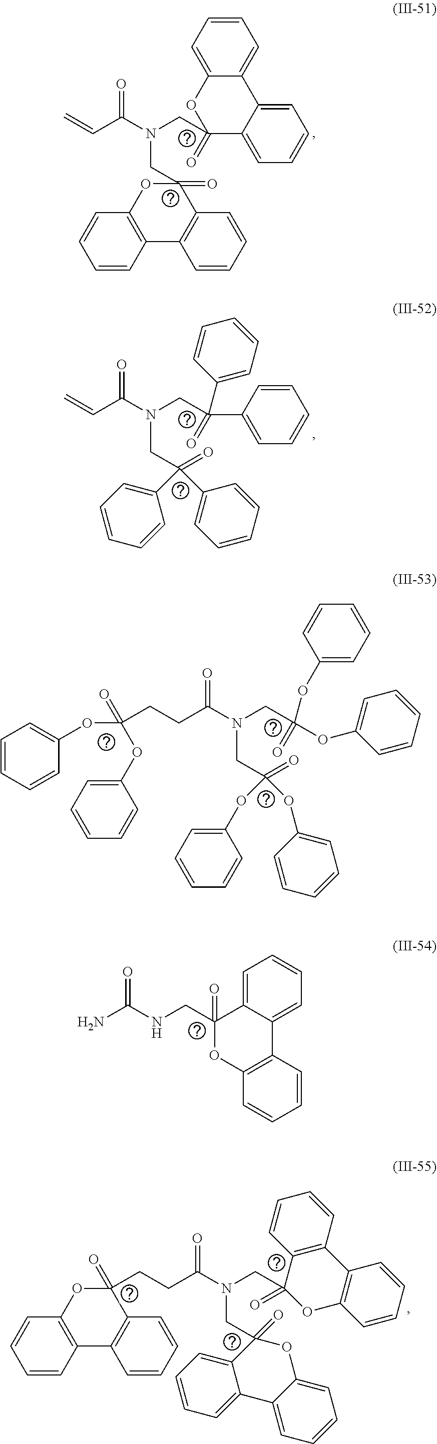 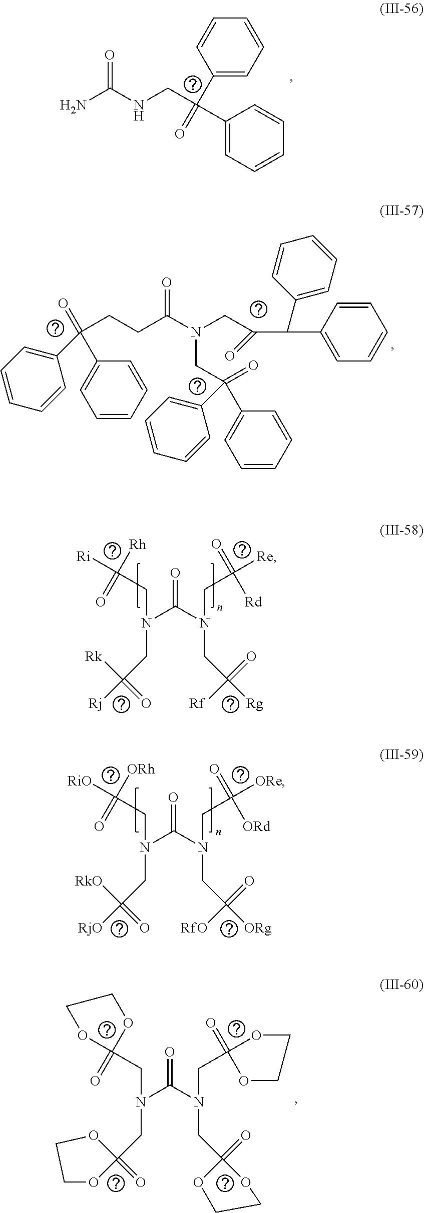 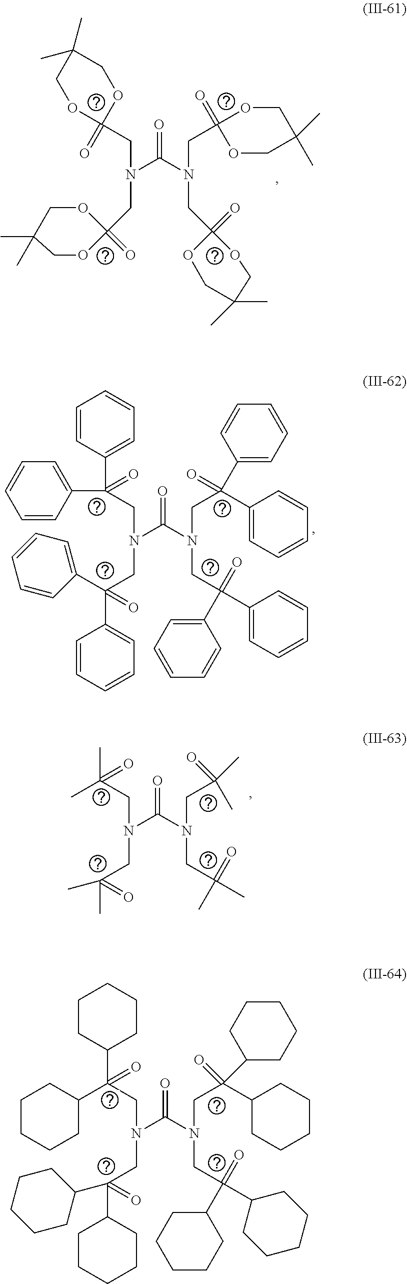 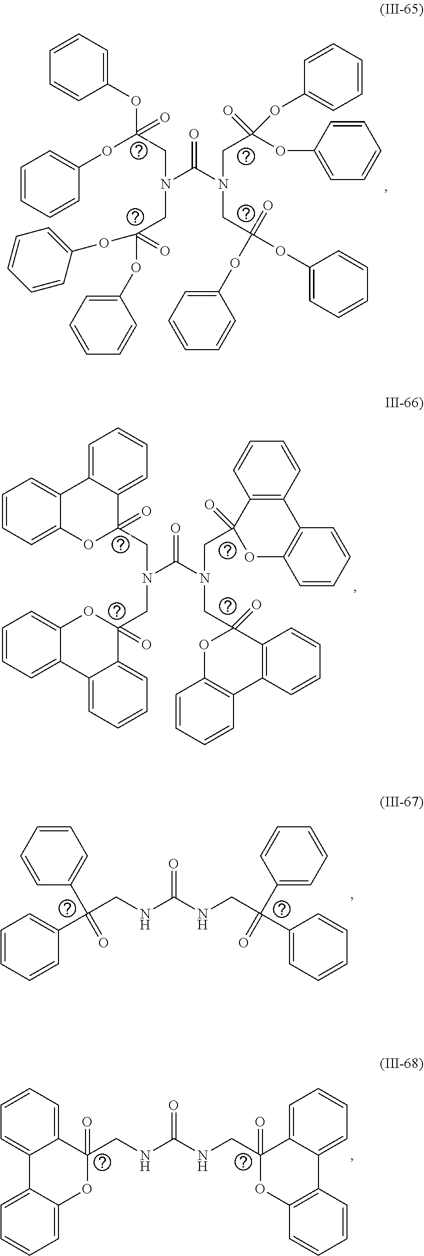 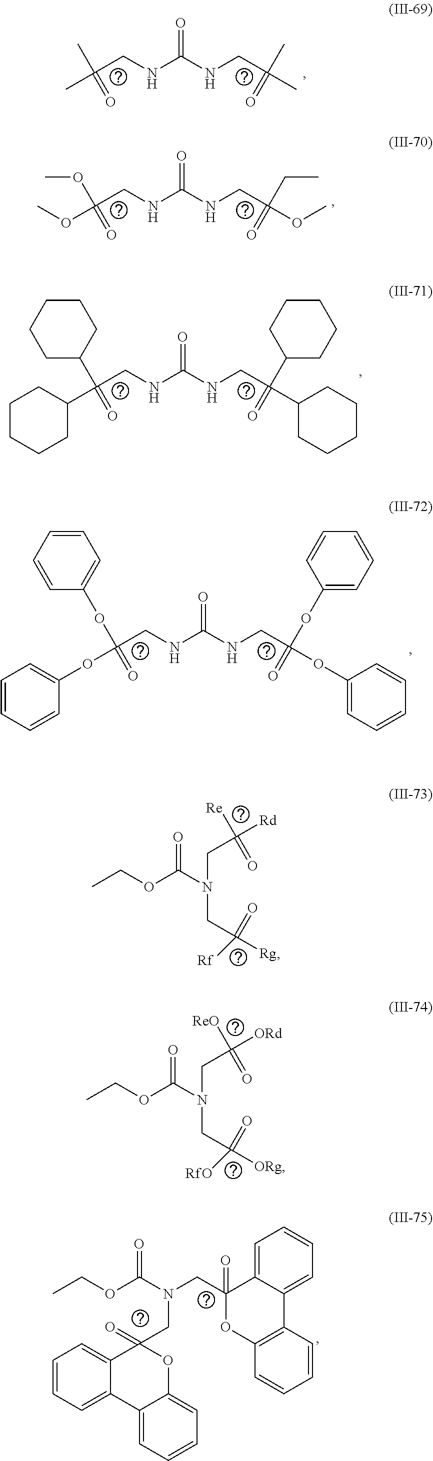 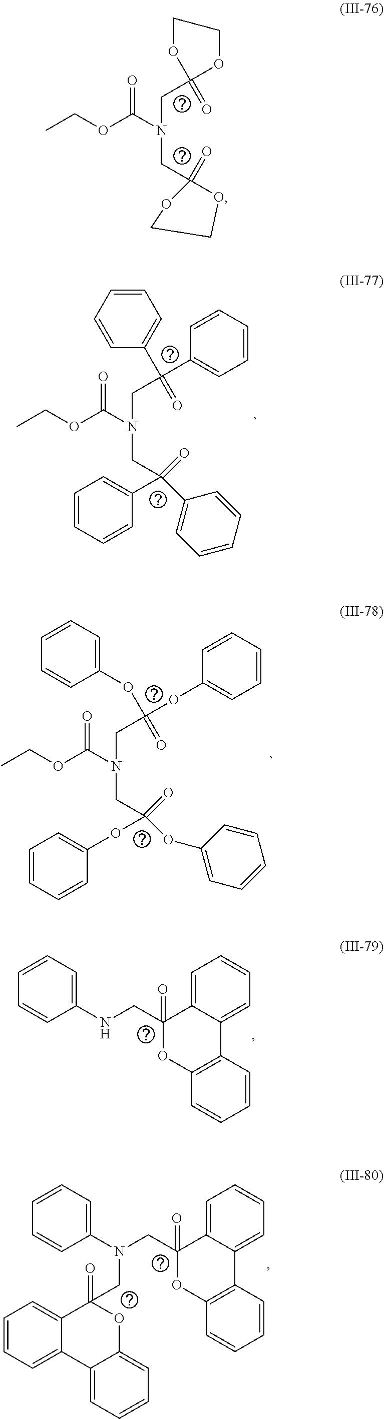 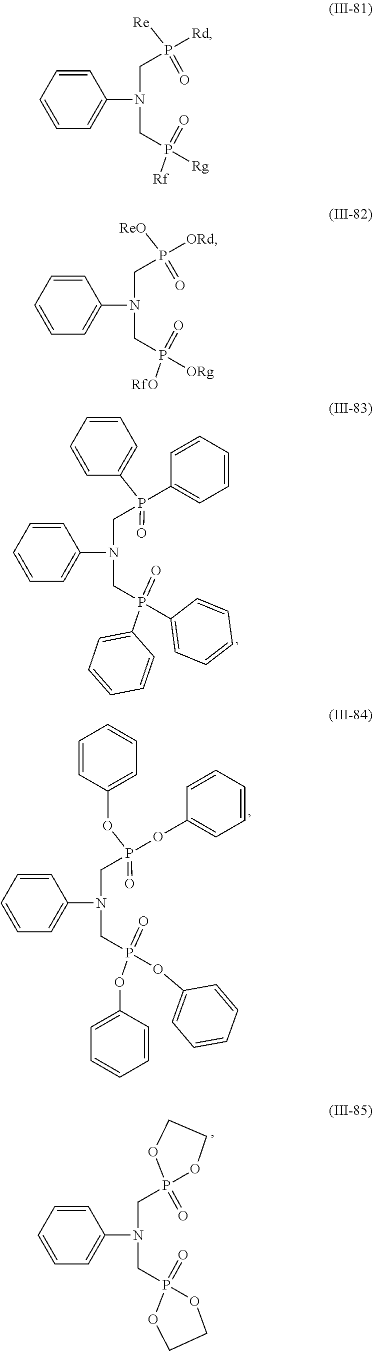 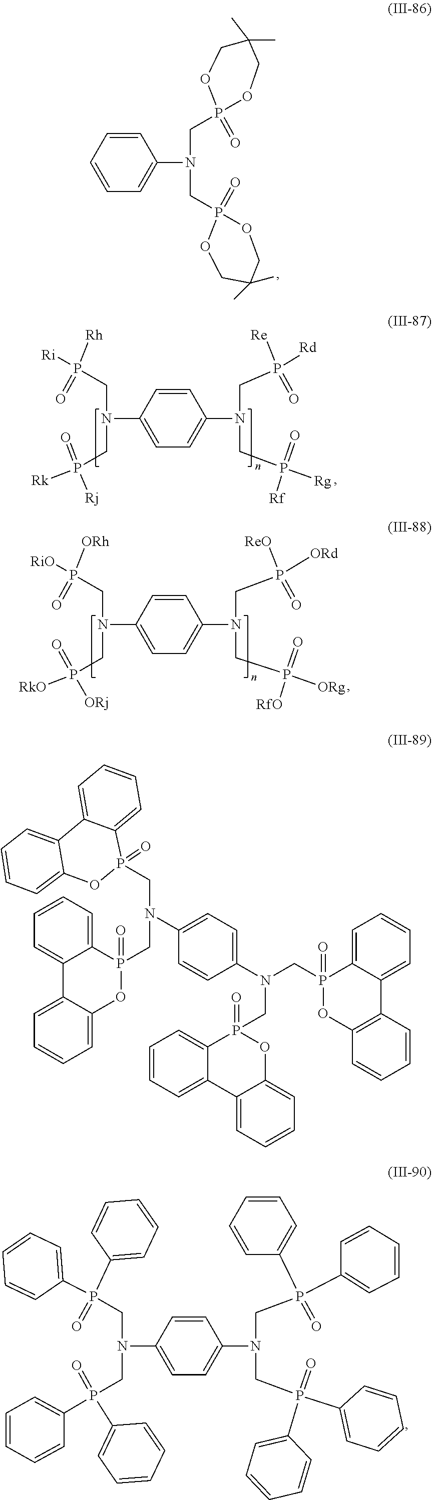 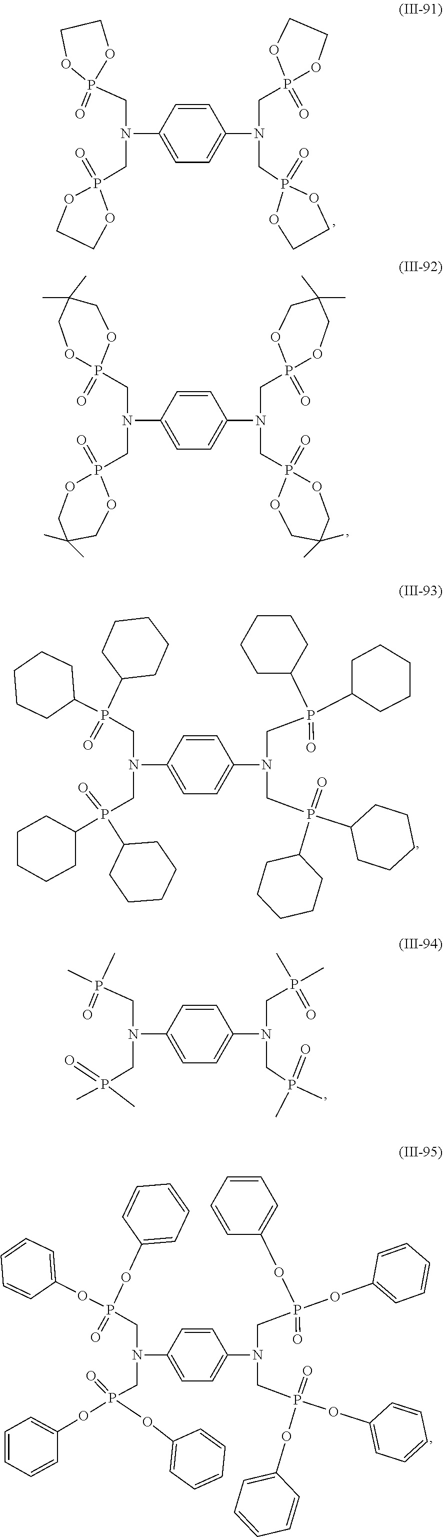 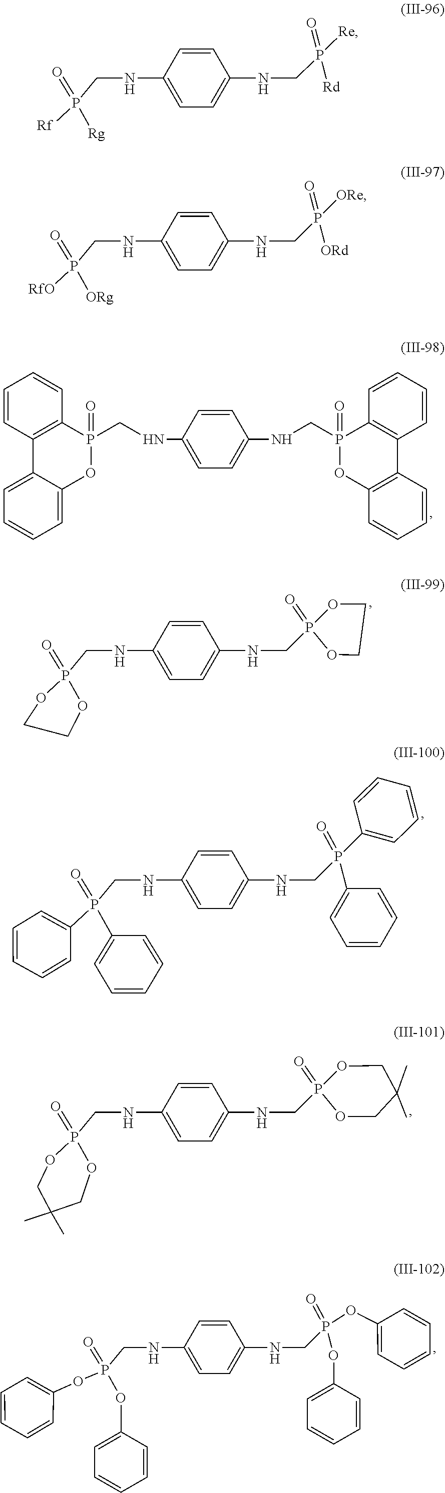 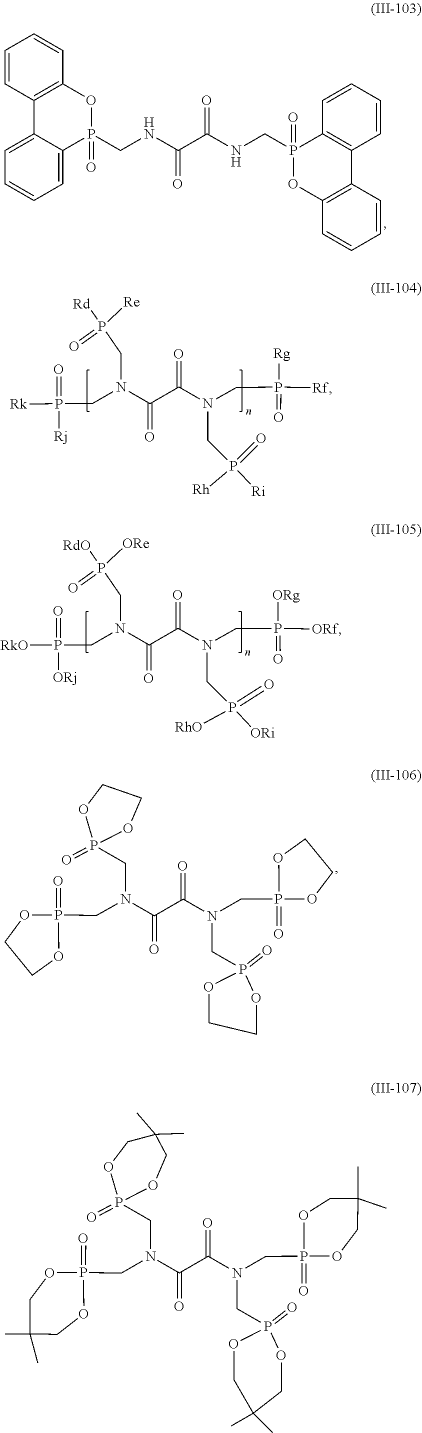 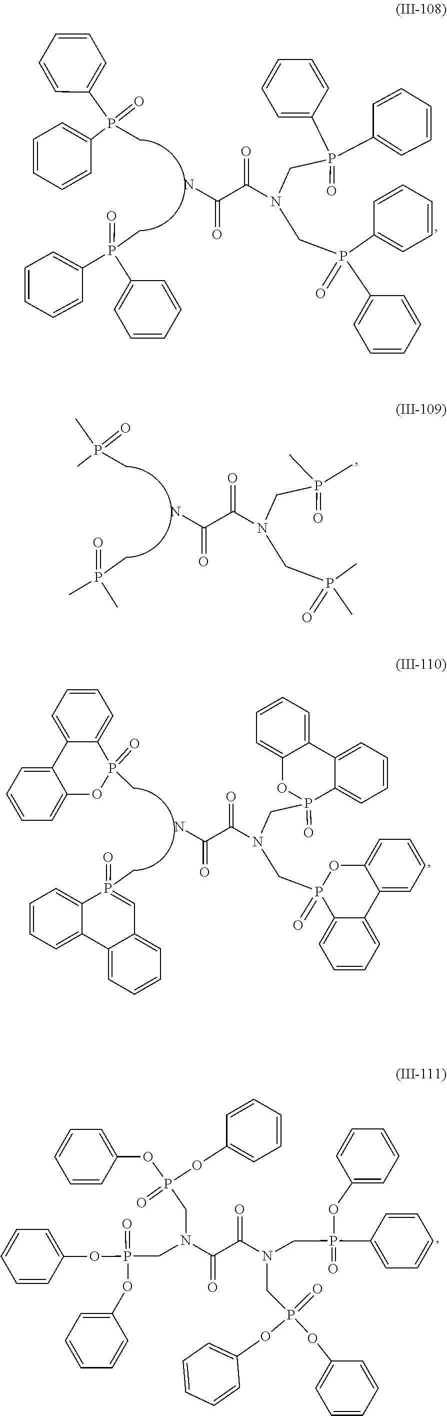 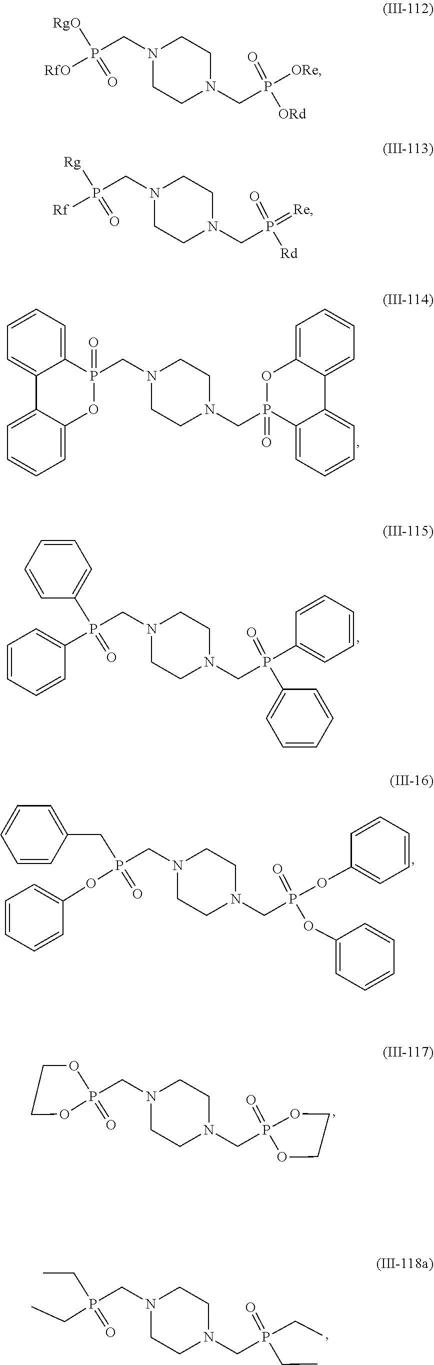 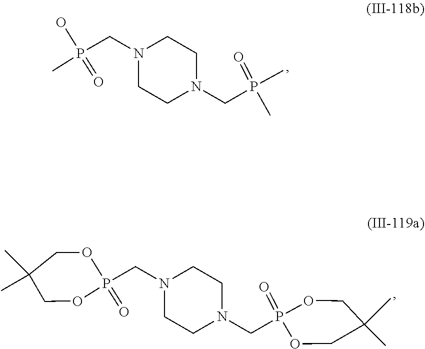 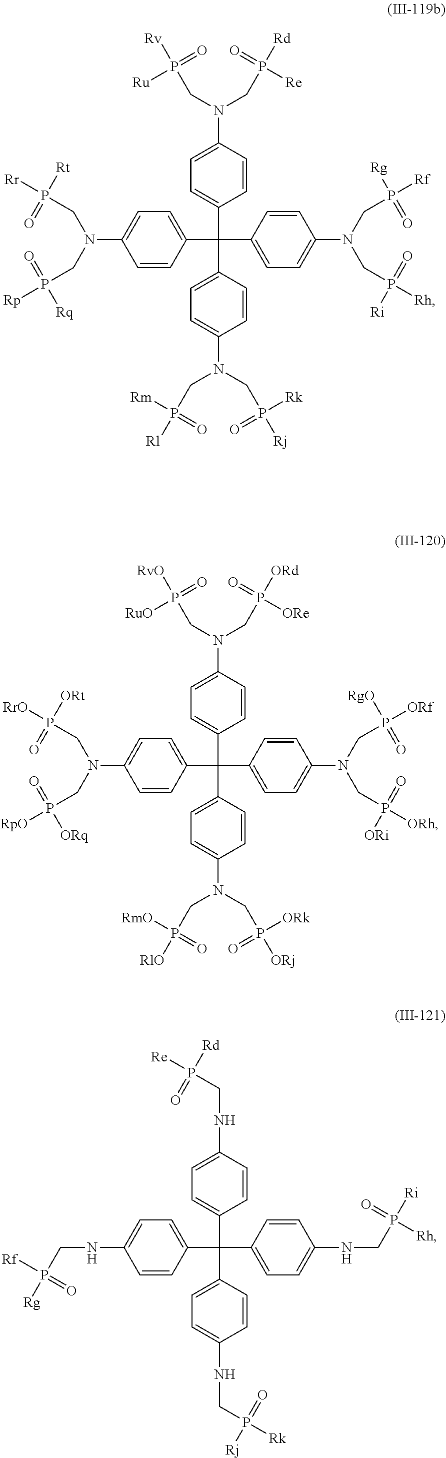 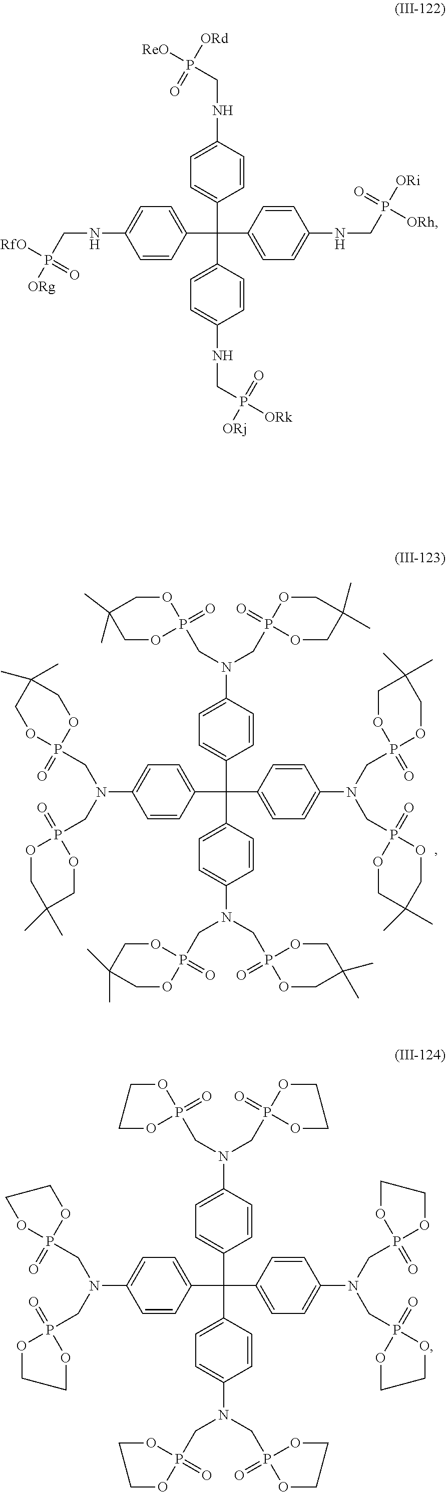 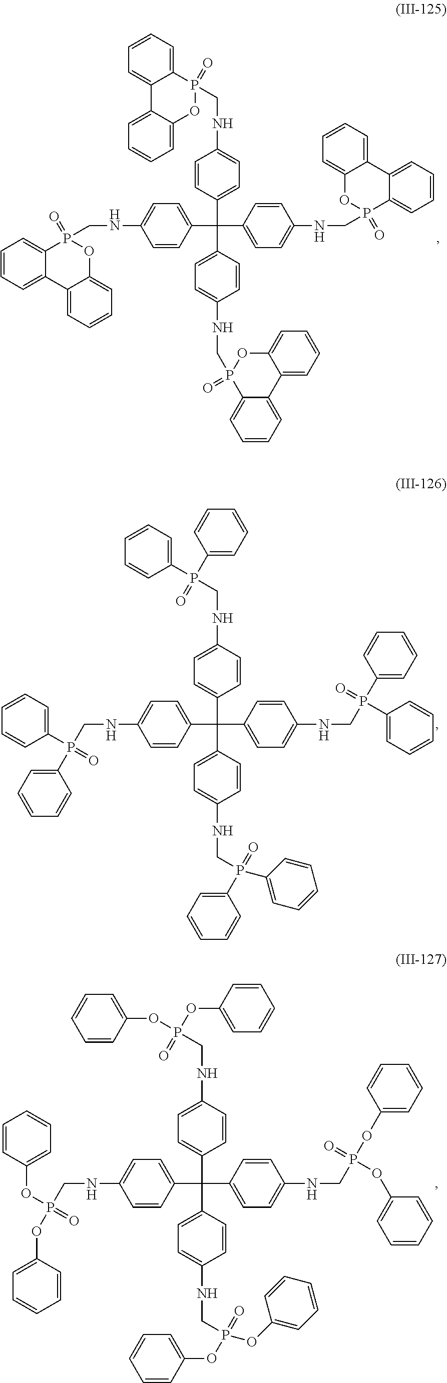 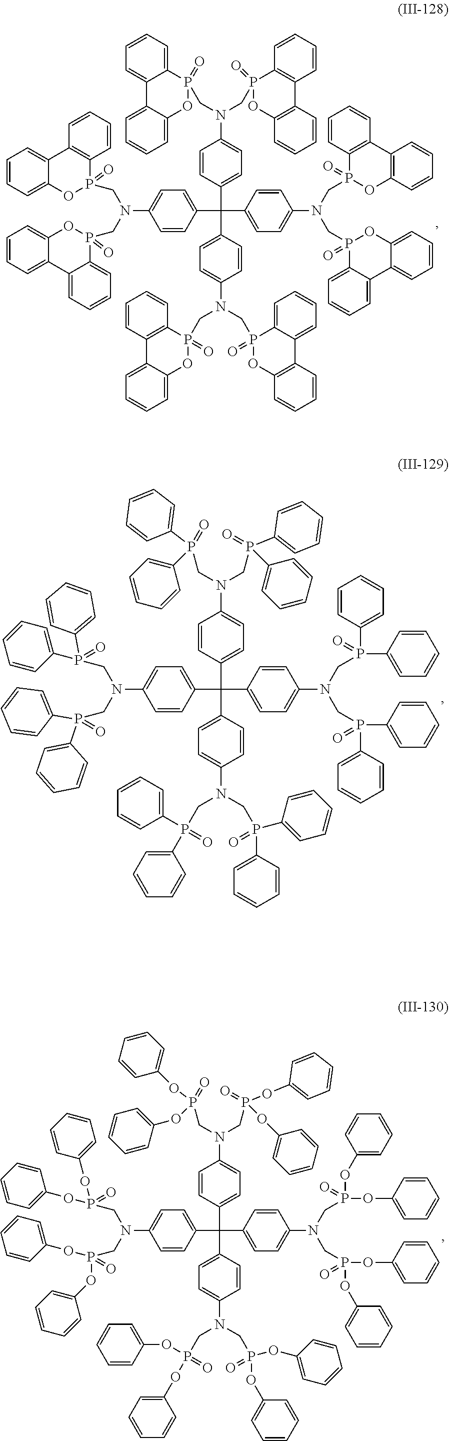 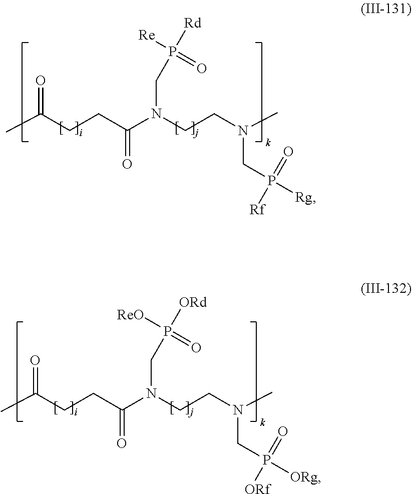
wherein i and j are integers equal to 0 or greater than 0; and k is an integer, k≥1; 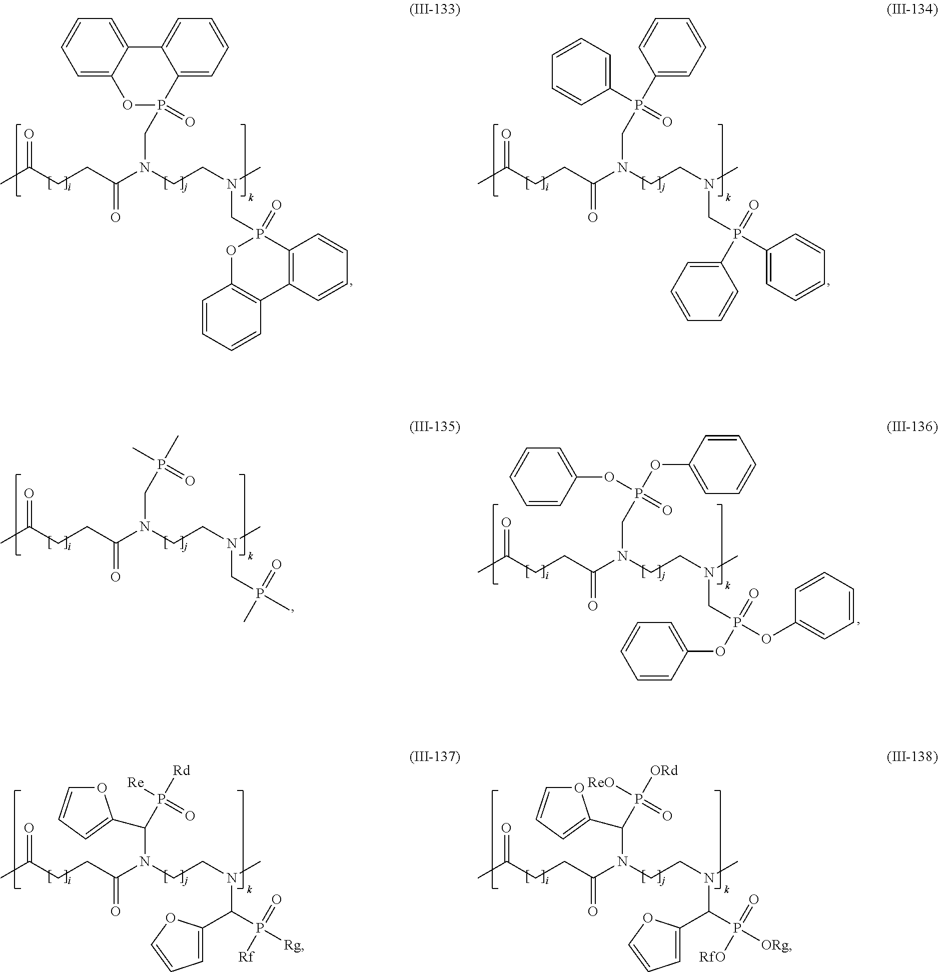 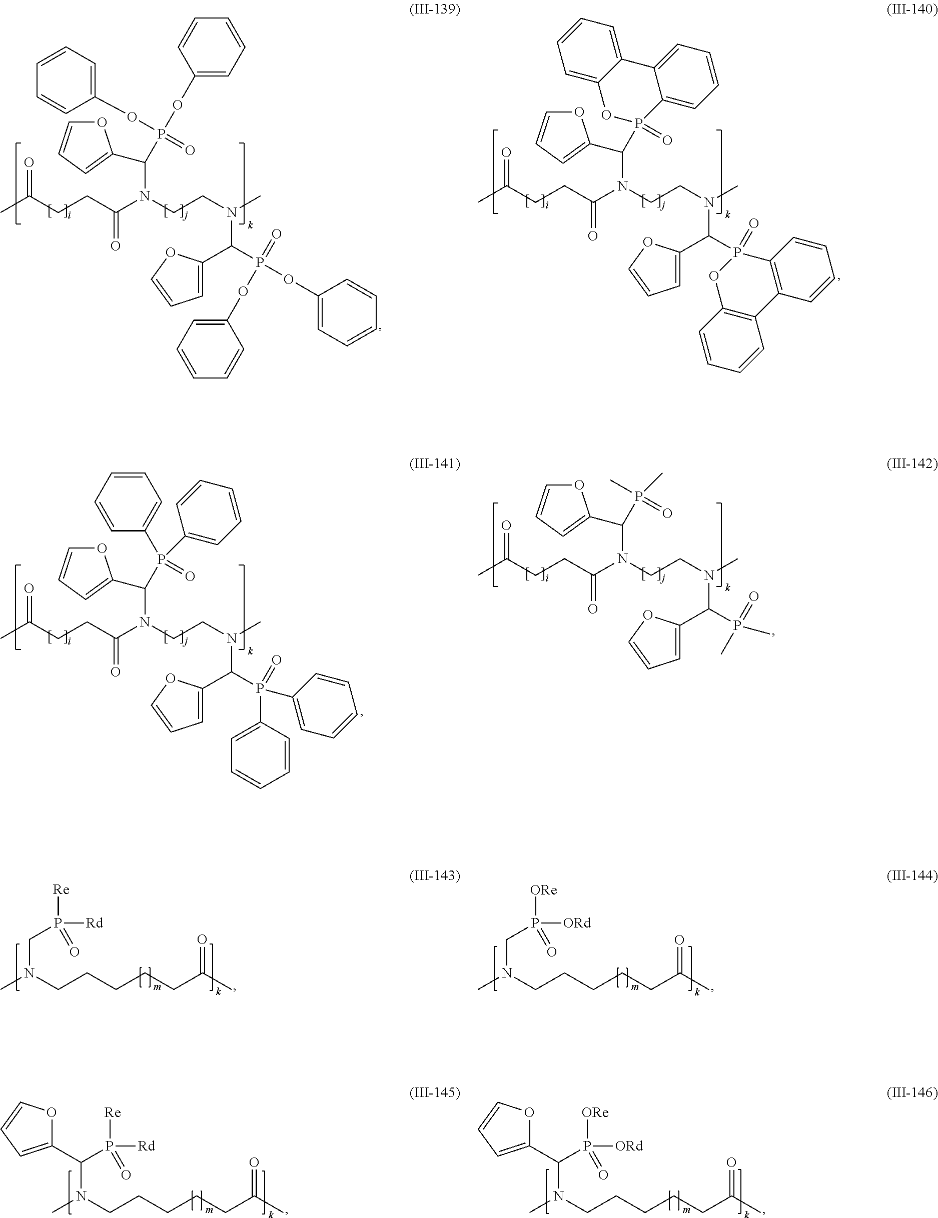 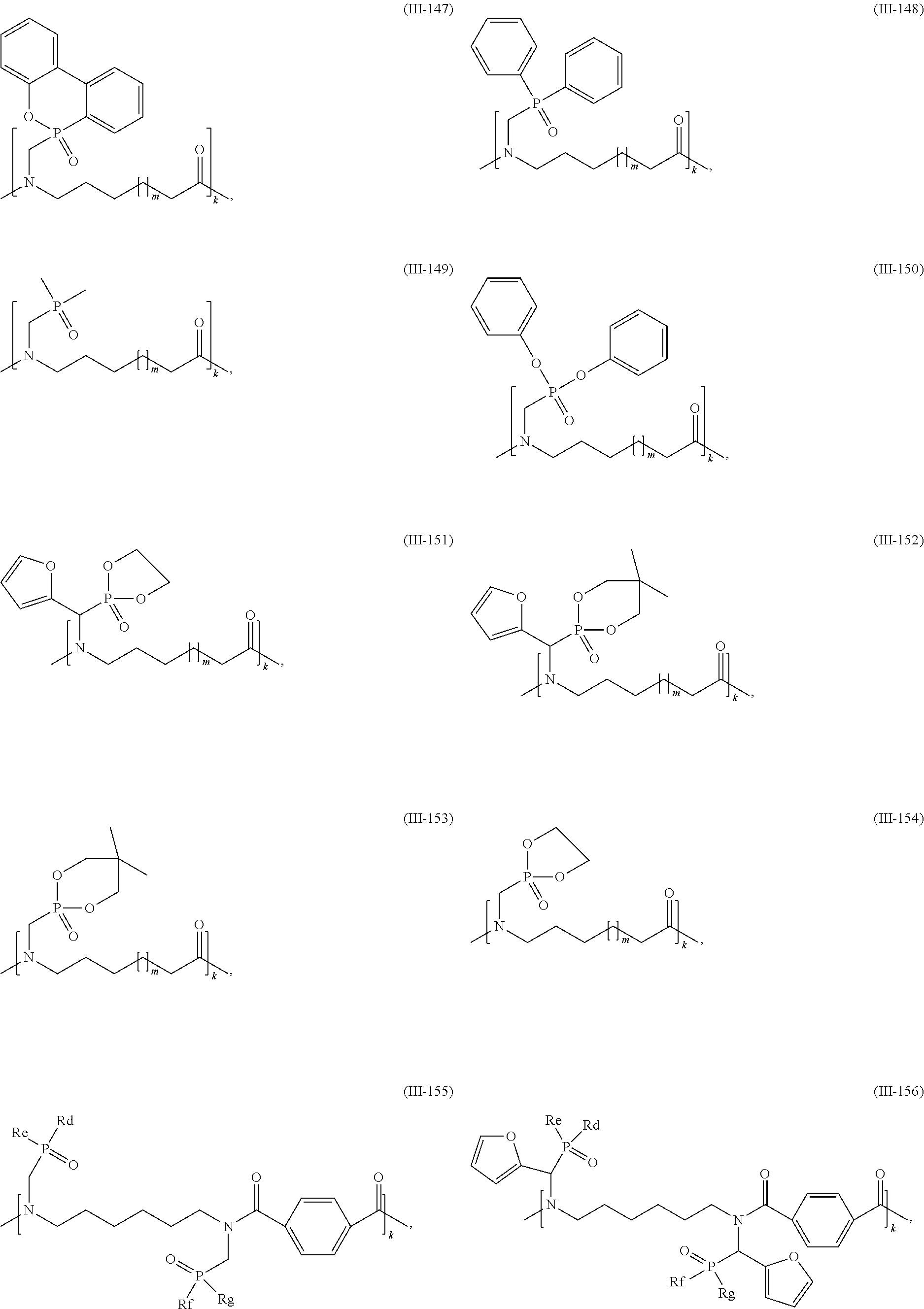 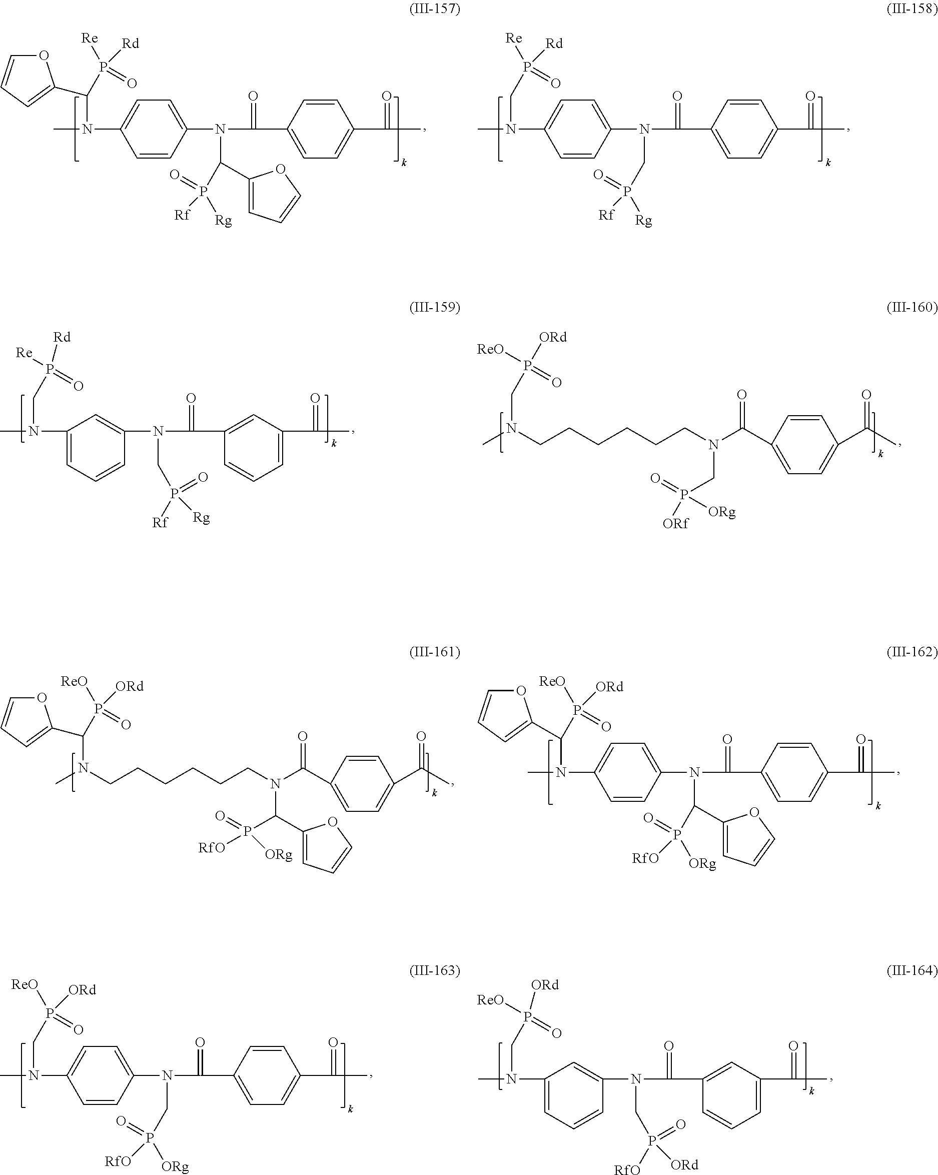 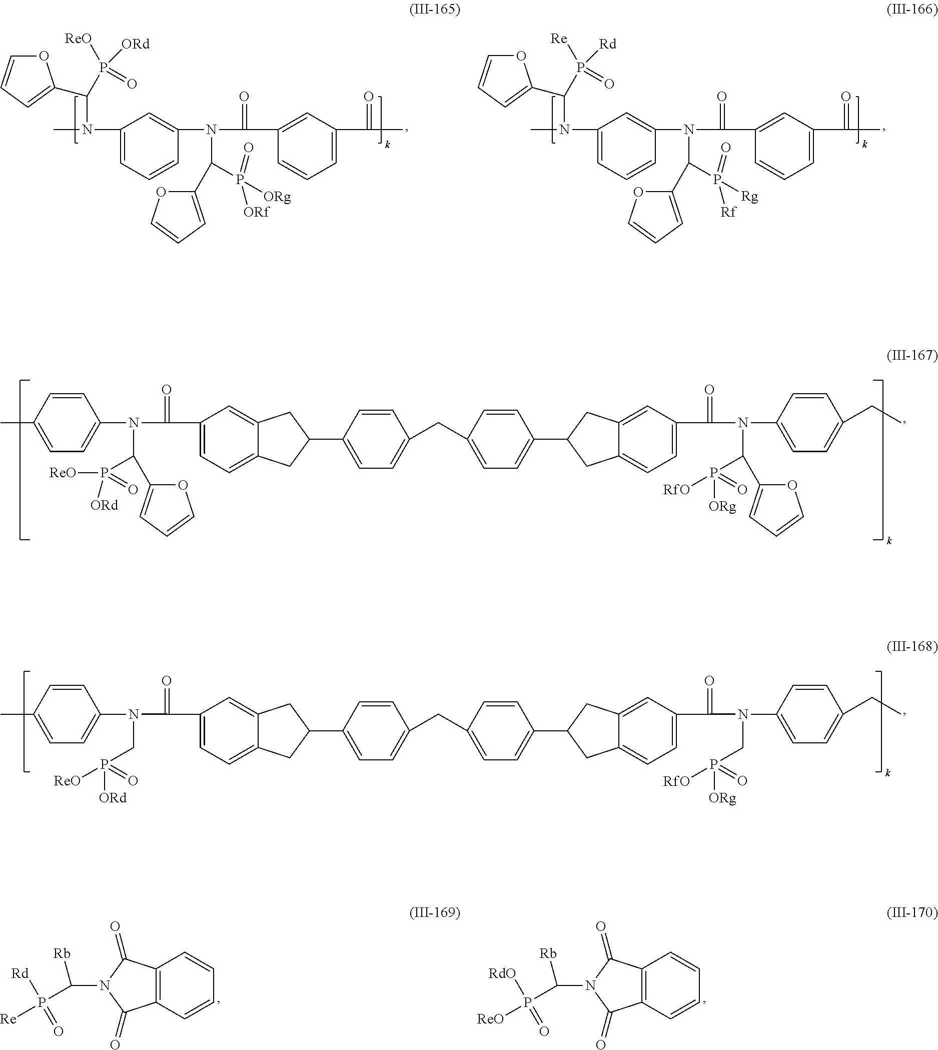
wherein i, j, and m are integers ≥0; k is an integer, ≥1; 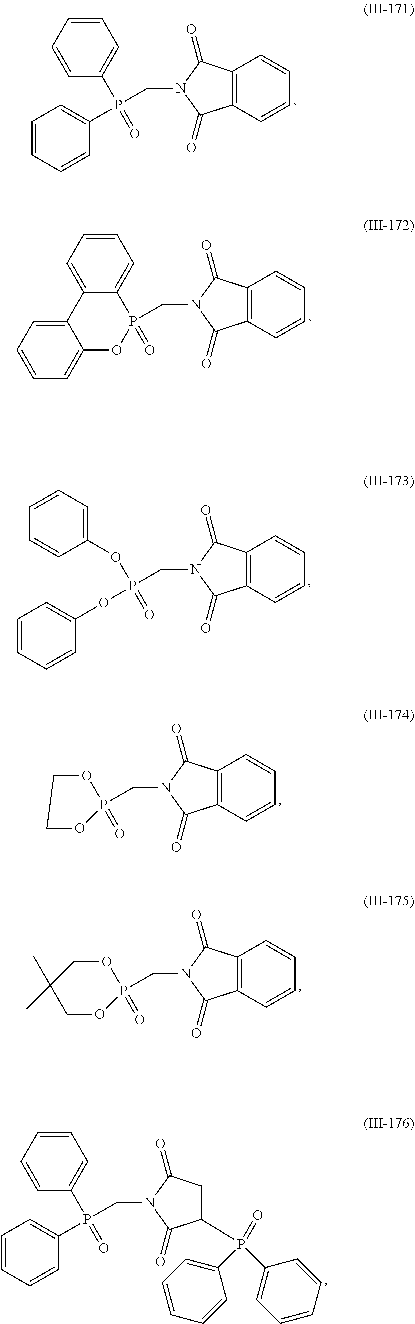 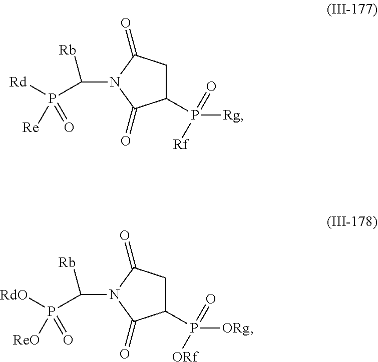
wherein Rb is selected from hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical; 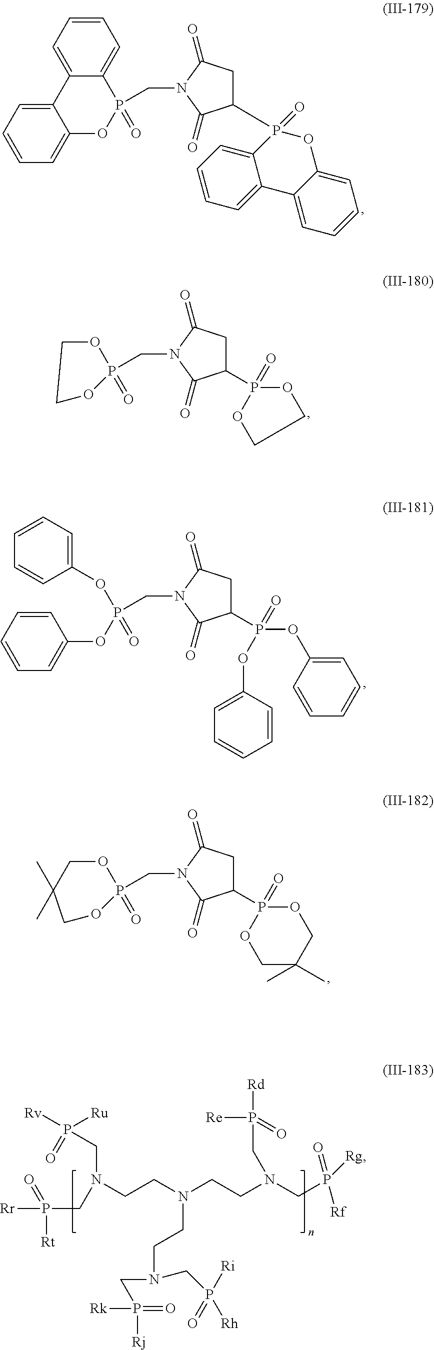 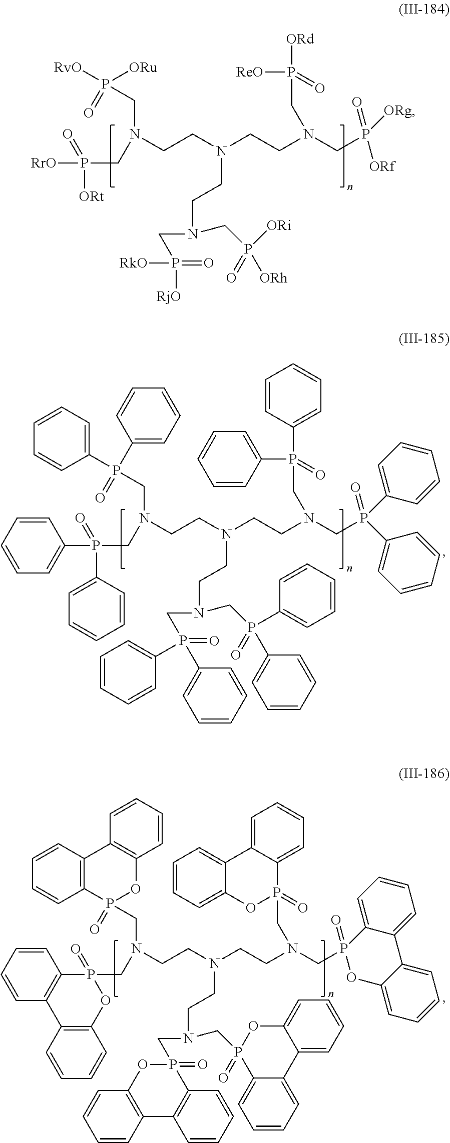 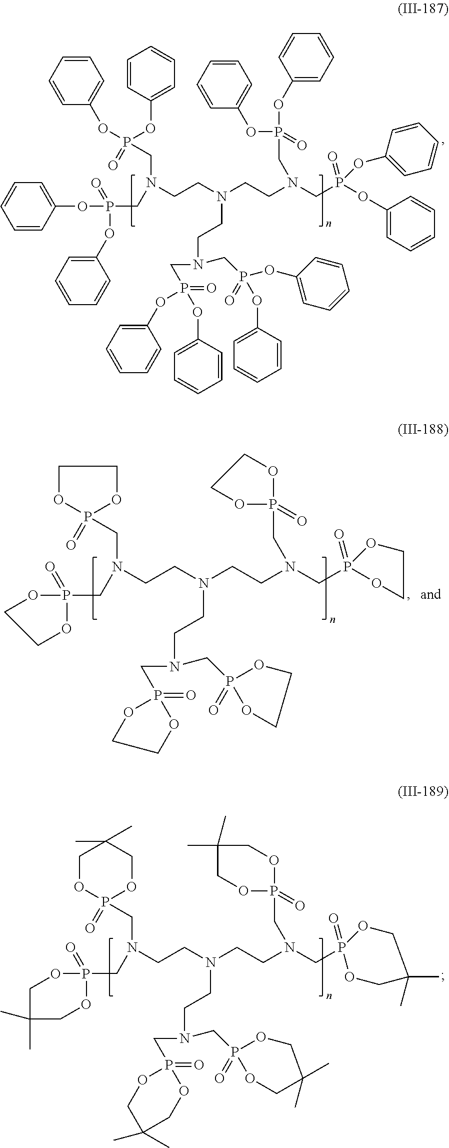
wherein n (if present) is an integer, n≥1, and preferably n=1˜100,
wherein, in all compounds (III-1) to (III-189), Re, Rd, Rf, Rg, Rh, Ri, Rk, Rj, Rm, Rl, Rp, Rq, Rr, Rt, Ru and Rv (if present) are independently of each other selected from C1-C24 alkyl, heteroalkyl, cycloalkyl, heterocycloalkyl, C6-C24 aryl, substituted aryl, C3-C24 heteroaryl, substituted heteroaryl, fused cycloalkyl aryl, fused cycloalkane heteroaryl group, fused heterocyclyl aryl, fused heterocyclyl heteroaryl, and nitrogen, silicon, oxygen, boron, sulfur, and carbonyl or sulfonyl substituted C1-C24 alkyl, cycloalkyl, heterocycloalkyl groups; and acyl radical.

16. A phosphorus nitrogen flame retardant represented by Formula III: 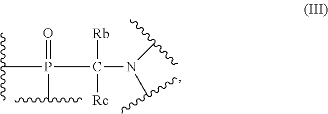
wherein Rb is independently of each other hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜-C18 aryl, substituted or unsubstituted heteroaryl such as C3˜C18 heteroaryl, and acyl radical;
wherein Rc is independently of each other hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical; and
wherein the waved lines represent any structural moiety or moieties.

17. The phosphorus nitrogen flame retardant according to claim 16, which is represented by anyone of Formulas (III-X), (III-Y) (III-1)˜(III-171) and (III-173)˜(III-189): 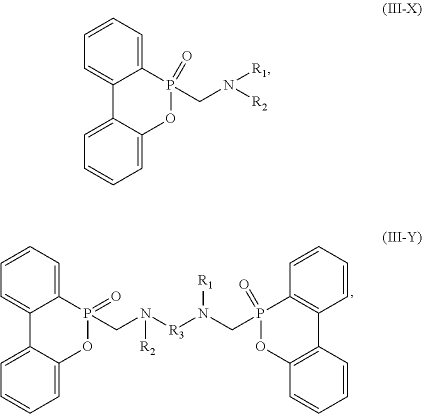
wherein R1 and R2 are independently of each other selected from H, C1-C24 alkyl, cycloalkyl, heteroalkyl, heterocycloalkyl, C6-C24 aryl, C3-C24 heteroaryl, fused cycloalkyl aryl, fused cycloalkane heteroaryl group, fused heterocyclyl aryl, fused heterocyclyl heteroaryl, and nitrogen, silicon, boron, oxygen, sulfur, and carbonyl or sulfonyl substituted C1-C24 alkyl groups; or wherein R1 and R2 are connected through a saturated/unsaturated alkyl group, or bridging a heteroaryl group, a fused cycloalkyl aryl group, a fused ring with the N atom, cycloalkylheteroaryl, fused heterocyclylaryl, or fused heterocyclylheteroaryl; optionally wherein the heteroaryl group is a monocyclic or polycyclic aromatic group, and the N atom is connected to the aromatic ring; optionally wherein the group contains one, two or three heterocyclic atoms being selected from N, O and S, and the remaining ring atoms are C; optionally wherein one or more carbon atoms of the heteroaryl group is substituted by a carbonyl group; optionally wherein the heterocyclic group is a non-aromatic mono- or polycyclic group, wherein one or more ring atoms are selected from N, O, or S(O) x heteroatoms, where x is an integer from 0 to 2, and the remaining ring atoms are C; optionally wherein the alkyl group includes linear, branched or aromatic ring-containing alkyl groups; and
wherein R3 is selected from C1-C24 alkyl, heteroalkyl, cycloalkyl, heterocycloalkyl, C6-C24 aryl, C3-C24 heteroaryl, fused cycloalkyl aryl, fused cycloalkane heteroaryl group, fused heterocyclyl aryl, fused heterocyclyl heteroaryl, and silicon, oxygen, boron, nitrogen, sulfur, and carbonyl or sulfonyl substituted C1-C24 alkyl groups; and unsaturated alkyl; 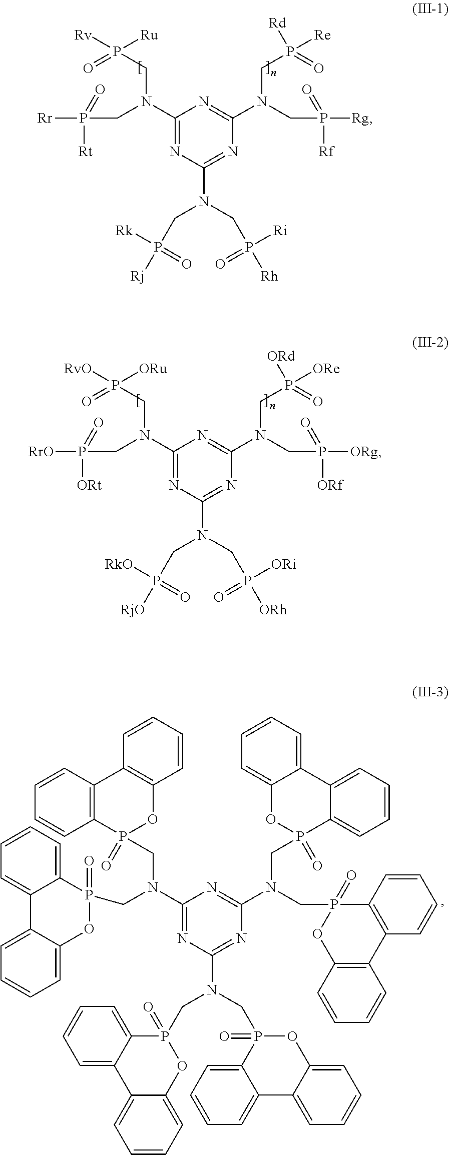 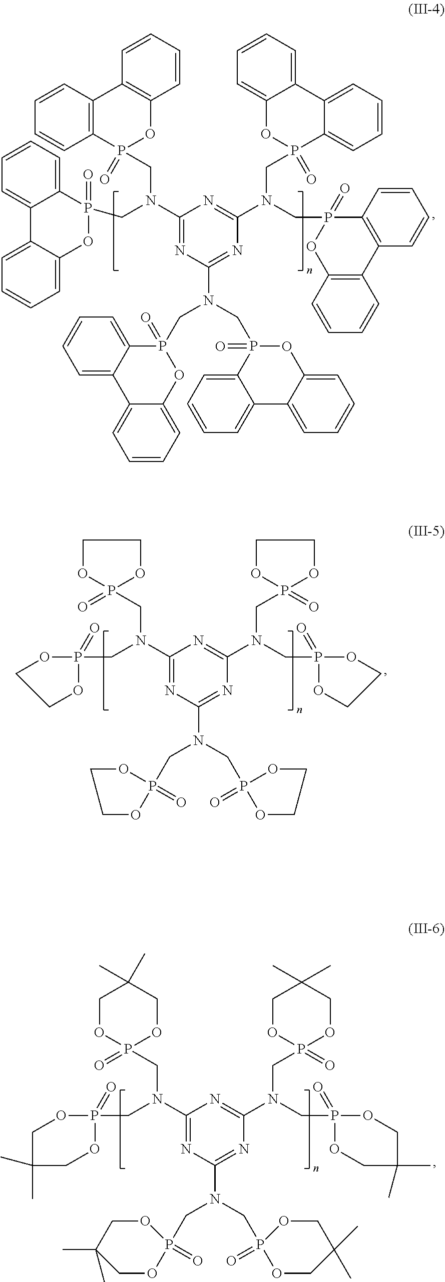 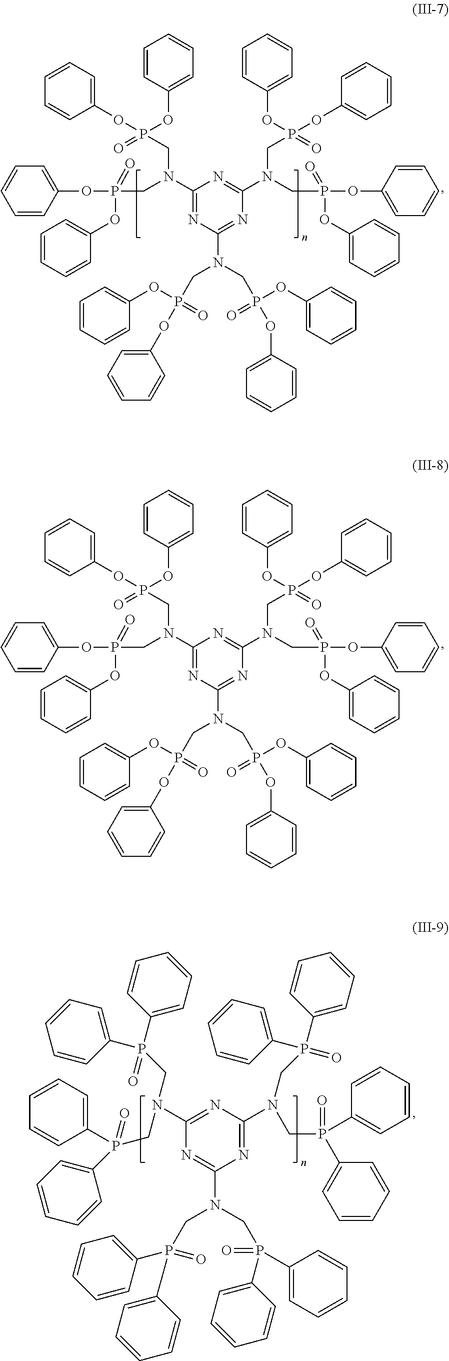 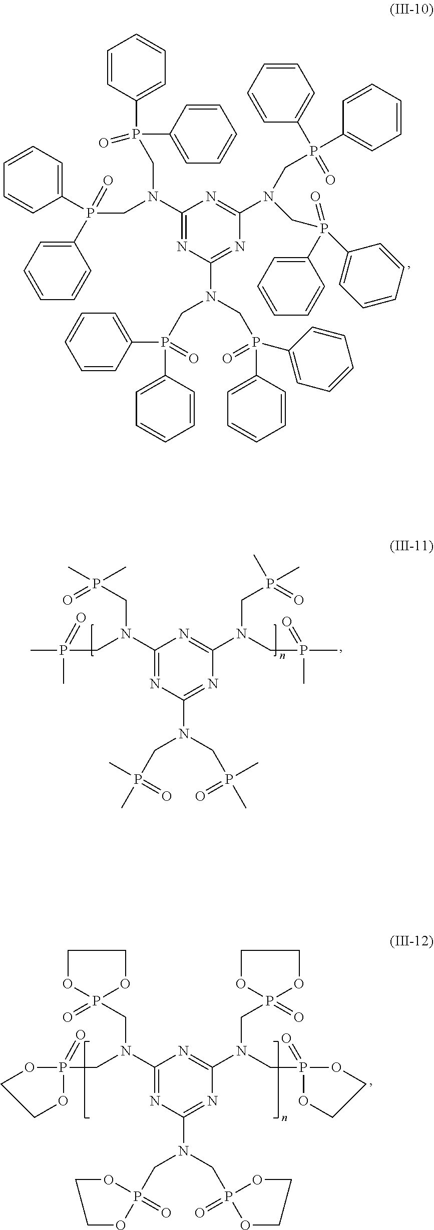 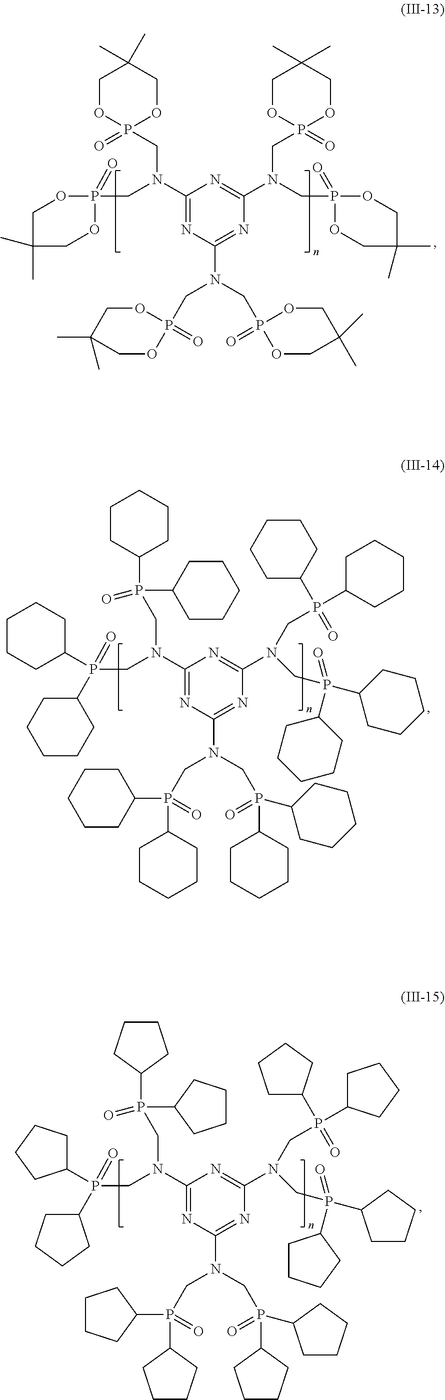 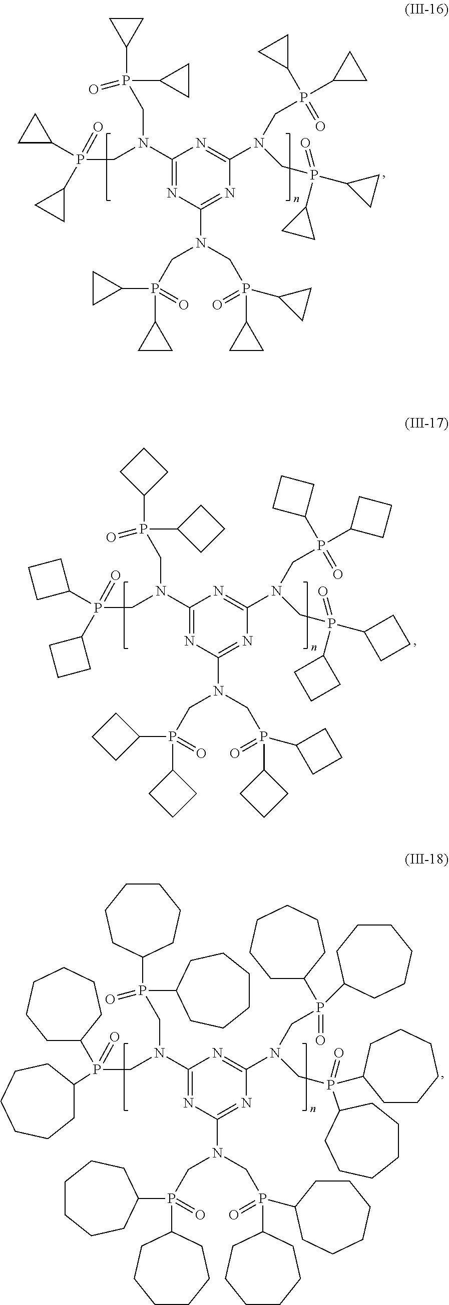 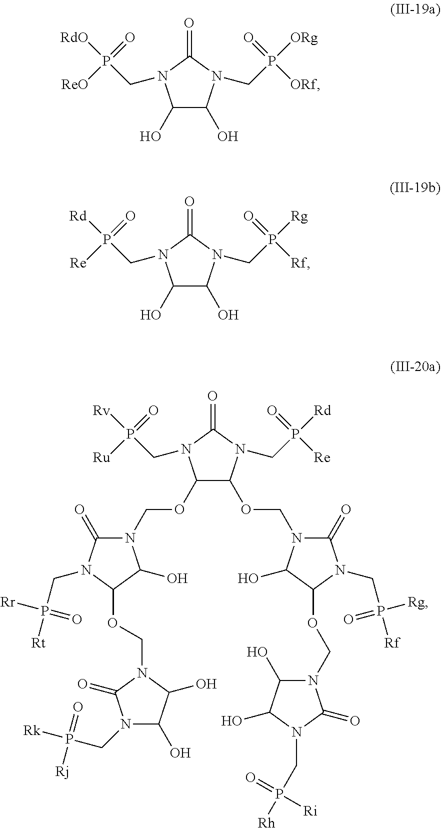 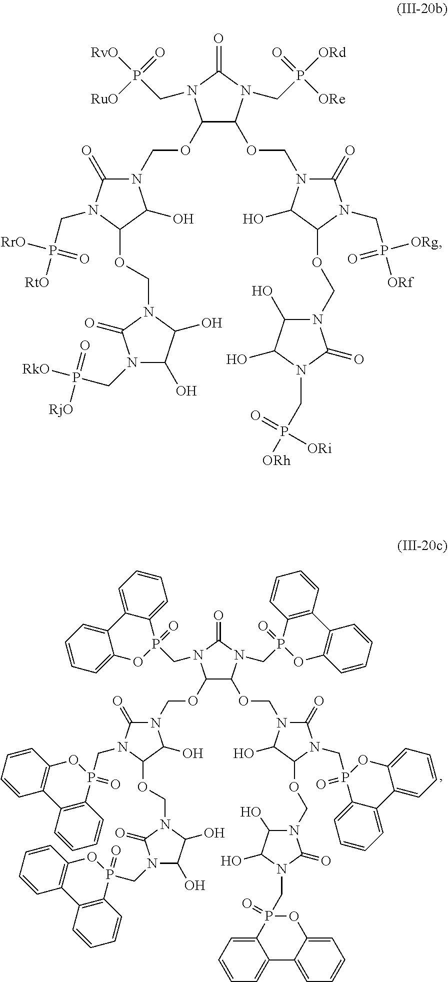 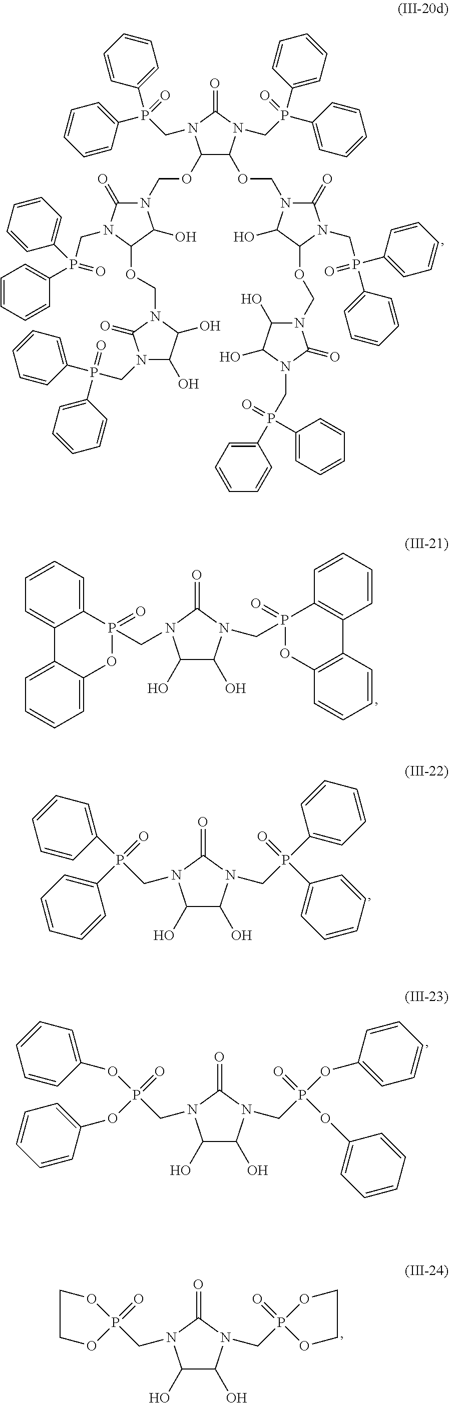 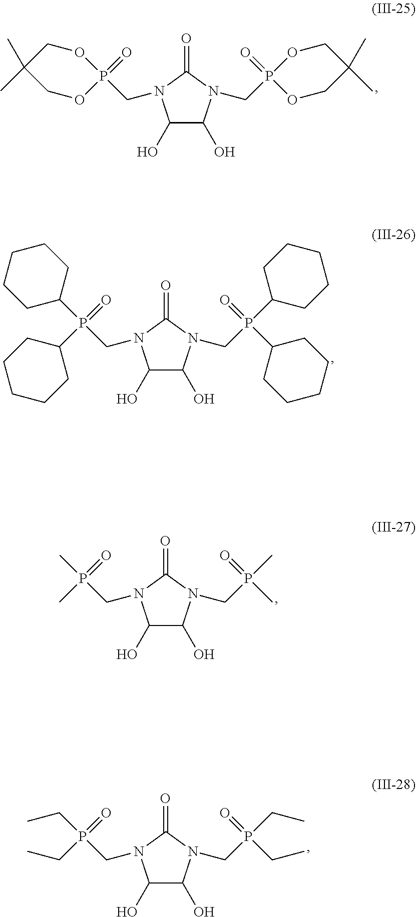 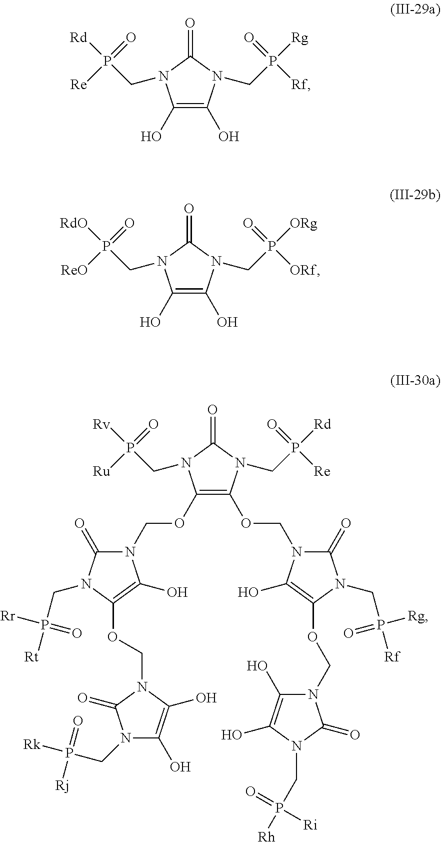 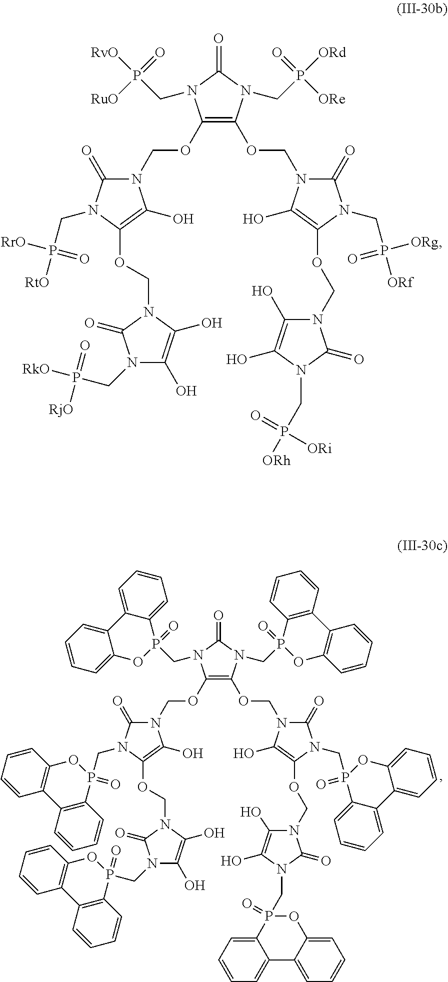 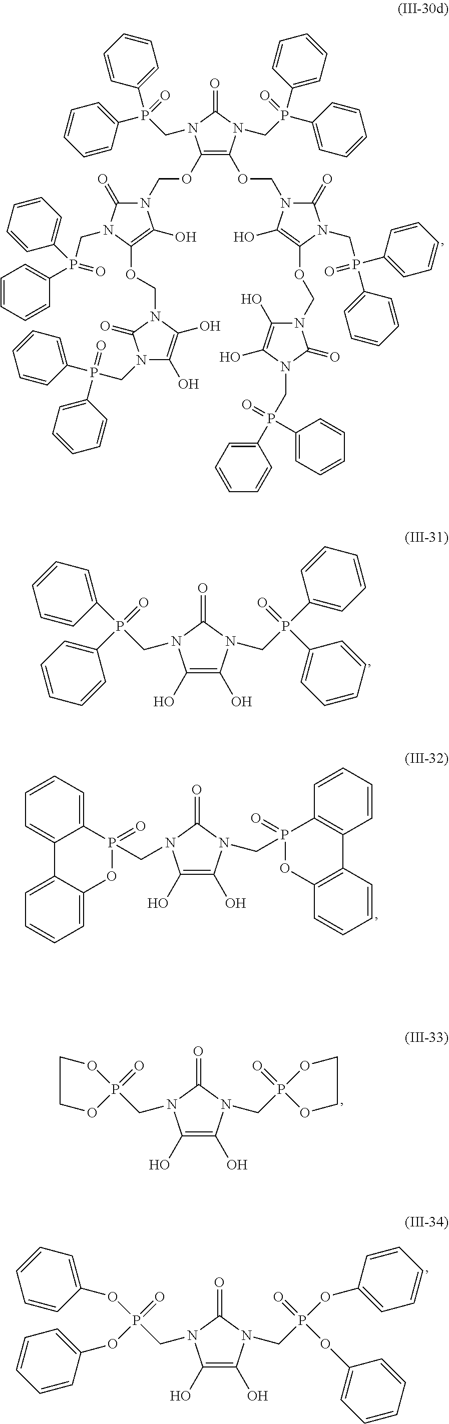 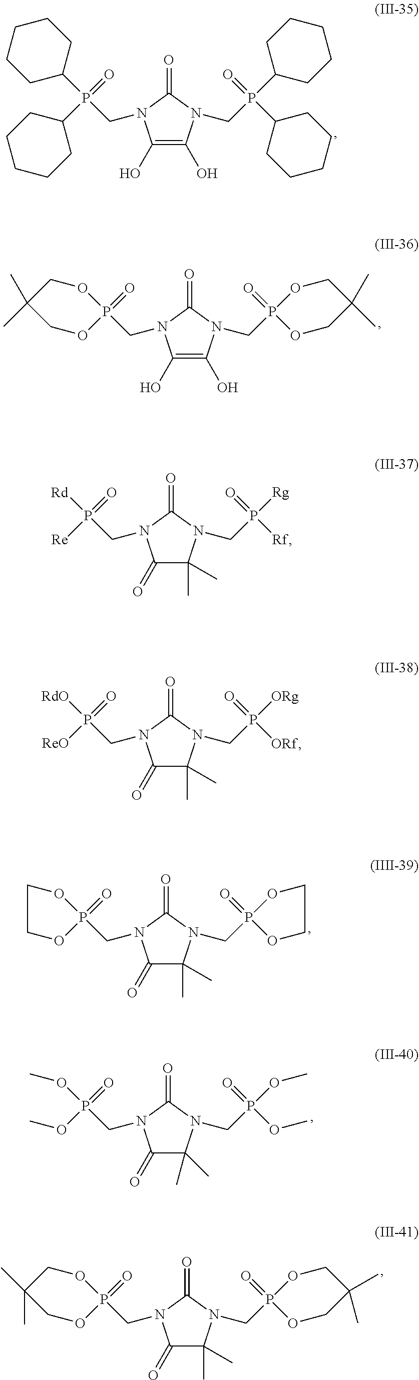 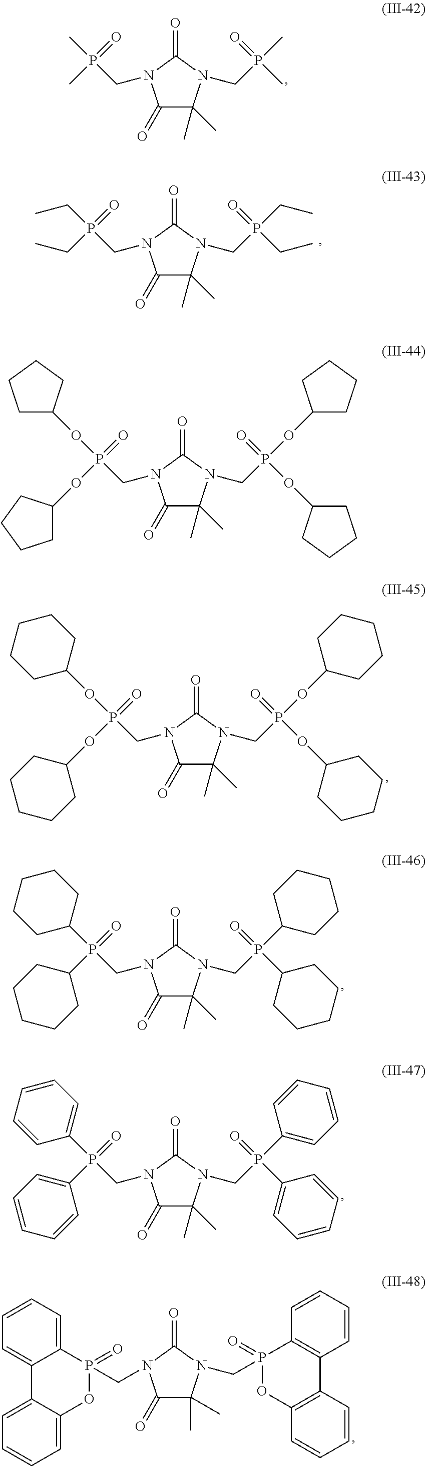 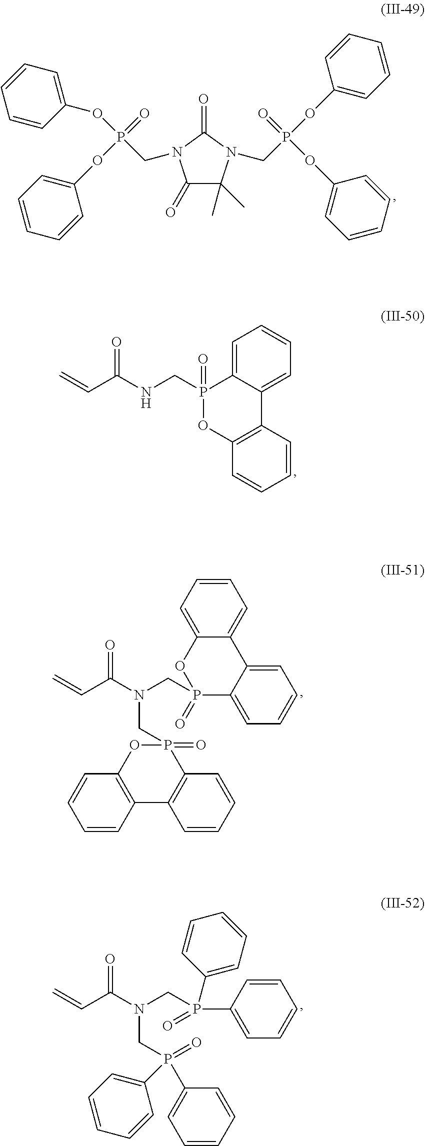 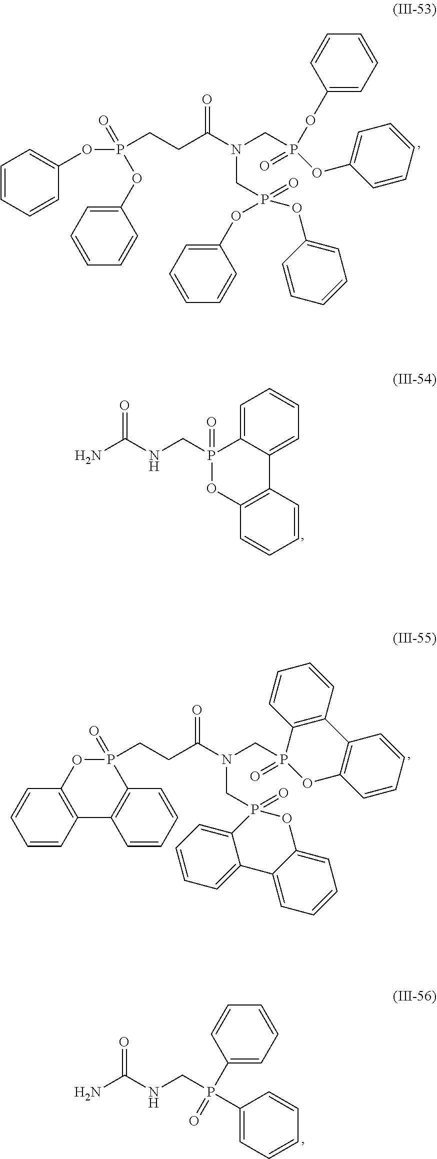 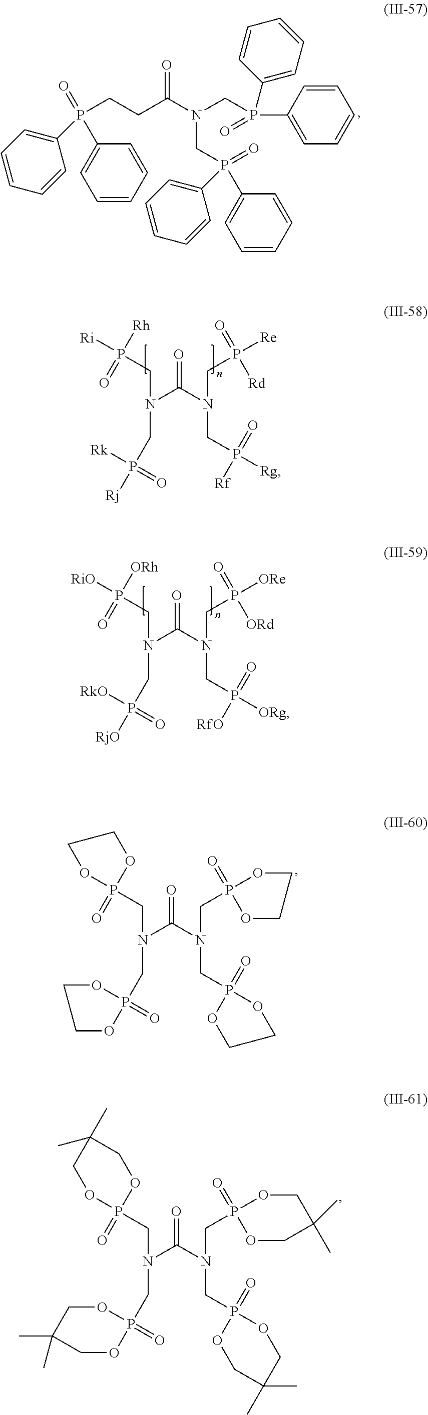 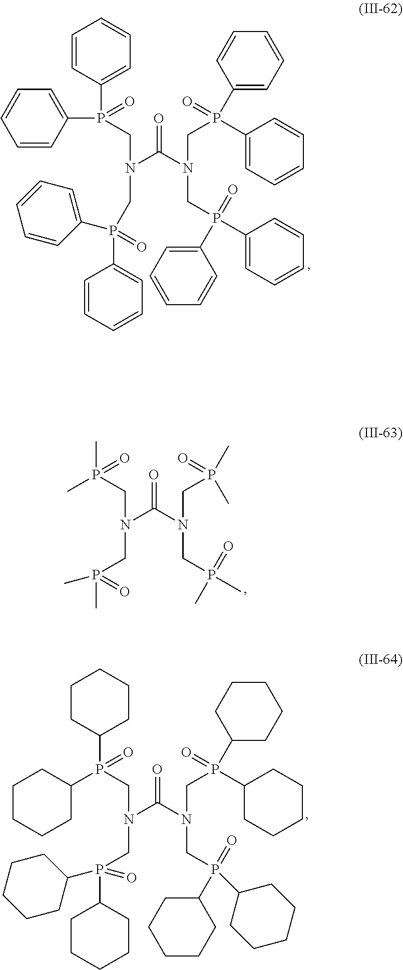 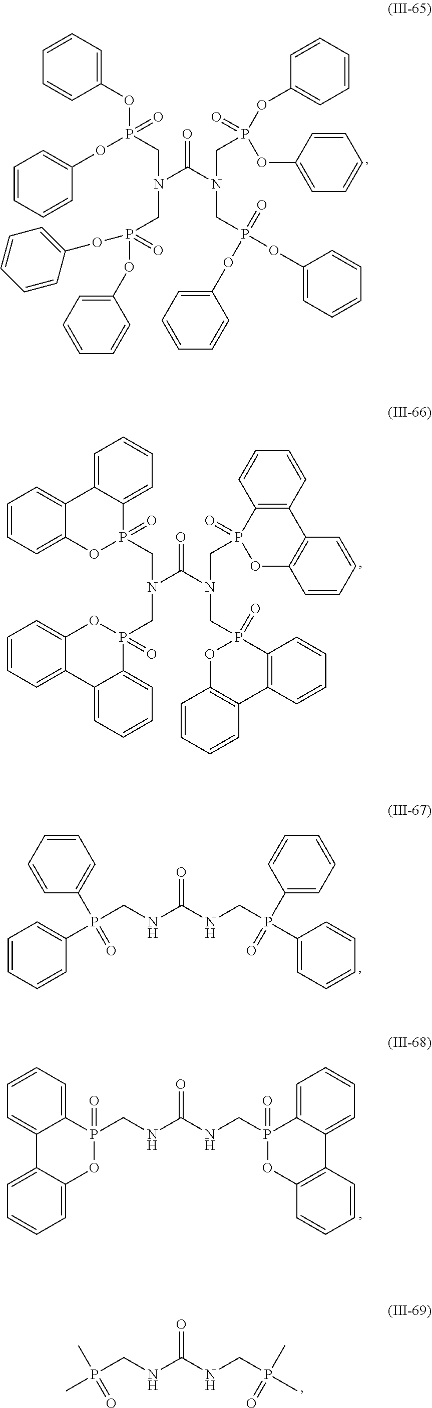 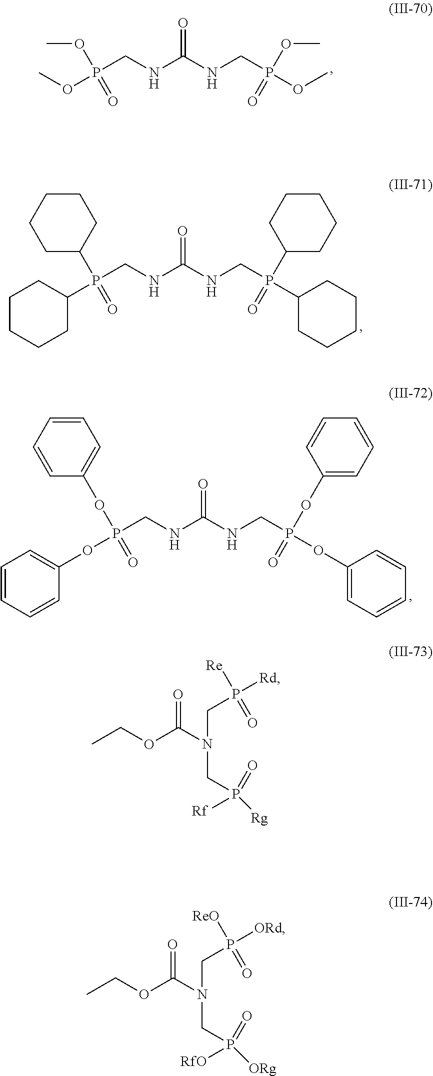 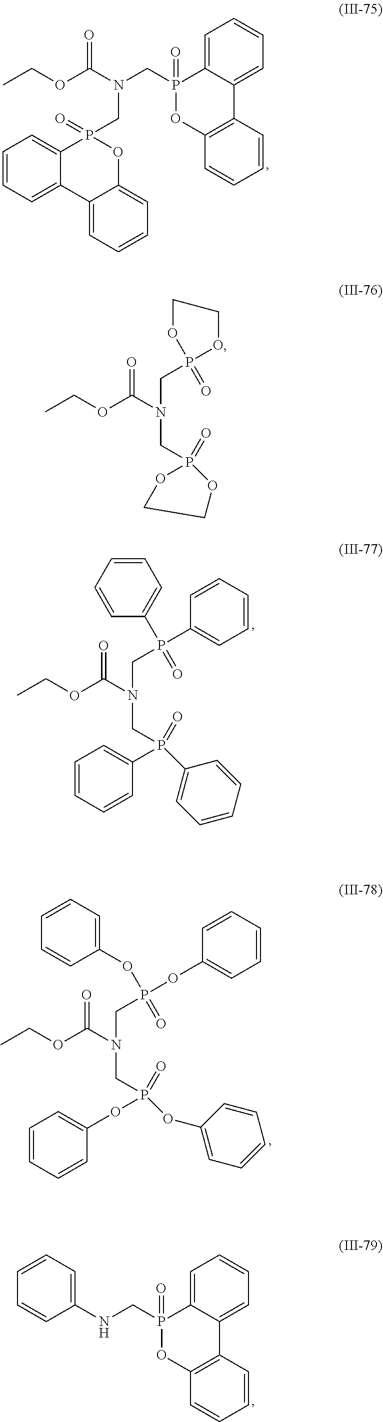 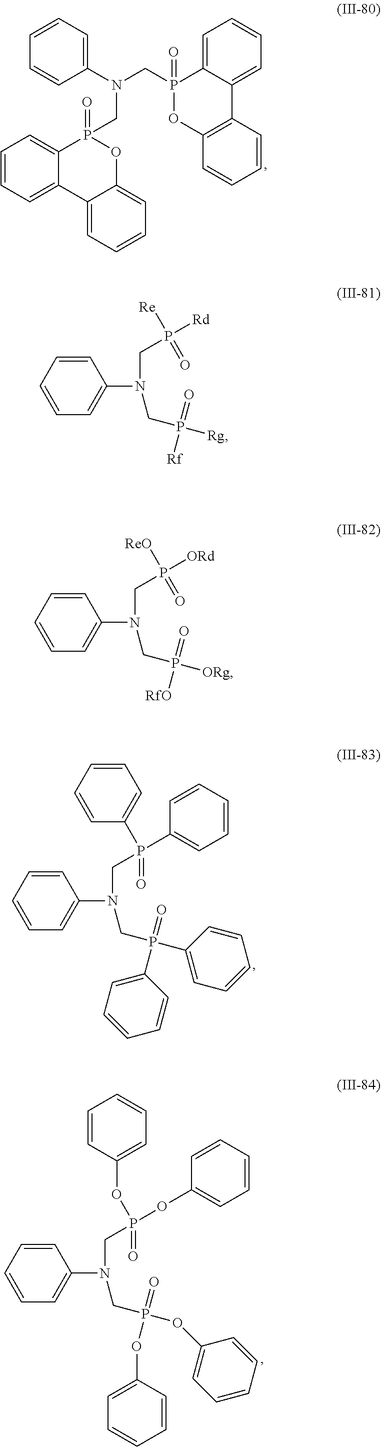 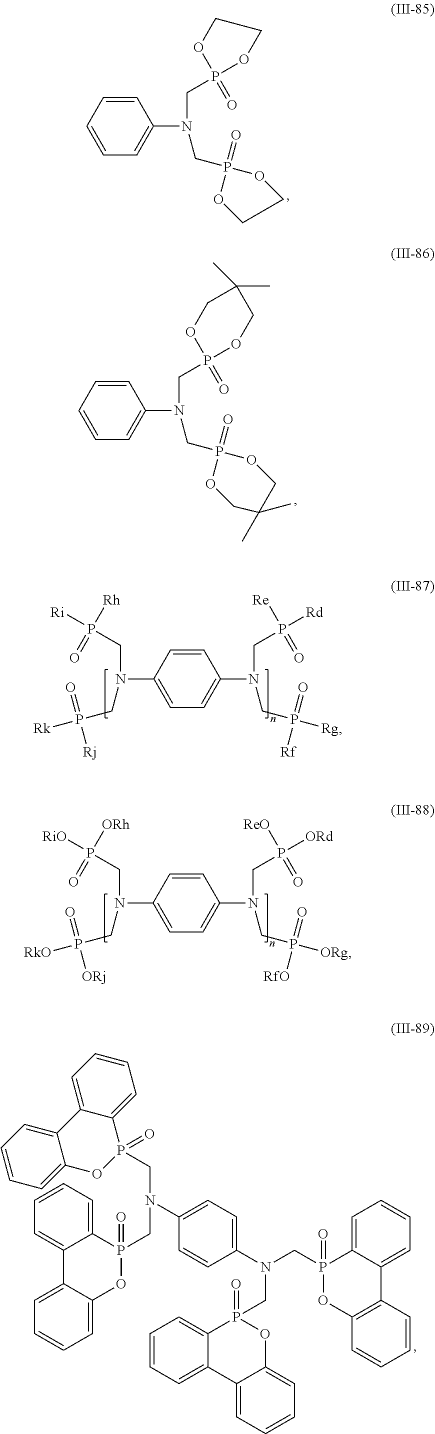 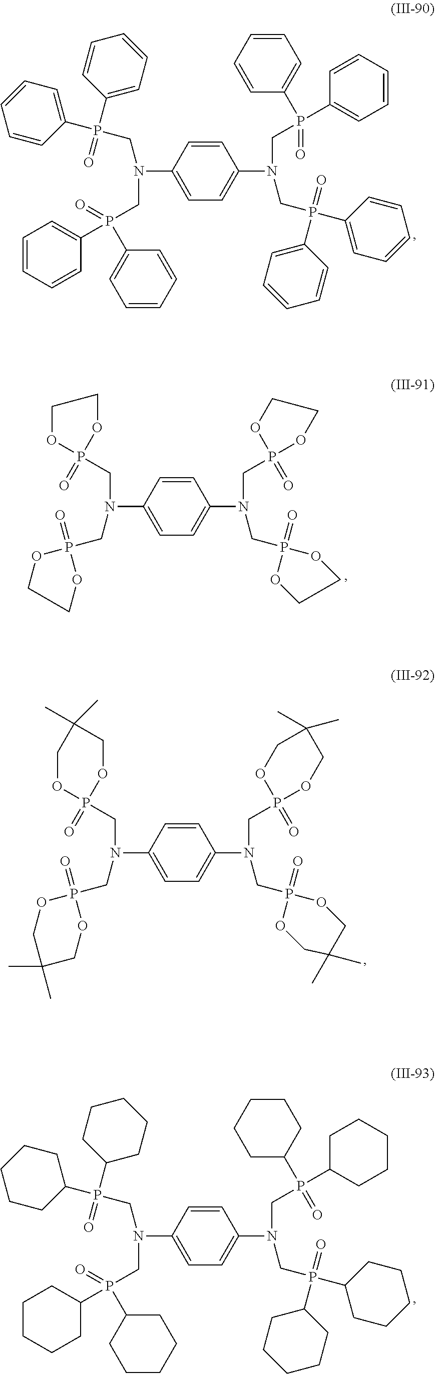 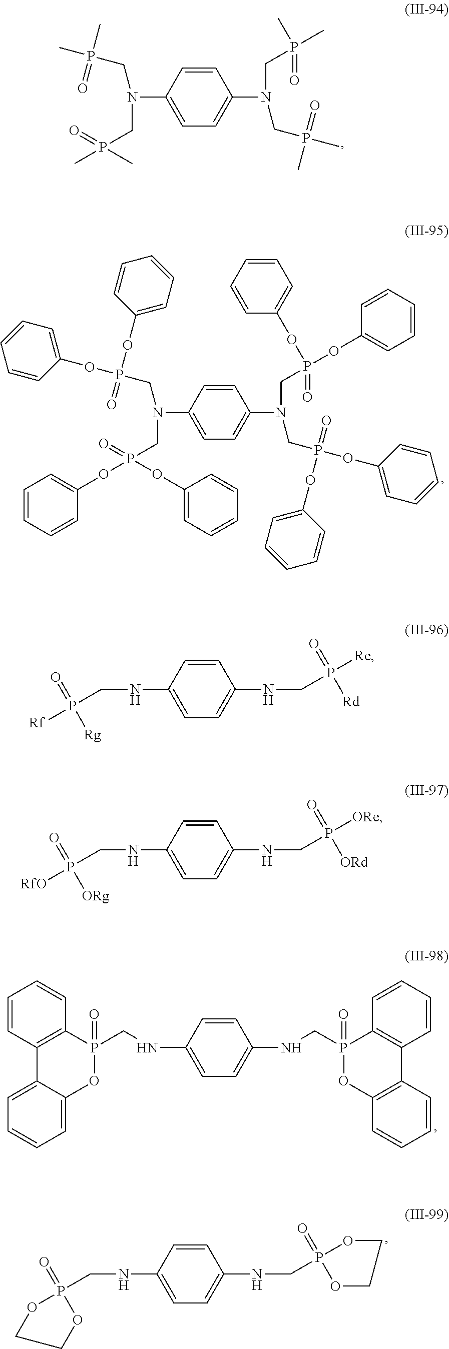 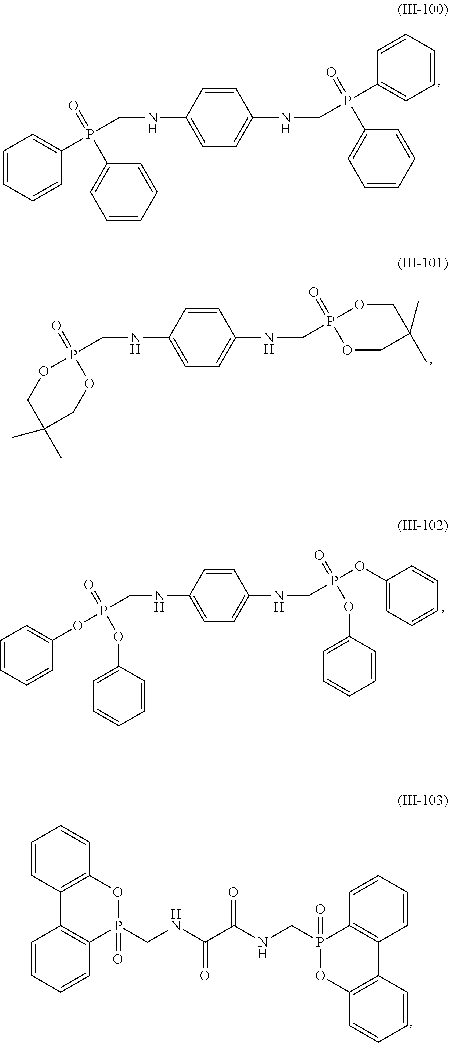 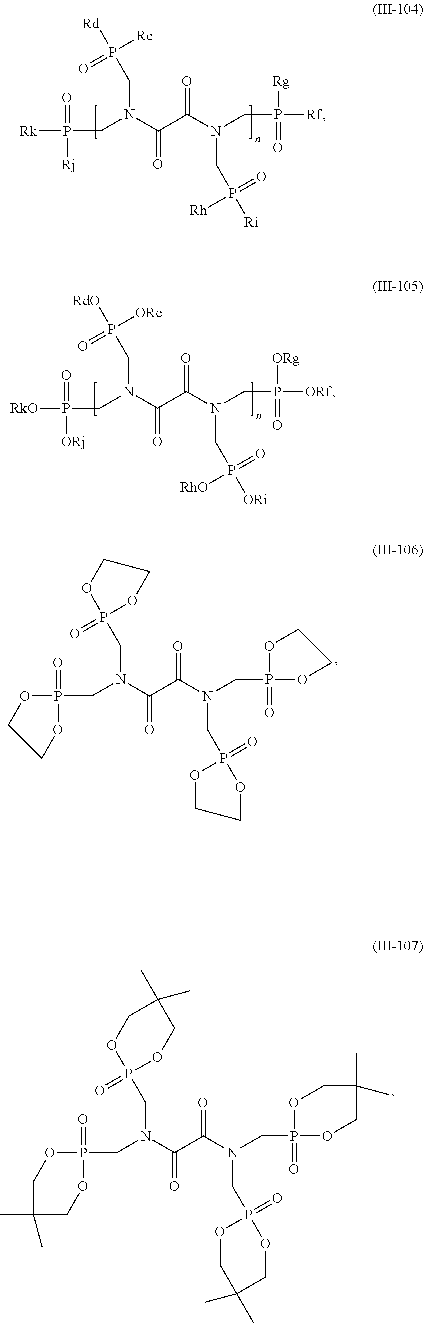 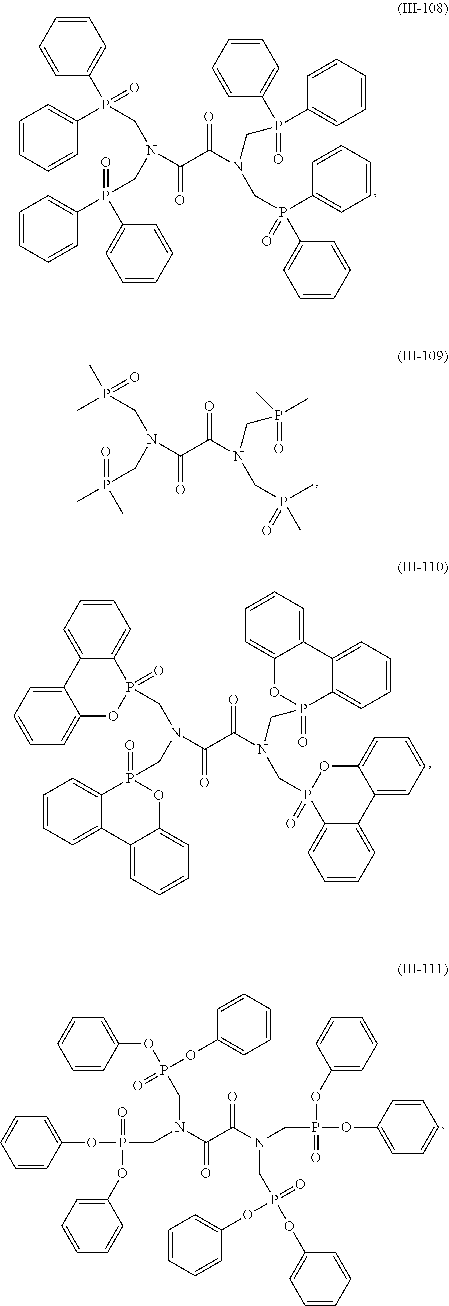 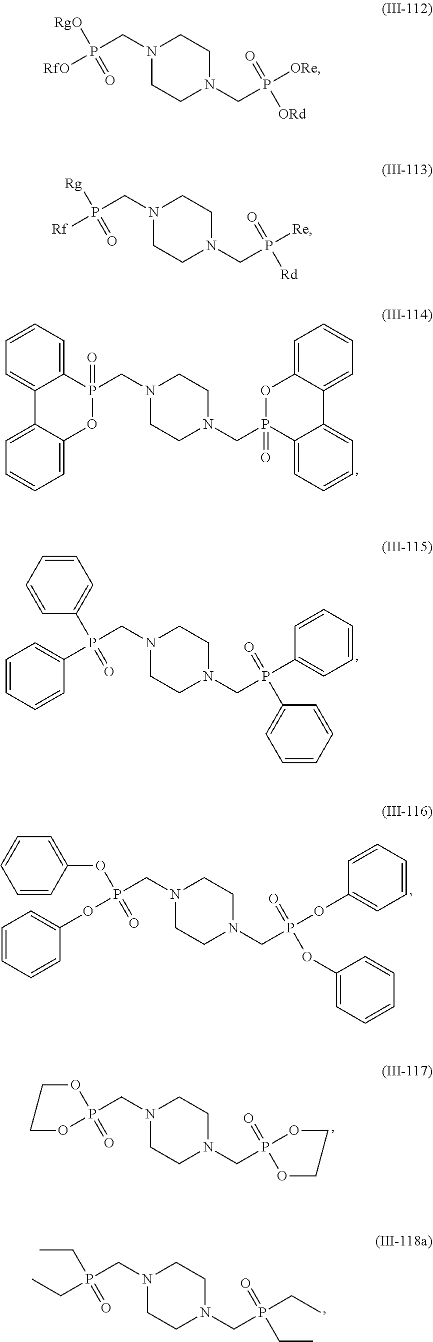 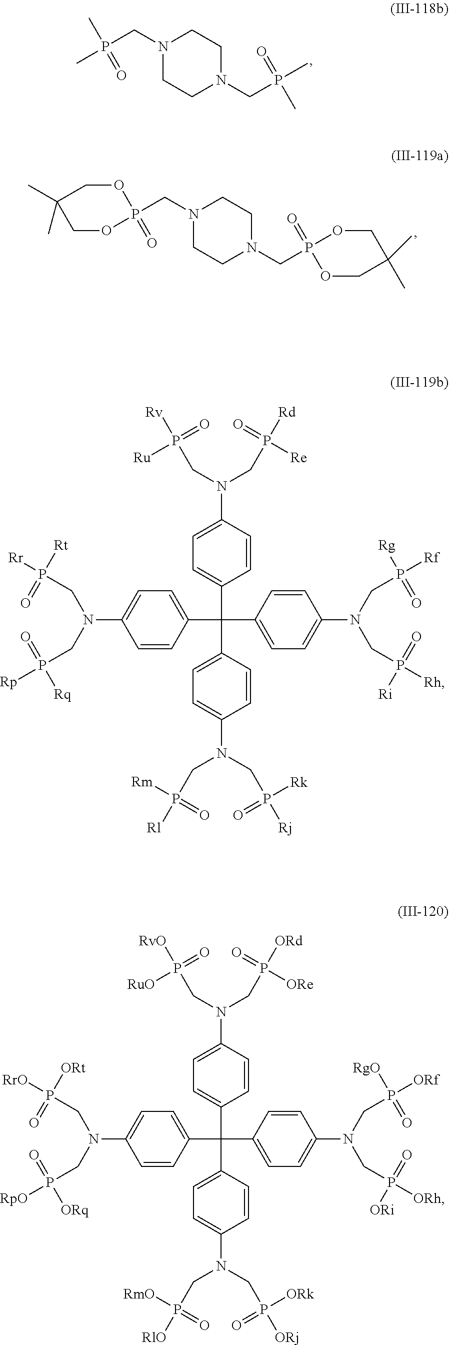 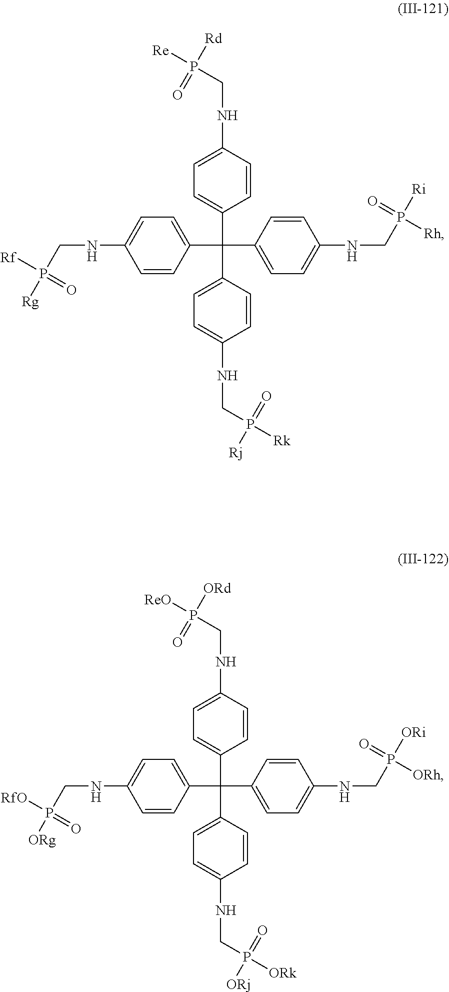 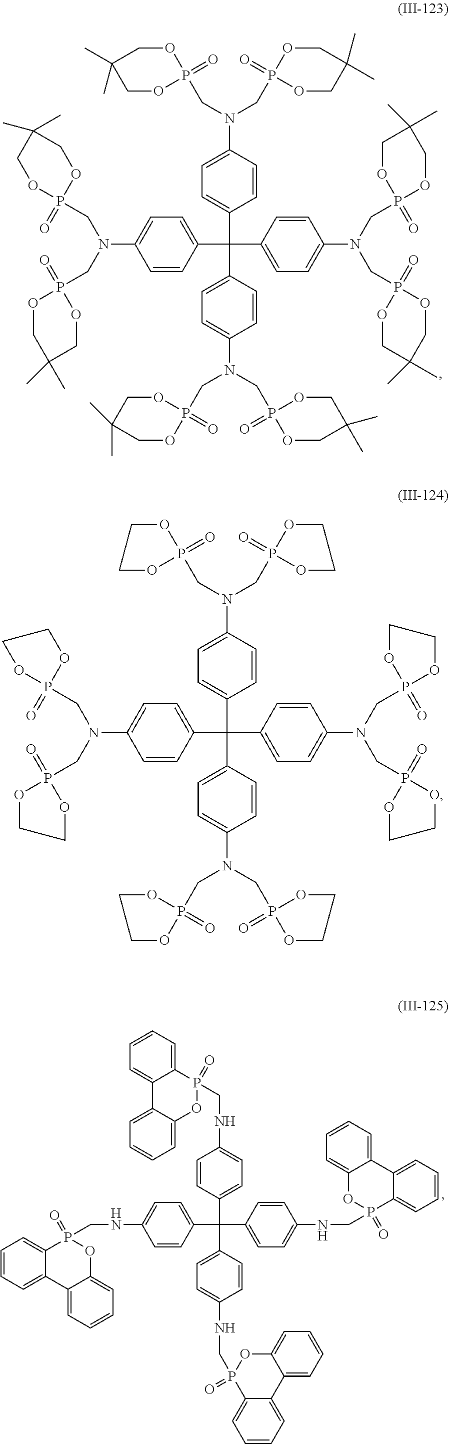 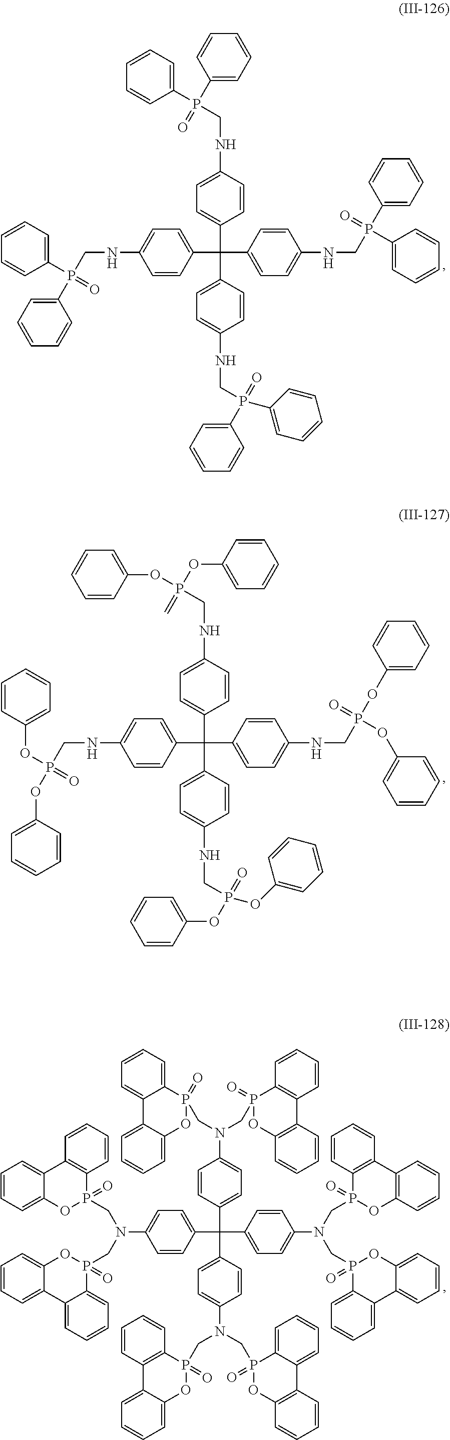 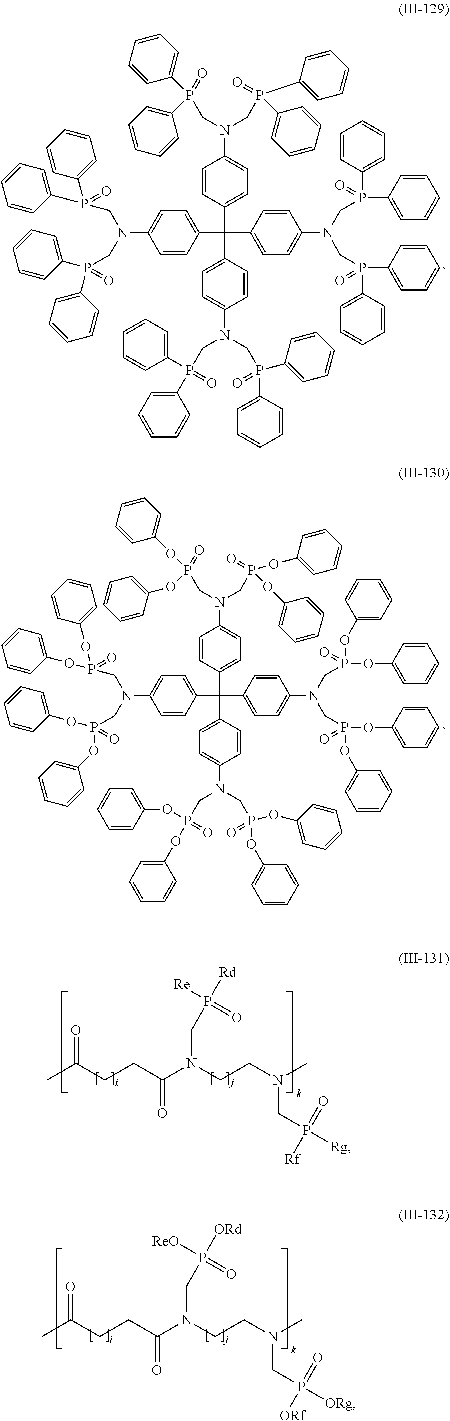
wherein i and j are integers equal to 0 or greater than 0; and k is an integer, k≥1; 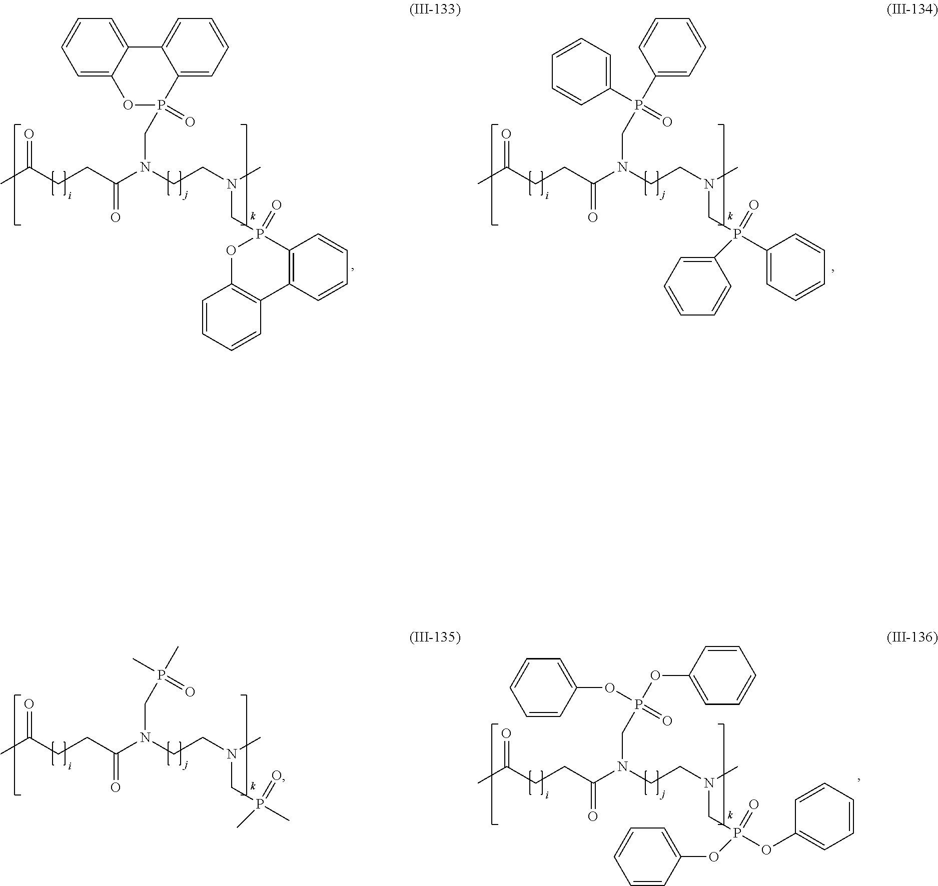 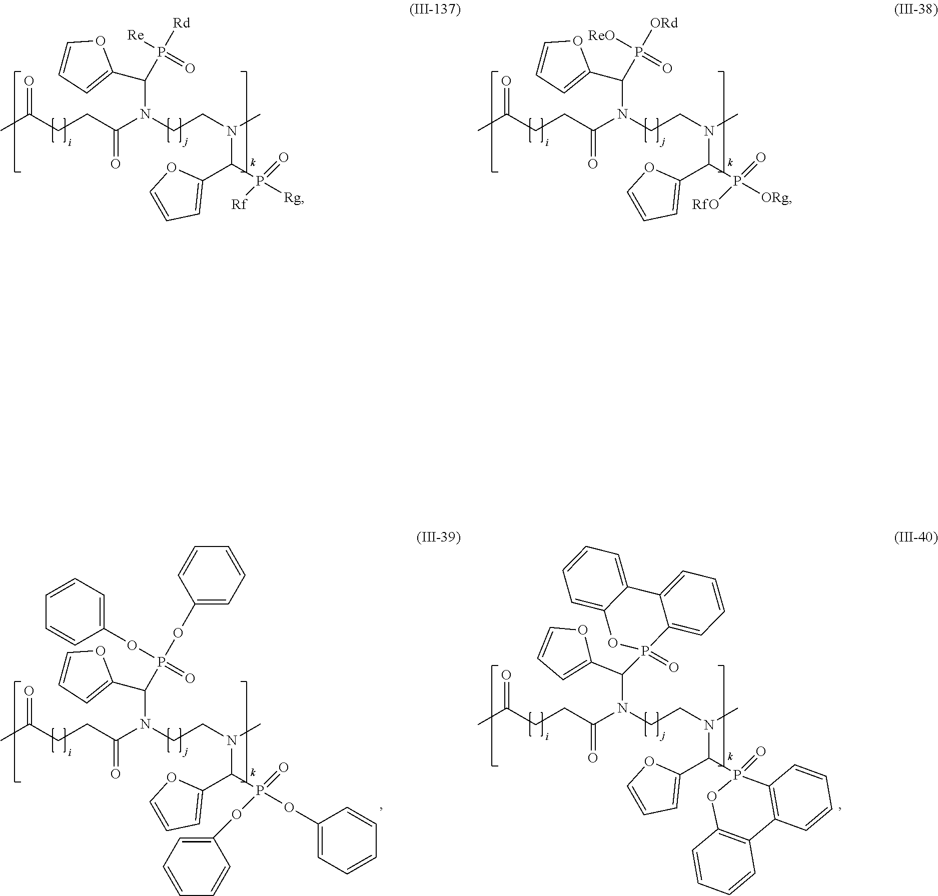 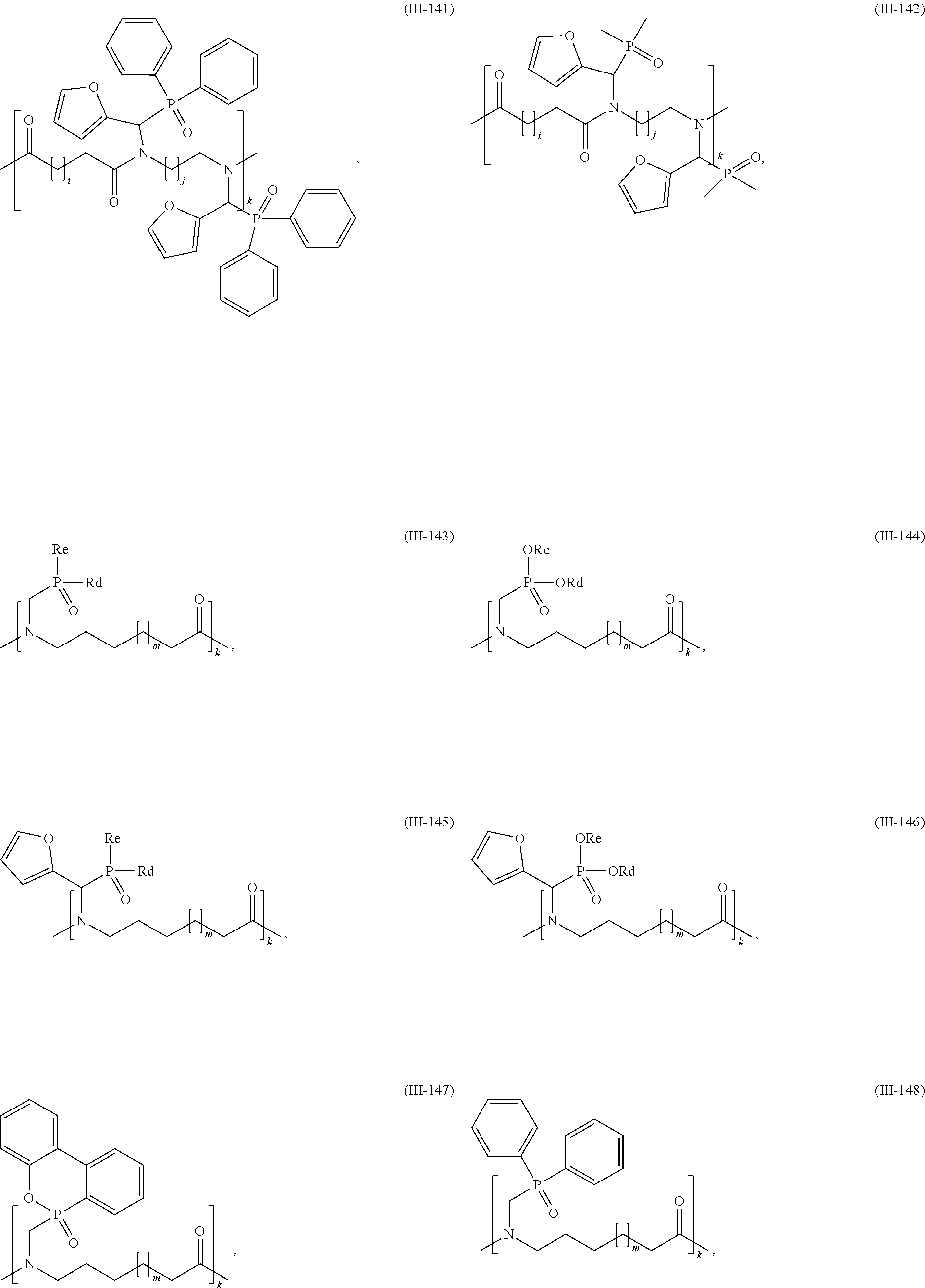 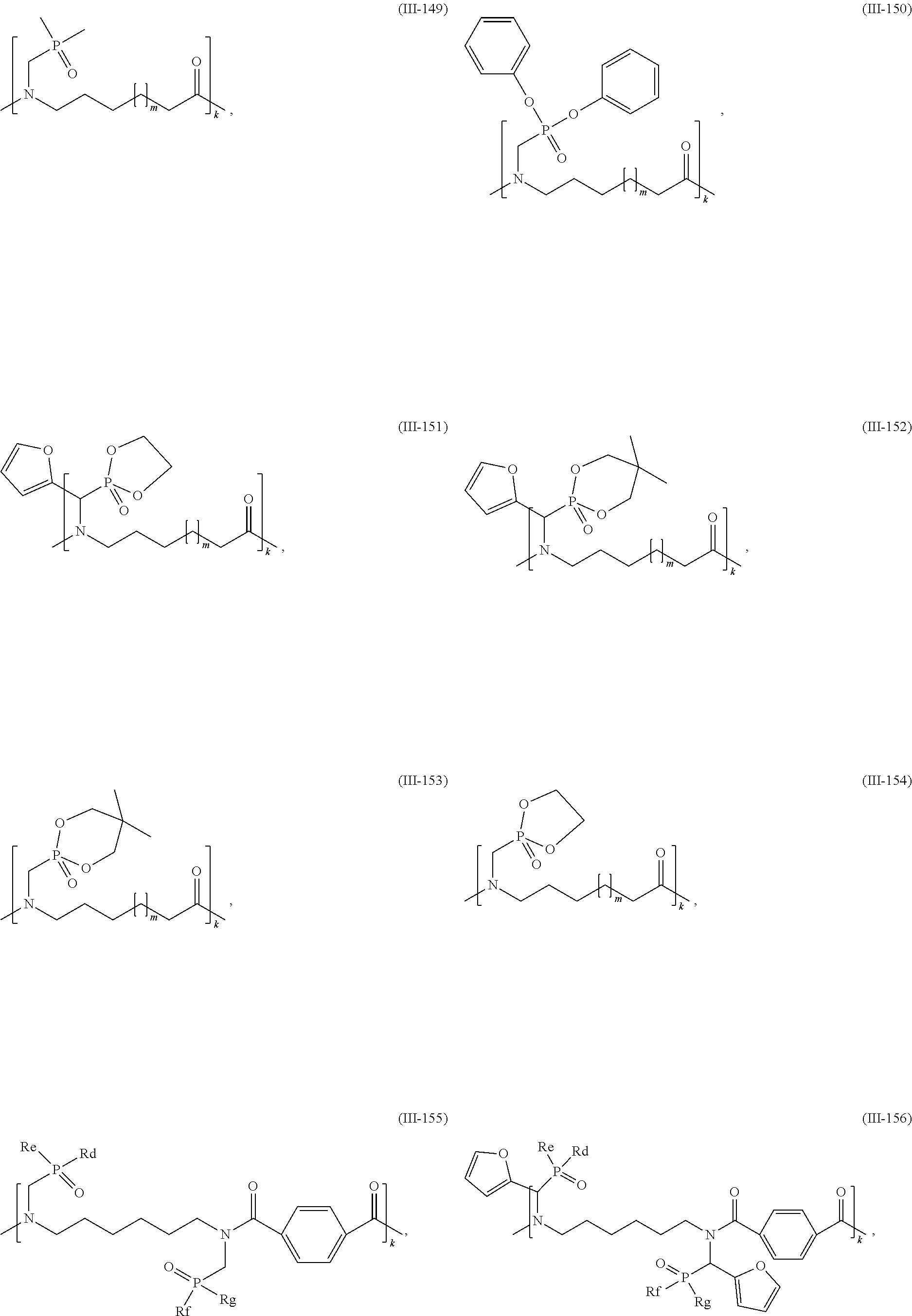 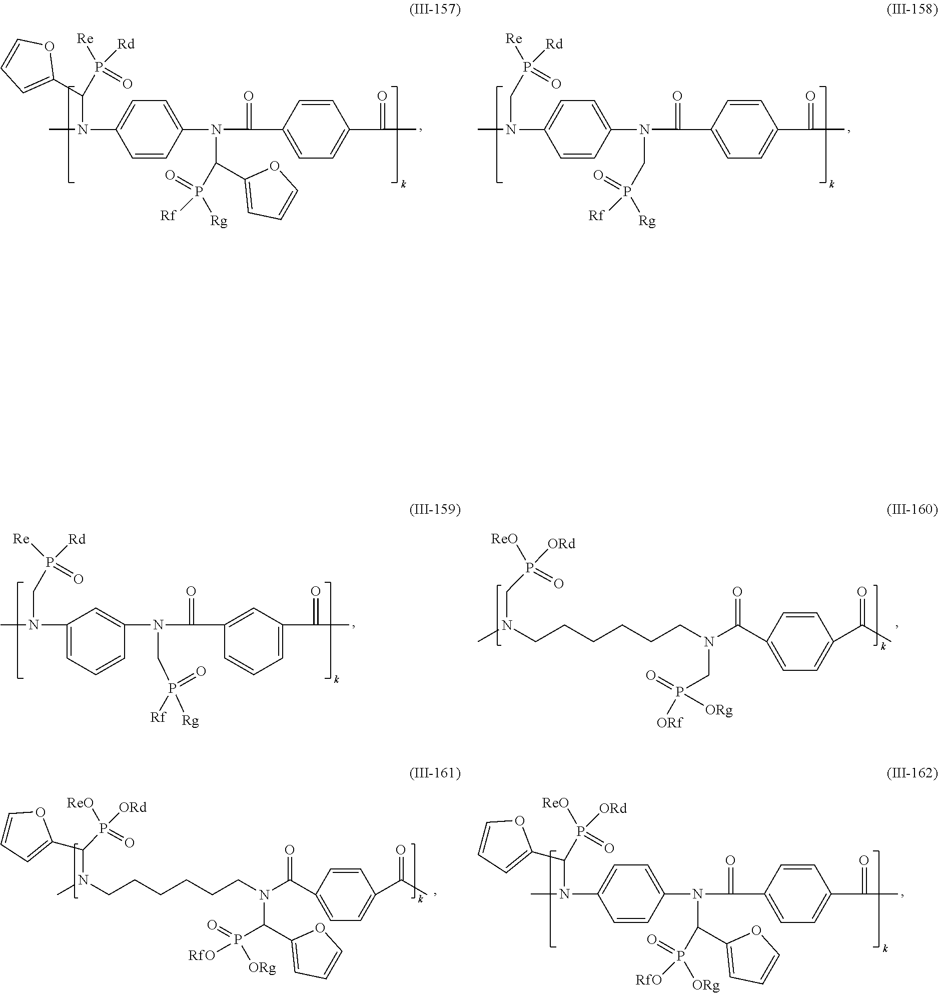 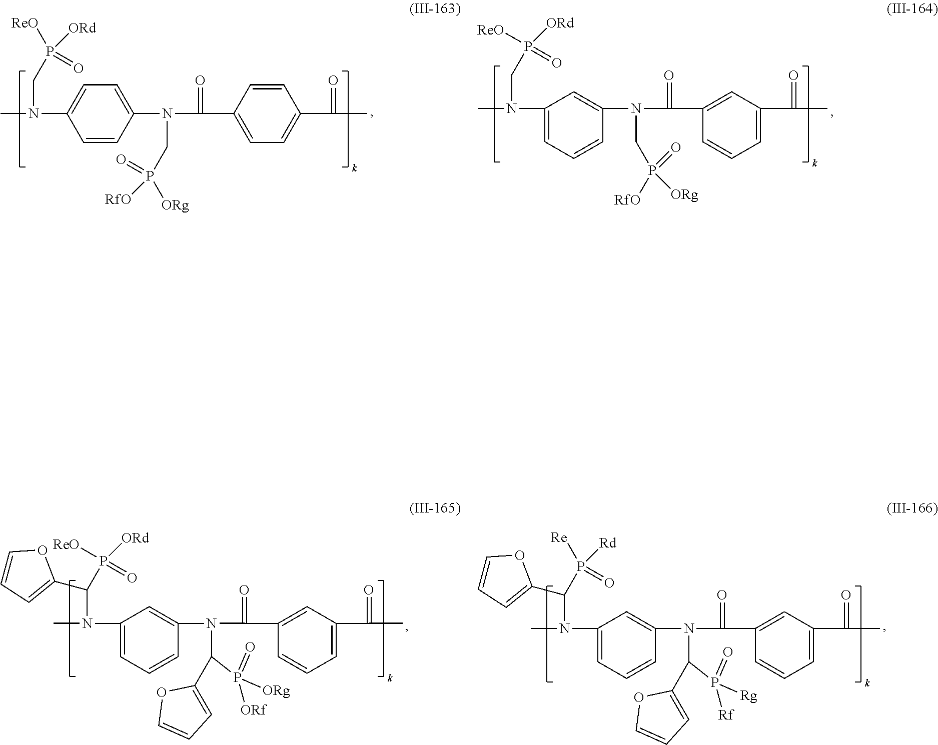 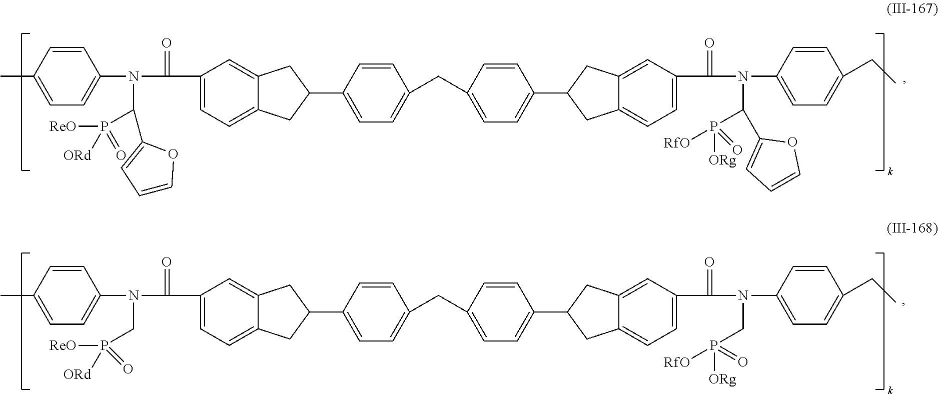
wherein i, j, and m are integers ≥0; k is an integer ≥1; 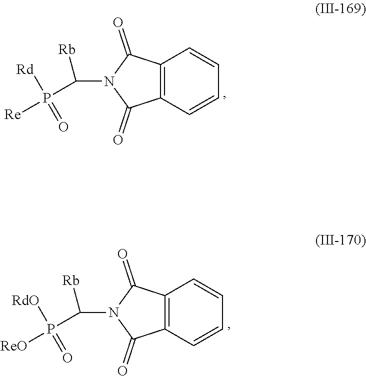
wherein Rb is selected from hydrogen, substituted or unsubstituted alkyl such as C1-C18 alkyl, substituted or unsubstituted heteroalkyl, substituted or unsubstituted cycloalkyl, substituted or unsubstituted heterocyclic alkyl, substituted or unsubstituted heterocycles, substituted or unsubstituted aryl such as C6˜C18 aryl, substituted or unsubstituted heteroaryl such as C3˜C18 heteroaryl, and acyl radical; 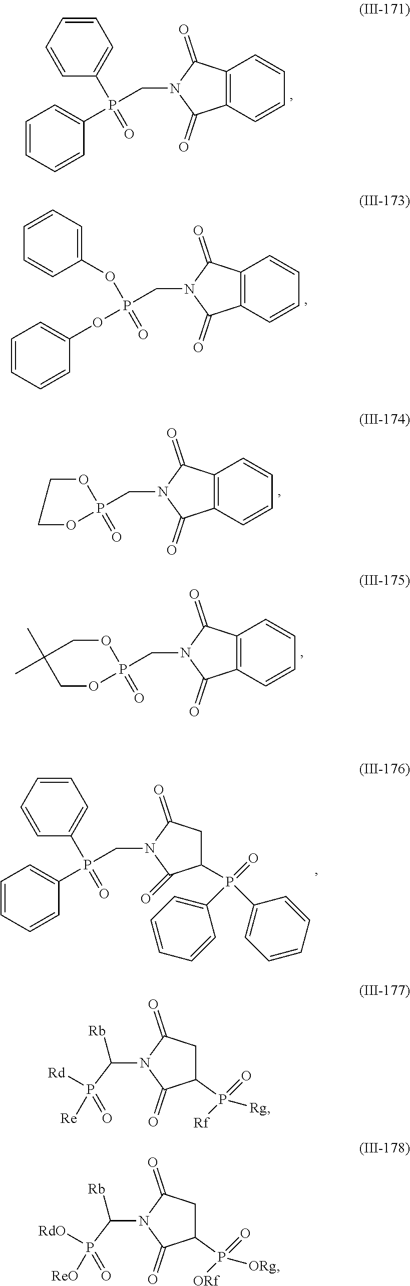 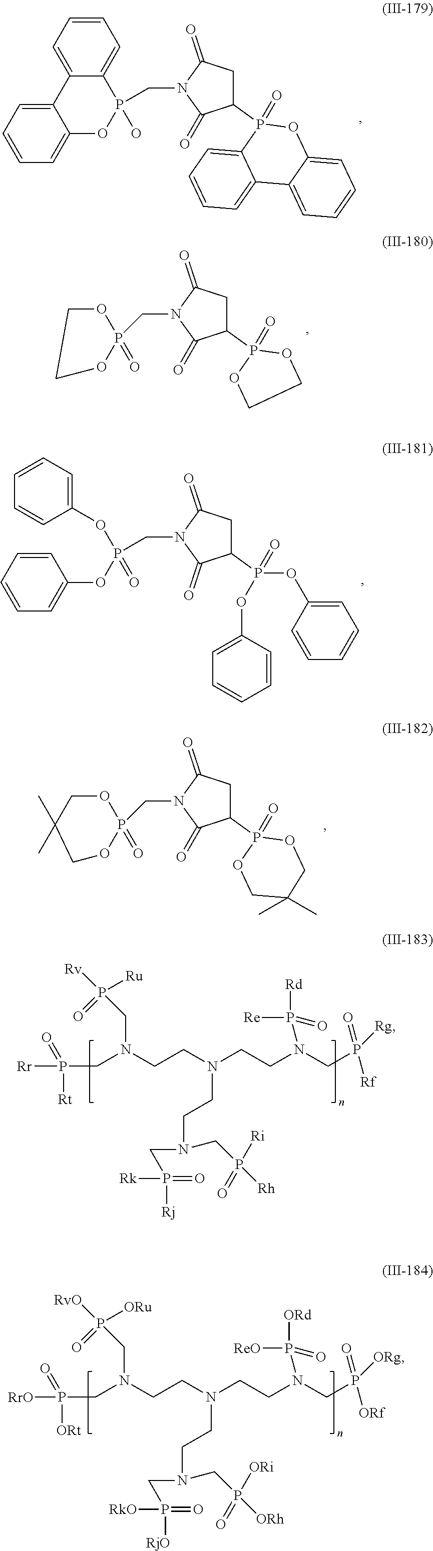 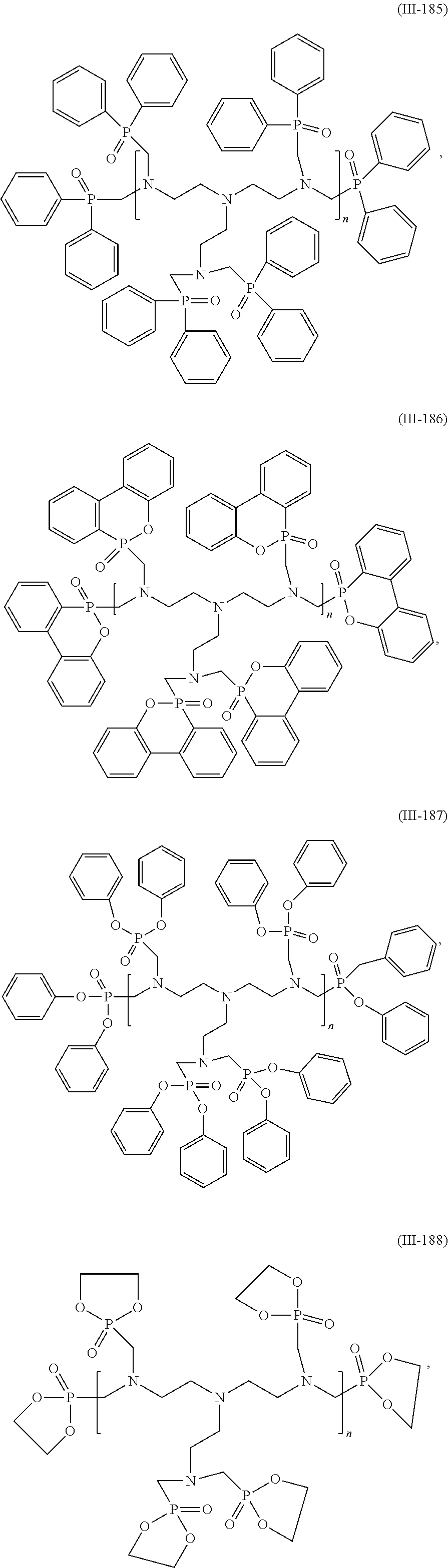 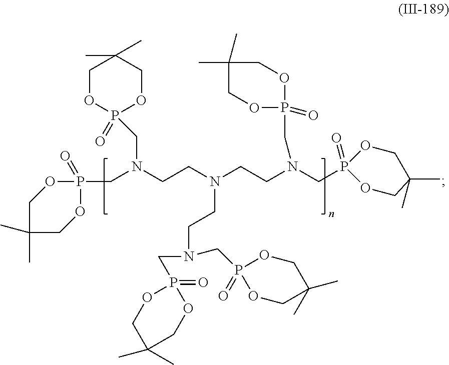
and
wherein n (if present) is an integer, n≥1, and preferably n=1˜100,
wherein, in all compounds (III-1) to (III-189), Re, Rd, Rf, Rg, Rh, Ri, Rk, Rj, Rm, Rl, Rp, Rq, Rr, Rt, Ru and Rv (if present) are independently of each other selected from C1-C24 alkyl, heteroalkyl, cycloalkyl, heterocycloalkyl, C6-C24 aryl, substituted aryl, C3-C24 heteroaryl, substituted heteroaryl, fused cycloalkyl aryl, fused cycloalkane heteroaryl group, fused heterocyclyl aryl, fused heterocyclyl heteroaryl, and nitrogen, silicon, oxygen, boron, sulfur, and carbonyl or sulfonyl substituted C1-C24 alkyl, cycloalkyl, heterocycloalkyl groups; and acyl radical.

18. A material comprising a base polymer and the phosphorus nitrogen flame retardant according to claim 16, optionally in a weight ratio of 25:75 to 99:1.

19. The material according to claim 18, wherein the base polymer is selected from resins such as thermoplastic resins and thermseting resins; thermoplastic resins such as polyphosphonate, polyethylene, polypropylene, polyisoprene, cyclic olefin copolymer, polyesters (e.g. polyethylene terephthalate, polybutylene terephthalate, polytrimethylene terephthalate, and polyethylene naphthalate), poly(2-ethyl-2-oxazoline), polycaprolactone, poly(lactic acid), poly(butylene adipate-co-terephthalate), polyhydroxyalkanoates, polypropylene carbonate, poly(farnenesene)diols, thermoplastic polyester elastomer (TPEE), TPE, thermoplastic polyolefin (TPO), thermoplastic vulcanizates (TPV), styrene-ethylene-butylene-styrene polybutadiene, polystyrene resin, impact-resistant polystyrene, acrylonitrile-styrene resin (SAN), acrylonitrile-butadiene-styrene resin (ABS resin), methyl methacrylate-butadiene-styrene resin (MBS resin), methyl methacrylate-acrylonitrile-butadiene-styrene resin (MABS resin), acrylonitrile-acrylic rubber-styrene resin (AAS resin), polymethyl (meth)acrylate, polycarbonate, polyphenylene ether, modified polyphenylene ether (mPPE), polyamide, polyphenylene sulfide, polyimide, polyether ether ketone, polysulfone, polyphenylsulfone, polyarylate, polyether ketone, polyether nitrile, polyvinyl chloride (PVC), chlorinated PVC, polyacrylonitrile, polyurethane, polythioether sulfone, polyether sulfone, polybenzimidazol, polycarbodiimide, polyamideimide, polyetherimide, polyacetal, liquid crystalline polymer, composite plastics and the like, and any blend or mixture thereof; thermosetting resins such as polyurethane, phenol resin, melamine resin, urea resin, unsaturated polyester resin, diallyl phthalate resin, silicon resin and epoxy resin; epoxy resins, bisphenol-A type epoxy resin, bisphenol-F type epoxy resin, bisphenol-AD type epoxy resin, phenol novolac type epoxy resin, cresol novolac type epoxy resin, cycloaliphatic epoxy resin, glycidyl ester-based resin, glycidyl amine-based epoxy resin, heterocyclic epoxy resin, urethane modified epoxy resin and brominated bisphenol-A type epoxy resin, and the like, and any blend or mixture thereof.

20. The material according to claim 18, further comprising one or more components selected from antioxidants, UV stabilizers, pigments, anti-dripping agents, releasing agents, fillers, minerals, carbon fibers, glass fibers, impact modifiers, lubricants, smoke suppressants, other phosphorous flame retardants, nitrogen flame retardants, and fluorine containing resins.
